(19) United States
(12) Patent Application Publication
(10) Pub. No.: US 2025/0210649 A1
(43) Pub. Date: Jun. 26, 2025

(54) METHOD FOR FORMING POSITIVE ELECTRODE ACTIVE MATERIAL AND BATTERY

(71) Applicant: SEMICONDUCTOR ENERGY LABORATORY CO., LTD., Atsugi-shi (JP)

(72) Inventors: Shunpei YAMAZAKI, Tokyo (JP); Shuji FUKAI, Kanagawa (JP); Kousuke SASAKI, Kanagawa (JP); Yusuke YOSHITANI, Kanagawa (JP); Shuhei YOSHITOMI, Kanagawa (JP); Fuminori SEKIKAWA, Kanagawa (JP); Tetsuya KAKEHATA, Kanagawa (JP); Yoshihiro KOMATSU, Kanagawa (JP); Ryosuke MATSUSAKI, Kanagawa (JP)

(21) Appl. No.: 18/973,866

(22) Filed: Dec. 9, 2024

(30) Foreign Application Priority Data
Dec. 20, 2023 (JP) 2023-215216
Feb. 19, 2024 (JP) 2024-023104

(51) Int. Cl. H01M 4/525; C01G 53/42; H01M 4/02; H01M 4/04; H01M 10/052

(52) U.S. Cl. CPC H01M 4/525; C01G 53/42; H01M 4/0471; H01M 10/052; C01P 2002/72; H01M 2004/028

(57) ABSTRACT

A novel positive electrode active material is to be provided. In addition, a battery with favorable charge and discharge characteristics is to be provided. The battery includes a positive electrode, and the positive electrode includes a positive electrode active material including lithium cobalt oxide. The lithium cobalt oxide contains magnesium, aluminum, and nickel, and when the concentration of cobalt in the lithium cobalt oxide measured from XPS analysis is represented as 1, the magnesium concentration (Mg/Co) is higher than or equal to 0.50 and lower than or equal to 0.90; and the half width of a Mg1s peak is higher than or equal to 1.0 eV and lower than or equal to 2.6 eV.

### BACKGROUND OF THE INVENTION

### 1. Field of the Invention

One embodiment of the present invention relates to an object, a method, or a manufacturing method. The present invention relates to a process, a machine, manufacture, or a composition of matter. One embodiment of the present invention relates to a power storage device, a semiconductor device, a display device, a light-emitting device, a lighting device, an electronic device each including a secondary battery, or a manufacturing method thereof.

Note that electronic devices in this specification mean all devices including power storage devices, and electro-optical devices including power storage devices, information terminal devices including power storage devices, and the like are all electronic devices.

### 2. Description of the Related Art

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Documents 1 and 2). Crystal structures of positive electrode active materials have also been studied (Non-Patent Documents 1 to 3).

X-ray diffraction (XRD) is one of methods used for analysis of crystal structures of positive electrode active materials. With use of the Inorganic Crystal Structure Database (ICSD) introduced in Non-Patent Document 4, XRD data can be analyzed. For example, the ICSD can be referred to for the lattice constant of the lithium cobalt oxide described in Non-Patent Document 5. For Rietveld analysis, the analysis program RIETAN-FP (Non-Patent Document 6) can be used, for example. For example, VESTA (Non-Patent Document 7) can be used as software for drawing crystal structures.

As image processing software, for example, ImageJ (Non-Patent Documents 8 to 10) is known. Using this software makes it possible to analyze the shape of a positive electrode active material, for example.

Nanobeam electron diffraction can also be effectively used to identify the crystal structure of a positive electrode active material, in particular, the crystal structure of a surface portion of the positive electrode active material. For analysis of electron diffraction patterns, an analysis program called ReciPro (Non-Patent Document 1) can be used, for example. Furthermore, element analysis of the positive electrode active material can be performed with scanning transmission electron microscope (STEM)-energy dispersive X-ray spectroscopy (EDX). Non-Patent Document 12 is known as a literature showing the detection limit (also referred to as lower detection limit) in the case of using STEM-EDX.

### REFERENCE

### Patent Document

[Patent Document 1] Japanese Published Patent Application No. 2018-206747
[Patent Document 2] Japanese Published Patent Application No. 2022-070247

### Non-Patent Document

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 22, 2012, pp. 17340-17348.
[Non-Patent Document 2] T. Motohashi et al., “Electronic phase diagram of the layered cobalt oxide system LiₓCoO₂ (0.0≤x≤1.0)”, Physical Review B, 80 (16); 165114.
[Non-Patent Document 3] Zhaohui Chen et al., “Staging Phase Transitions in LiₓCoO₂”, Journal of The Electrochemical Society, 149 (12), 2002, A1604-A1609.
[Non-Patent Document 4] A. Belsky, et al., “New developments in the Inorganic Crystal Structure Database (ICSD): accessibility in support of materials research and design”, Acta Cryst., (2002), B58, 364-369.
[Non-Patent Document 5] J. Akimoto, Y. Gotoh, Y. Oosawa, “Synthesis and structure refinement of LiCoO₂ single crystals”, Journal of Solid State Chemistry (1998) 141, pp. 298-302.
[Non-Patent Document 6] F. Izumi and K. Momma, “Three-Dimensional Visualization in Powder Diffraction,” Solid State Phenom., 130, 15-20 (2007)
[Non-Patent Document 7] K. Momma and F. Izumi, “VESTA 3 for three-dimensional visualization of crystal, volumetric and morphology data” J. Appl. Cryst. (2011). 44, 1272-1276.
[Non-Patent Document 8] Rasband, W. S., ImageJ, U. S. National Institutes of Health, Bethesda, Maryland, USA, http://rsb.info.nih.gov/ij/, 1997-2012.
[Non-Patent Document 9] Schneider, C. A., Rasband, W. S., Eliceiri, K. W., “NIH Image to ImageJ: 25 years of image analysis”, Nature Methods, 9, 671-675, 2012.
[Non-Patent Document 10] Abramoff, M. D., Magelhaes, P. J., Ram, S. J., “Image Processing with ImageJ”, Biophotonics International, volume 11, issue 7, pp. 36-42, 2004.
[Non-Patent Document 11] Seto, Y. & Ohtsuka, M., “ReciPro: free and open-source multipurpose crystallographic software integrating a crystal model database and viewer, diffraction and microscopy simulators, and diffraction data analysis tools” (2022) J. Appl. Cryst., 55.
[Non-Patent Document 12] K. Fukunaga and Y. Kondo, “Detection Limit of TEM/STEM-EDS”, KENBIKYO, 53.3, pp. 134-139, 2018.

### SUMMARY OF THE INVENTION

Development of lithium-ion secondary batteries has room for improvement in terms of output performance, discharge capacity, cycle performance, reliability, safety, cost, and the like. For example, in order to inhibit a change in the crystal structure on the surface of a positive electrode active material, the surface of the positive electrode active material is covered with an inert oxide, in which case the coating film might inhibit insertion and extraction of lithium. Inhibiting insertion and extraction of lithium ions causes concern of a decrease in secondary battery characteristics, such as a decrease in discharge capacity at the time of high rate discharging (also referred to as a decrease in output performance or a decrease in rate characteristics) and a decrease in charge and discharge capacity in a low-temperature environment.

In view of the above, an object of one embodiment of the present invention is to provide a positive electrode active material that can be used for a lithium-ion secondary battery and in which insertion and extraction of lithium ions are promoted. Another object of one embodiment of the present invention is to provide a positive electrode active material or a composite oxide with which a decrease in discharge capacity at the high rate discharging is inhibited. Another object of one embodiment of the present invention is to provide a positive electrode active material or a composite oxide with which a decrease in discharge capacity in a low-temperature environment is inhibited. Another object of one embodiment of the present invention is to provide a positive electrode active material or a composite oxide with which a decrease in discharge capacity during charge and discharge cycles is inhibited. Another object of one embodiment of the present invention is to provide a positive electrode active material or a composite oxide having a crystal structure that is unlikely to be broken by repeated charging and discharging. Another object of one embodiment of the present invention is to provide a positive electrode active material or a composite oxide with high discharge capacity. Another object of one embodiment of the present invention is to provide a secondary battery with high safety or high reliability, an electronic device including the secondary battery, or a vehicle including the secondary battery.

Another object of one embodiment of the present invention is to provide a positive electrode active material, a composite oxide, a power storage device, or a manufacturing method thereof.

Note that the description of these objects does not preclude the presence of other objects. One embodiment of the present invention does not need to achieve all these objects. Other objects can be derived from the description of the specification, the drawings, and the claims.

One embodiment of the present invention is a battery including a positive electrode; the positive electrode includes lithium cobalt oxide; the lithium cobalt oxide contains magnesium, aluminum, and nickel; when the concentration of cobalt in the lithium cobalt oxide measured from XPS analysis is represented as 1, the magnesium concentration (Mg/Co) is higher than or equal to 0.50 and lower than or equal to 0.90; and the half width of a Mg1s peak in the XPS analysis is higher than or equal to 1.0 eV and lower than or equal to 2.6 eV.

In the above battery, when the concentration of magnesium measured from the XPS analysis is represented as 1, the concentration of fluorine (F/Mg) is preferably higher than or equal to 0.10 and lower than or equal to 0.20. When the concentration of cobalt measured from the XPS analysis is represented as 1, the concentration of aluminum (Al/Co) is preferably higher than or equal to 0.01 and lower than or equal to 0.04 and the concentration of nickel (Ni/Co) is preferably higher than or equal to 0.01 and lower than or equal to 0.07.

It is preferable that in any of the above batteries, the positive electrode include lithium cobalt oxide having a layered rock-salt crystal structure of a space group R-3m; a negative electrode include a lithium metal, a mixture in which 2 wt % of vinylene carbonate is added to lithium hexafluorophosphate, ethylene carbonate, and diethyl carbonate is used as an electrolyte solution; and an XRD pattern at least have a diffraction peak at 2θ of 19.25±0.20° and 2θ of 45.47±0.10° when the positive electrode is analyzed by powder X-ray diffraction with CuKα₁ radiation in an argon atmosphere in the following manner: constant current charge with a current value of 0.5 C (note that 1 C=200 mA/g) is performed up to a voltage of 4.60 V in an environment at 45° C., and then constant voltage charging is performed until the current value becomes 0.05 C.

Another embodiment of the present invention is a method for forming a positive electrode active material, including a first step of mixing lithium cobalt oxide and lithium fluoride to form a first mixture; a second step of heating the first mixture at a temperature higher than or equal to 900° C. and lower than or equal to 950° C. for longer than or equal to 2 hours and shorter than or equal to 10 hours; a third step of mixing a magnesium source with the first mixture to form a second mixture; a fourth step of heating the second mixture at a temperature higher than or equal to 850° C. and lower than or equal to 950° C. for longer than or equal to 2 hours and shorter than or equal to 60 hours; a fifth step of mixing a nickel source and an aluminum source with the second mixture to form a third mixture; and a sixth step of heating the third mixture at a temperature higher than or equal to 800° C. and lower than or equal to 900° C. for longer than or equal to 2 hours and shorter than or equal to 20 hours.

In the above method for forming a positive electrode active material, when EELS analysis is performed on a portion within a range less than or equal to 2 nm from the surface of the first mixture that has been subjected to the second step, a valence of cobalt is preferably greater than or equal to 2.35 and less than or equal to 2.90.

Alternatively, in the above method for forming a positive electrode active material, the first mixture is preferably mixed with lithium fluoride in addition to the magnesium source in the third step.

In any of the above methods for forming a positive electrode active material, in the third step, magnesium fluoride is preferably used as the magnesium source, and when the number of moles of lithium cobalt oxide is 100, the first mixing is preferably performed so that the number of moles of the magnesium fluoride is greater than or equal to 0.5 and less than or equal to 3.0.

In the above method for forming a positive electrode active material, it is preferable that nickel hydroxide be used as the nickel source and aluminum hydroxide be used as the aluminum source in the fifth step. Furthermore, when the number of moles of lithium cobalt oxide is 100, the mixing is preferably performed so that the number of moles of the nickel hydroxide is greater than or equal to 0.05 and less than or equal to 4.0 and the number of moles of aluminum hydroxide is greater than or equal to 0.05 and less than or equal to 4.0.

According to one embodiment of the present invention, a positive electrode active material that can be used for a lithium-ion secondary battery and in which insertion and extraction of lithium ions are promoted can be provided. According to another embodiment of the present invention, a positive electrode active material or a composite oxide with which a decrease in discharge capacity at the high rate discharging is inhibited can be provided. According to another embodiment of the present invention, a positive electrode active material or a composite oxide with which a decrease in discharge capacity in a low-temperature environment is inhibited can be provided. According to another embodiment of the present invention, a positive electrode active material or a composite oxide with which a decrease in discharge capacity during charge and discharge cycles is inhibited can be provided. According to another embodiment of the present invention, a positive electrode active material or a composite oxide having a crystal structure that is unlikely to be broken by repeated charging and discharging can be provided. According to another embodiment of the present invention, a positive electrode active material or a composite oxide with high discharge capacity can be provided. According to another embodiment of the present invention, a secondary battery with high safety or high reliability, an electronic device including the secondary battery, or a vehicle including the secondary battery can be provided. According to another embodiment of the present invention, a positive electrode active material, a composite oxide, a power storage device, or a manufacturing method thereof can be provided.

Note that the description of these effects does not preclude the existence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

In the accompanying drawings:

FIGS. 1A to 1D illustrate a method for forming a positive electrode active material;

FIG. 2 illustrates a method for forming a positive electrode active material;

FIGS. 3A to 3C illustrate a method for forming a positive electrode active material;

FIG. 4A is a cross-sectional view illustrating an inner structure of a secondary battery, and FIG. 4B is a cross-sectional view illustrating a positive electrode and an electrolyte of the secondary battery;

FIGS. 5A and 5B are cross-sectional views illustrating a positive electrode active material;

FIGS. 6A to 6F are cross-sectional views illustrating a positive electrode active material;

FIG. 7 shows crystal structures of a positive electrode active material;

FIG. 8 shows crystal structures of a conventional positive electrode active material;

FIG. 9 shows XRD patterns calculated from crystal structures;

FIG. 10 shows XRD patterns calculated from crystal structures;

FIGS. 11A to 11G show positional relations of element distribution according to EDX line analysis;

FIG. 12A is an exploded perspective view of a coin-type secondary battery, FIG. 12B is a perspective view of the coin-type secondary battery, and FIG. 12C is a cross-sectional perspective view of the coin-type secondary battery;

FIG. 13A illustrates an example of a cylindrical secondary battery, FIG. 13B illustrates an example of the cylindrical secondary battery, FIG. 13C illustrates an example of a plurality of cylindrical secondary batteries, and FIG. 13D illustrates an example of a power storage system including the plurality of cylindrical secondary batteries;

FIGS. 14A and 14B illustrate examples of a secondary battery, and FIG. 14C illustrates the internal state of the secondary battery;

FIGS. 15A to 15C illustrate an example of a secondary battery;

FIGS. 16A and 16B each illustrate the appearance of a secondary battery;

FIGS. 17A to 17C illustrate a method for manufacturing a secondary battery;

FIG. 18A illustrates a structure example of a battery pack, FIG. 18B illustrates a structure example of the battery pack, and FIG. 18C illustrates a structure example of the battery pack;

FIG. 19A is a perspective view of a battery pack of one embodiment of the present invention, FIG. 19B is a block diagram of the battery pack, and FIG. 19C is a block diagram of a vehicle including the battery pack;

FIGS. 20A to 20D illustrate examples of transport vehicles, and FIG. 20E is a diagram illustrating an example of an artificial satellite;

FIGS. 21A and 21B illustrate power storage devices of one embodiment of the present invention;

FIG. 22A illustrates an electric bicycle, FIG. 22B illustrate a secondary battery of the electric bicycle, and FIG. 22C illustrates a motor scooter;

FIGS. 23A to 23D illustrate examples of electronic devices;

FIG. 24A illustrates examples of wearable devices, FIG. 24B is a perspective view of a watch-type device, and FIG. 24C illustrates a side surface of the watch-type device;

FIG. 25 is an HAADF-STEM image of a positive electrode active material;

FIGS. 26A and 26B are HAADF-STEM images of a positive electrode active material;

FIGS. 27A and 27B show cross-sectional STEM-EDX analysis results of a positive electrode active material;

FIGS. 28A and 28B show cross-sectional STEM-EDX analysis results of a positive electrode active material;

FIGS. 29A to 29D show cross-sectional STEM-EDX analysis results of a positive electrode active material;

FIGS. 30A to 30D show cross-sectional STEM-EDX analysis results of a positive electrode active material;

FIGS. 31A and 31B show cross-sectional STEM-EDX analysis results of a positive electrode active material;

FIGS. 32A and 32B show cross-sectional STEM-EDX analysis results of a positive electrode active material;

FIGS. 33A to 33D show cross-sectional STEM-EDX analysis results of a positive electrode active material;

FIGS. 34A to 34D show cross-sectional STEM-EDX analysis results of a positive electrode active material;

FIGS. 35A and 35B are graphs showing results of a discharge rate test;

FIGS. 36A and 36B are graphs showing results of a discharge rate test;

FIGS. 37A and 37B are graphs showing results of a discharge rate test;

FIGS. 38A and 38B are graphs showing results of a discharge rate test;

FIGS. 39A and 39B are graphs showing results of a charge and discharge cycle test;

FIGS. 40A and 40B are graphs showing results of a charge and discharge cycle test;

FIGS. 41A and 41B are graphs showing results of a charge and discharge cycle test;

FIGS. 42A and 42B are graphs showing results of a charge and discharge cycle test;

FIGS. 43A and 43B are graphs showing results of a charge and discharge cycle test;

FIGS. 44A and 44B are graphs showing results of a charge and discharge cycle test;

FIGS. 45A and 45B are graphs showing results of a charge and discharge cycle test;

FIGS. 46A and 46B are graphs showing results of XPS analysis;

FIG. 47 is a graph showing results of a discharge rate test; and

FIGS. 48A and 48B are graphs showing XRD analysis results of positive electrodes in a high-voltage charged state.

### DETAILED DESCRIPTION OF THE INVENTION

Hereinafter, embodiment examples for carrying out the present invention will be described with reference to the drawings and the like. Note that the present invention should not be construed as being limited to the embodiment examples given below. Embodiments for carrying out the invention can be changed unless they deviate from the spirit of the present invention.

In this specification and the like, a space group is represented using the short symbol of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, crystal planes, crystal orientations, and space groups are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. A trigonal system represented by the space group R-3m is generally represented by a composite hexagonal lattice for easy understanding of the structure and is also represented by a composite hexagonal lattice in this specification and the like unless otherwise specified. In some cases, not only (hkl) but also (hkil) is used as the Miller index. Here, i is −(h+k).

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

The theoretical capacity of a positive electrode active material refers to the amount of electricity obtained when all lithium that can be inserted into and extracted from the positive electrode active material is extracted. For example, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material is represented by x in a compositional formula, e.g., LiₓMO₂. Note that M represents a transition metal and is cobalt and/or nickel unless otherwise specified in this specification and the like. In the case of a positive electrode active material in a lithium-ion secondary battery, x can be represented by (theoretical capacity−charge capacity)/theoretical capacity. For example, when a lithium-ion secondary battery that includes LiₓMO₂ as a positive electrode active material is charged to 219.2 mAh/g, the positive electrode active material can be represented by Li_{0.2}MO₂, i.e., x=0.2. Note that “x in LiₓMO₂ is small” means, for example, 0.1<x≤0.24.

Lithium cobalt oxide to be used for a positive electrode, which has been appropriately synthesized and almost satisfies the stoichiometric proportion, is LiCoO₂ with x of 1. Also in a secondary battery after its discharging ends, it can be said that lithium cobalt oxide therein is LiCoO₂ with x of 1. Here, “state where discharging ends (discharged state)” means that the voltage becomes 3.0 V or 2.5 V or lower at a current of 100 mA/g or lower, for example.

Charge capacity and/or discharge capacity used for calculation of x in LiₓMO₂ are/is preferably measured under the conditions where there is no influence or small influence of a short circuit and/or decomposition of an electrolyte solution or the like. For example, data of a lithium-ion secondary battery that is measured while a sudden change in capacity that seems to be derived from a short circuit is caused should not be used for calculation of x.

The space group of a positive electrode active material or the like is identified by XRD, electron diffraction, neutron diffraction, or the like. Thus, in this specification and the like, belonging to a space group or being a space group can be rephrased as being identified as a space group.

A structure is referred to as a cubic close-packed structure when three layers of anions are shifted and stacked like “ABCABC” in the structure. Accordingly, anions do not necessarily form a cubic lattice structure. At the same time, actual crystals always have a defect and thus, analysis results are not necessarily consistent with the theory. For example, in an electron diffraction pattern or a fast Fourier transform (FFT) pattern of a transmission electron microscope (TEM) image or the like, a spot may appear in a position different from a theoretical position. For example, anions may be regarded as forming a cubic close-packed structure when a difference in orientation from a theoretical position is 5° or less or 2.5° or less.

The distribution of an element indicates the region where the element is successively detected by a successive analysis method to the extent that the detection value is no longer on the noise level. The region where the element is successively detected to the extent that the detection value is no longer on the noise level can be rephrased as, for example, the region where the element is detected every time the analysis is performed.

In this specification and the like, a positive electrode active material is sometimes referred to as a composite oxide, a positive electrode member, a positive electrode material, a secondary battery positive electrode member, a lithium-ion secondary battery positive electrode member, or the like.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

Note that the description is made on the assumption that materials (such as a positive electrode active material, a negative electrode active material, an electrolyte solution, and a separator) of a secondary battery have not been degraded unless otherwise specified. A decrease in discharge capacity due to aging treatment and burn-in treatment during the manufacturing process of a secondary battery is not regarded as degradation. For example, a state where discharge capacity is higher than or equal to 97% of the rated capacity of a secondary battery composed of a cell or an assembled battery can be regarded as a non-degraded state. The rated capacity conforms to Japanese Industrial Standards (JIS C 8711:2019) in the case of a secondary battery for a portable device. The rated capacities of other secondary batteries conform to JIS described above, JIS for electric vehicle propulsion, industrial use, and the like, standards defined by the International Electrotechnical Commission (IEC), and the like.

In this specification and the like, in some cases, materials included in a secondary battery that have not been degraded are referred to as initial products or materials in an initial state, and materials that have been degraded (have discharge capacity lower than 97% of the rated capacity of the secondary battery) are referred to as products in use, materials in a used state, products that are already used, or materials in an already-used state.

In this specification and the like, the (001) plane, the (003) plane, and the like are sometimes collectively referred to as the (001) plane. In this specification and the like, the (001) plane is sometimes referred to as the C-plane, the basal plane, or the like. In lithium cobalt oxide, lithium diffuses through two-dimensional paths. In other words, the diffusion path of lithium extends along a plane. In this specification and the like, a plane where a lithium diffusion path is exposed, i.e., a plane other than a plane where lithium is inserted and extracted (specifically, the (001) plane), is sometimes referred to as the edge plane.

In this specification and the like, a secondary particle refers to a particle formed by aggregation of primary particles. In this specification and the like, a primary particle refers to a particle whose appearance shows no grain boundary. In this specification and the like, a single-particle refers to a particle whose appearance shows no grain boundary. In this specification and the like, a single crystal grain refers to a crystal grain whose inner portion does not have a grain boundary, whereas a polycrystalline grain refers to a crystal grain whose inner portion has a grain boundary. A polycrystalline grain may be regarded as a group of a plurality of crystallites, and a grain boundary may be regarded as an interface existing between two or more crystallites. Note that crystallites in a polycrystalline grain are preferably in the same direction.

In this specification and the like, the phrase “A and/or B” is an example of an expression that encompasses only A, only B, and A and B.

A short circuit of a secondary battery might cause not only a malfunction in charging operation and/or discharging operation of the secondary battery but also heat generation and ignition. In order to obtain a safe secondary battery, short-circuit current is preferably inhibited even at a high charge voltage. With the positive electrode included in a battery of one embodiment of the present invention, short-circuit current is inhibited even at a high charge voltage. Thus, a secondary battery with both high discharge capacity and high safety can be provided.

### Embodiment 1

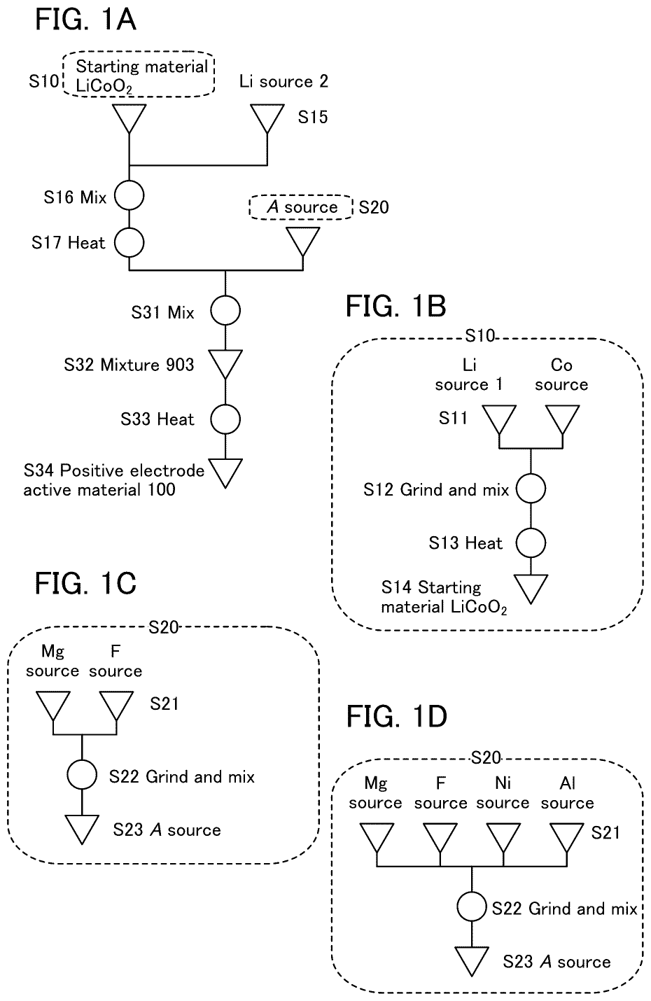

In this embodiment, an example of a method for forming a positive electrode active material 100 that is a positive electrode active material of one embodiment of the present invention will be described. FIGS. 1A to 3C illustrate methods for forming the positive electrode active material 100.

A way of adding an additive element is important in forming the positive electrode active material 100. Favorable crystallinity of the inner portion of the positive electrode active material is also important.

Thus, in the formation process of the positive electrode active material 100, the following steps are preferably performed. First, a first lithium source and a cobalt source are mixed and heat treatment is performed on the mixture, whereby lithium cobalt oxide is synthesized. Next, the lithium cobalt oxide and a second lithium source are mixed and heat treatment is performed on the mixture. After that, an additive element source is mixed to the mixture and heat treatment is performed on the mixture containing the additive element source.

In a method of synthesizing lithium cobalt oxide containing an additive element by mixing the additive element source concurrently with the first lithium source and the cobalt source, it is sometimes difficult to increase the concentration of the additive element in the surface portion of the positive electrode active material. In addition, after lithium cobalt oxide is synthesized, mixing an additive element source is only performed and heating is not performed, in which case the additive element is just attached to, not solid-solute in, the lithium cobalt oxide. It is difficult to distribute the additive element favorably without sufficient heating. Therefore, it is preferable that lithium cobalt oxide be synthesized, and then an additive element source be mixed and heat treatment be performed.

However, heat treatment at an excessively high temperature may cause cation mixing, which increases the possibility of entry of the additive element such as magnesium into the cobalt sites. Magnesium that has entered the cobalt sites does not have an effect of maintaining a layered Rock-salt crystal structure belonging to R-3m when x in LiₓCoO₂ is small. Furthermore, heat treatment at an excessively high temperature might have an adverse effect; for example, cobalt might be reduced to be bivalent or lithium might be evaporated.

### [Initial Heating]

It is preferable that the second lithium source and the lithium cobalt oxide be mixed and heating (this heating is referred to as initial heating) be performed before mixing the additive element source and heating the mixture containing the additive element source. Here, a material functioning as a fusing agent is preferably used as the second lithium source, and for example, lithium fluoride is suitable.

Sufficient mixing should be performed on the lithium cobalt oxide and the second lithium source. For example, a ball mill can be used for the mixing.

The step of sufficiently mixing the lithium cobalt oxide and the second lithium source brings an effect of eliminating the adhesion between the particles of the lithium cobalt oxide.

Furthermore, adding a material functioning as a fusing agent as the second lithium source brings an effect of inhibiting the particles of the lithium cobalt oxide from adhering again in the following step of mixing and heating the lithium cobalt oxide that has been subjected to initial heating and the additive element source.

If the additive element is added to the lithium cobalt oxide where the particles adhere to each other and heating is performed thereon, the additive element might not be sufficiently distributed in the adhesion portion. Thus, when adhesion is eliminated in a later step, e.g., a pressure application step after coating a positive electrode current collector with the lithium cobalt oxide, a surface where the additive element is not sufficient might be exposed, and deterioration might move on from the surface when a secondary battery including the positive electrode is used. Therefore, it is preferable that mixing the additive element source and heating the mixture containing the additive element be performed after the adhesion of particles of the lithium cobalt oxide is inhibited in the above manner.

By adding a fusing agent in the initial heating step, lowering the melting points occurs in the vicinity of the surface of the lithium cobalt oxide in the subsequent step where the lithium cobalt oxide that has been subjected to the initial heating and the additive element source are mixed and heated. Lowering the melting point in this manner makes it easier to distribute the additive element favorably at a temperature at which cation mixing is less likely to occur.

Thus, the heating temperature at the initial heating is preferably higher than or equal to the melting point of the second lithium source. For example, in the case where lithium fluoride is used as the second lithium source, the initial heating temperature is preferably higher than 848° C. of the melting point of lithium fluoride (e.g., higher than or equal to 850° C.), further preferably higher than or equal to 900° C. The initial heating temperature is preferably lower than or equal to the temperature at the time of synthesizing the lithium cobalt oxide (e.g., lower than or equal to 950° C.). In other words, lithium cobalt oxide and lithium fluoride are preferably mixed and heated as the initial heating at a temperature higher than or equal to 900° C. and lower than or equal to 950° C.

The use of lithium cobalt oxide that has been subjected to the above initial heating can inhibit lithium deficiency generated by evaporation of lithium in the subsequent step of mixing and heating the additive element.

The lithium cobalt oxide that has been subjected to the above initial heating preferably has a higher proportion of the layered rock-salt crystal structure in the surface portion than the lithium cobalt oxide that has not been subjected to the initial heating. For example, in a portion within a range less than or equal to 2 nm from the surface of the lithium cobalt oxide that has been subjected to the above initial heating, the layered rock-salt crystal structure preferably accounts for higher than or equal to 35%, further preferably higher than or equal to 45%. When EELS analysis is performed, the valence of cobalt is preferably greater than or equal to 2.35, further preferably greater than or equal to 2.45. A higher proportion of layered rock-salt crystal structure is one factor indicating the inhibition of lithium deficiency.

Meanwhile, it is preferable that not all the surface portion of lithium cobalt oxide have a layered rock-salt crystal structure. For example, in pure lithium cobalt oxide, the solid solubility limit of magnesium is extremely low. To make the additive element including magnesium soluble at a sufficient concentration, the surface portion of the lithium cobalt oxide preferably has a feature of a rock-salt crystal structure. Thus, in a portion within a range less than or equal to 2 nm from the surface of the lithium cobalt oxide that has been subjected to the above initial heating, the percentage of the layered rock-salt crystal structure is preferably lower than 100%, further preferably less than or equal to 90%. When EELS analysis is performed, the valence of cobalt is preferably less than 3.0, further preferably less than or equal to 2.90.

That is, in a portion within a range less than or equal to 2 nm from the surface of the lithium cobalt oxide that has been subjected to the above initial heating, the layered rock-salt crystal structure preferably accounts for higher than or equal to 35% and lower than 100%, further preferably higher than or equal to 35% and lower than or equal to 90%, still further preferably higher than or equal to 45% and lower than or equal to 90%. When the EELS analysis is performed, the valence of cobalt is preferably greater than or equal to 2.35 and less than 3.0, further preferably greater than or equal to 2.35 and less than or equal to 2.90, still further preferably greater than or equal to 2.45 and less than or equal to 2.90.

### <<Formation Method 1 of Positive Electrode Active Material 100>>

A formation method 1 of the positive electrode active material 100, in which heating treatment and the initial heating are performed, is described with reference to FIGS. 1A to 1D.

### <Step S11>

In Step S11 shown in FIG. 1B, a first lithium source (Li source 1) and a cobalt source (Co source) are prepared as materials for first lithium and a transition metal which are starting materials.

As the first lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used and for example, cobalt hydroxide or tricobalt tetraoxide can be used.

The cobalt source preferably has a high purity and is preferably a material having a purity higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with increased capacity and/or increased reliability can be provided.

Furthermore, the cobalt source preferably has high crystallinity and for example, the cobalt source preferably includes single crystal grains. The crystallinity of the cobalt source can be evaluated with a TEM image, a STEM image, a high-angle annular dark field scanning TEM (HAADF-STEM) image, an annular bright-field scanning transmission electron microscope (ABF-STEM) image, or the like. Other examples of evaluation includes X-ray diffraction, electron diffraction, and neutron diffraction. Note that the above methods for evaluating crystallinity can also be employed to evaluate the crystallinity of materials other than the cobalt source.

### <Step S12>

Next, in Step S12 shown in FIG. 1B, the first lithium source and the cobalt source are ground and mixed to form a mixed material. The grinding and mixing can be performed by a dry method or a wet method. A wet method enables finer grinding and mixing of particles. In the case of a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the first lithium source and the cobalt source be mixed into dehydrated acetone whose moisture content is less than or equal to 10 ppm and which has a purity higher than or equal to 99.5% for the grinding and mixing. With use of dehydrated acetone with the above-described purity, impurities that might be mixed can be reduced.

ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably greater than or equal to 100 mm/s and less than or equal to 2000 mm/s in order to inhibit contamination from the media or the material. In this embodiment, the grinding and mixing are performed at a circumferential speed of 838 mm/s (the number of rotations: 400 rpm, the ball mill diameter: 40 mm).

### <Step S13>

Next, in Step S13 shown in FIG. 1B, the above mixed material is heated. The heating is preferably performed at higher than or equal to 800° C. and lower than or equal to 1100° C., further preferably at higher than or equal to 900° C. and lower than or equal to 1050° C., still further preferably at approximately 900° C. An excessively low temperature may lead to insufficient decomposition and melting of the first lithium source and the cobalt source. An excessively high temperature might lead to a defect due to evaporation of lithium from the first lithium source and/or excessive reduction of cobalt, for example. An oxygen vacancy or the like may be induced by a change of trivalent cobalt into divalent cobalt, for example.

When the heating time is too short, lithium cobalt oxide is not synthesized, but when the heating time is too long, the productivity is lowered. For example, the heating time is preferably longer than or equal to an hour and shorter than or equal to 100 hours, further preferably longer than or equal to 2 hours and shorter than or equal to 20 hours.

A temperature raising rate is preferably higher than or equal to 80° C./h and lower than or equal to 250° C./h although depending on the end-point temperature of the heating. For example, in the case of heating at 1000° C. for 10 hours, the temperature raising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 parts per billion (ppb).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as “flowing”.

In the case where the heating atmosphere is an oxygen-containing atmosphere, a way without oxygen flowing may be performed. For example, a method may be employed in which the pressure in the reaction chamber is reduced, the reaction chamber is filled (or “purged”) with oxygen, and the exit and entry of the oxygen are prevented. For example, the pressure in the reaction chamber may be reduced to −970 hPa and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A container holding an object to be heated at the time of heating is preferably a crucible made of aluminum oxide or a setter (also referred to as a saggar) made of aluminum oxide. Almost no impurities enter the crucible made of aluminum oxide. In this embodiment, a setter made of aluminum oxide with a purity of 99.9% is used. The crucible or the setter is preferably covered with a lid before heating, in which case volatilization of a material can be prevented. Furthermore, as materials of the crucible and the setter, mullite-cordierite may be used.

A used crucible is preferable to a new crucible. In this specification and the like, a new crucible refers to a crucible that is subjected to heating two or less times while a material containing lithium, the transition metal M, and/or the additive element is contained therein. A used crucible refers to a crucible that is subjected to heating three or more times while a material containing lithium, the transition metal M, and/or the additive element is contained therein. In the case where a new crucible is used, some materials such as lithium fluoride might be absorbed by, diffused in, transferred to, and/or attached to a sagger. Loss of some materials due to such phenomena increases a concern that an element is not distributed in a preferable range particularly in the surface portion of the positive electrode active material. In contrast, such a risk is low in the case of a used crucible.

The heated material is crushed as needed and may be made to pass through a sieve. The collection of the heated material may be performed after the material is moved from the crucible to a mortar. As the mortar, a zirconium oxide mortar can be suitably used. A zirconium oxide mortar is made of a material that hardly releases impurities. Specifically, a mortar made of zirconium oxide with a purity higher than or equal to 90%, preferably higher than or equal to 99% is used. Note that heating conditions similar to those in Step S13 can be employed in a later-described heating step other than Step S13.

### <Step S14>

Through the above steps, lithium cobalt oxide (LiCoO₂) can be synthesized as Step S14 in FIG. 1B.

Although the example is described in which the lithium cobalt oxide is formed by a solid phase method as in Steps S11 to S14, the lithium cobalt oxide may be formed by a coprecipitation method. Alternatively, lithium cobalt oxide may be formed by a hydrothermal method.

### <Step S15>

In Step S15 shown in FIG. 1A, a second lithium source (Li source 2) is prepared. As the second lithium source, for example, lithium fluoride is preferably used.

### <Step S16>

Next, in Step S16 shown in FIG. 1A, the lithium cobalt oxide and a second lithium source are mixed. The mixing in Step S16 is preferably performed under milder conditions than the mixing in Step S12, in order not to damage the shapes of the lithium cobalt oxide particles. For example, a condition with a smaller number of rotations or a shorter time than that for the mixing in Step S12 is preferable. Moreover, a dry method is regarded as a milder condition than a wet method. For example, a ball mill, a bead mill, or the like can be used for the mixing. When a ball mill is used, zirconium oxide balls are preferably used as a medium, for example.

### <Step S17>

Next, in Step S17 shown in FIG. 1A, the mixture of the lithium cobalt oxide and the second lithium source is heated. The heating is performed a temperature preferably higher than or equal to 800° C. and lower than 1000° C., further preferably at higher than or equal to 850° C. and lower than or equal to 950° C., still further preferably higher than or equal to 900° C. and lower than or equal to 950° C. The heating time is preferably longer than or equal to an hour and shorter than or equal to 60 hours, further preferably longer than or equal to 2 hours and shorter than or equal to 20 hours, still further preferably longer than or equal to 2 hours and shorter than or equal to 10 hours, yet still further preferably longer than or equal to 2 hours and shorter than or equal to 6 hours. The heating in Step S17 is the first heating performed on the lithium cobalt oxide and thus, this heating is sometimes referred to as the initial heating. The heating is performed before Step S33 described below and thus is sometimes referred to as preheating or pretreatment. Steps S16 and S17 are implemented, whereby lithium cobalt oxide can have a smooth surface.

Note that pre-synthesized lithium cobalt oxide may be used in Step S14. In this case, Steps S11 to S13 can be skipped. Even when Steps S16 and S17 are performed on the pre-synthesized lithium cobalt oxide, lithium cobalt oxide with a smooth surface can be obtained.

### <Step S20>

Next, as shown in Step S20, an additive element A is preferably added to the lithium cobalt oxide that has been subjected to the initial heating. When the additive element A is added to the lithium cobalt oxide that has been subjected to the initial heating, the additive element A can be uniformly added. It is thus preferable that the initial heating precede the addition of the additive element A. The step of adding the additive element A is described with reference to FIGS. 1C and 1D.

### <Step S21 to Step S23>

The steps of preparing the additive element A source (A source) are described with reference to FIG. 1C. A lithium source may be prepared in addition to the additive element A source.

As the additive element A, the additive element described in the above embodiment, e.g., one or more selected from magnesium, fluorine, nickel, aluminum, zirconium, vanadium, iron, manganese, chromium, niobium, arsenic, zinc, silicon, sulfur, phosphorus, and boron can be used. Furthermore, one or both of bromine and beryllium can be used.

### <Step S21>

Step S21 shown in FIG. 1C is described. When magnesium is selected as the additive element, the additive element source can be referred to as a magnesium source (Mg source). As the magnesium source, magnesium fluoride, magnesium oxide, magnesium hydroxide, magnesium carbonate, or the like can be used. Two or more of these magnesium sources may be used.

When fluorine is selected as the additive element, the additive element source can be referred to as a fluorine source (F source). As the fluorine source, for example, lithium fluoride (LiF), magnesium fluoride (MgF₂), aluminum fluoride (AlF₃), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C. Note that in the case where lithium fluoride is used as the fluorine source, the lithium fluoride can also be referred to as a third lithium source.

Magnesium fluoride can be used as both the fluorine source and the magnesium source. Lithium fluoride can be used also as the lithium source. Another example of the lithium source that can be used in Step S21 is lithium carbonate.

The fluorine source may be a gas; for example, fluorine (F₂), carbon fluoride, sulfur fluoride, oxygen fluoride (e.g., OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed at a molar ratio of approximately 65:35, the effect of lowering the melting point is maximized. Meanwhile, when the proportion of lithium fluoride increases, the cycle performance might be degraded because of an excessive amount of lithium. Therefore, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 or an approximate value thereof). Note that in this specification and the like, “an approximate value” means a value greater than 0.9 times and less than 1.1 times the given value.

### <Step S22>

Next, in Step S22 shown in FIG. 1C, the magnesium source and the fluorine source are ground and mixed. Any of the conditions for the grinding and mixing that are described for Step S12 can be selected to perform Step S22.

### <Step S23>

Next, in Step S23 shown in FIG. 1C, the materials ground and mixed in the above step are collected to give the additive element A source (A source). Note that the additive element A source in Step S23 contains a plurality of starting materials and can be referred to as a mixture.

As for the particle diameter of the mixture, its D50 (median diameter) is preferably greater than or equal to 600 nm and less than or equal to 10 μm, further preferably greater than or equal to 1 μm and less than or equal to 5 μm. Also when one kind of material is used as the additive element source, the D50 (median diameter) is preferably greater than or equal to 600 nm and less than or equal to 10 μm, further preferably greater than or equal to 1 μm and less than or equal to 5 μm.

Such a pulverized mixture (which may contain only one kind of the additive element) is easily attached to the surface of a lithium cobalt oxide particle uniformly in a later step of mixing with the lithium cobalt oxide. The mixture is preferably attached uniformly to the surface of the lithium cobalt oxide particle, in which case the additive element is easily distributed or dispersed uniformly in the surface portion of the positive electrode active material 100 subjected to heating.

### <Step S21>

A process different from that in FIG. 1C is described with reference to FIG. 1D. In Step S21 shown in FIG. 1D, four kinds of additive element A sources to be added to the lithium cobalt oxide are prepared. In other words, FIG. 1D is different from FIG. 1C in the kinds of the additive element A sources. A lithium source may be prepared together with the additive element sources.

As the four kinds of additive element sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 1C. As the nickel source, nickel oxide, nickel hydroxide, or the like can be used. As the aluminum source, aluminum oxide, aluminum hydroxide, or the like can be used.

### <Step S22 and Step S23>

Steps S22 and S23 shown in FIG. 1D are similar to the steps described with reference to FIG. 1C.

### <Step S31>

Next, in Step S31 shown in FIG. 1A, the lithium cobalt oxide obtained through initial heating and the additive element A source (A source) are mixed.

In this embodiment, the number of magnesium atoms contained in the additive element A source is preferably greater than or equal to 0.50% and less than or equal to 3.0%, further preferably greater than or equal to 0.75% and less than or equal to 2.0%, still further preferably greater than or equal to 0.75% and less than or equal to 1.0% with respect to the number of cobalt atoms contained in the lithium cobalt oxide.

The mixing in Step S31 is preferably performed under milder conditions than the mixing in Step S12, in order not to damage the shapes of the lithium cobalt oxide particles. For example, a condition with a smaller number of rotations or a shorter time than that for the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for an hour. The mixing is performed in a dry room the dew point of which is higher than or equal to −100° C. and lower than or equal to −10° C.

### <Step S32>

Next, in Step S32 in FIG. 1A, the materials mixed in the above step are collected, whereby a mixture 903 is obtained. At the time of the collection, the materials may be made to pass through a sieve as needed.

Note that although FIGS. 1A to 1D show the formation method in which the addition of the additive element is performed only after the initial heating, the present invention is not limited to the above-described method. The addition of the additive element may be performed at another timing or may be performed a plurality of times. The timing of the addition may be different between the elements.

### <Step S33>

Next, in Step S33 shown in FIG. 1A, the mixture 903 is heated.

For example, in the case where MgF₂ is used as the additive element source A, the lower limit of the heating temperature in Step S33 is preferably higher than or equal to 742° C. because the eutectic point of LiF and MgF₂ is around 742° C.

The mixture in which LiCoO₂, LiF, and MgF₂ are mixed at the molar ratio of 100:0.33:1 exhibits an endothermic peak at around 830° C. in differential scanning calorimetry (DSC) measurement; the heating temperature is further preferably higher than or equal to 830° C. Thus, the heating in Step S33 is preferably performed at higher than or equal to 800° C. and lower than or equal to 1000° C., further preferably at higher than or equal to 830° C. and lower than or equal to 950° C., still further preferably at higher than or equal to 850° C. and lower than or equal to 950° C. The heating time can be longer than or equal to an hour and shorter than or equal to 60 hours, for example, and is preferably longer than or equal to two hours and shorter than or equal to 20 hours.

In the formation method described in this embodiment, LiF, which is the second lithium source added in Steps S16 and S17 in FIG. 1A, functions as a fusing agent in some cases. Owing to the material functioning as a fusing agent, the heating temperature in Step S33 can be lower than the decomposition temperature of the lithium cobalt oxide, e.g., higher than or equal to 742° C. and lower than or equal to 950° C., which allows the additive element such as magnesium to be present in the surface portion and formation of a positive electrode active material having favorable characteristics.

A supplementary explanation of the heating time is provided. The heating time depends on conditions such as the heating temperature and the particle size and composition of the lithium cobalt oxide in Step S14. The heating may be preferably performed at a lower temperature or for a shorter time in the case where the particle size of the lithium cobalt oxide is small than in the case where the particle size is large.

### <Step S34>

Next, the heated material is collected in Step S34 shown in FIG. 1A, so that the positive electrode active material 100 is obtained. At this time, the collected particles can be crushed by being made to pass through a sieve as needed. Through the above process, the positive electrode active material 100 of one embodiment of the present invention can be formed. The positive electrode active material of one embodiment of the present invention has a smooth surface.

### <<Formation Method 2 of Positive Electrode Active Material 100>>

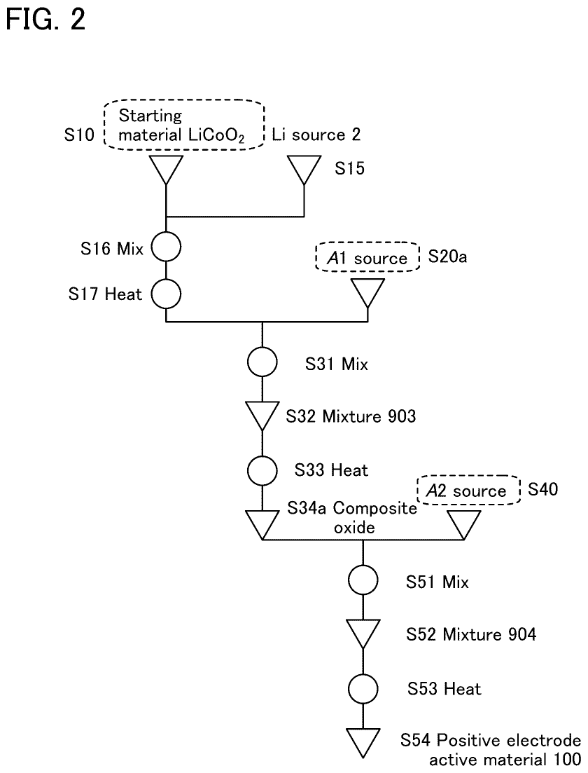

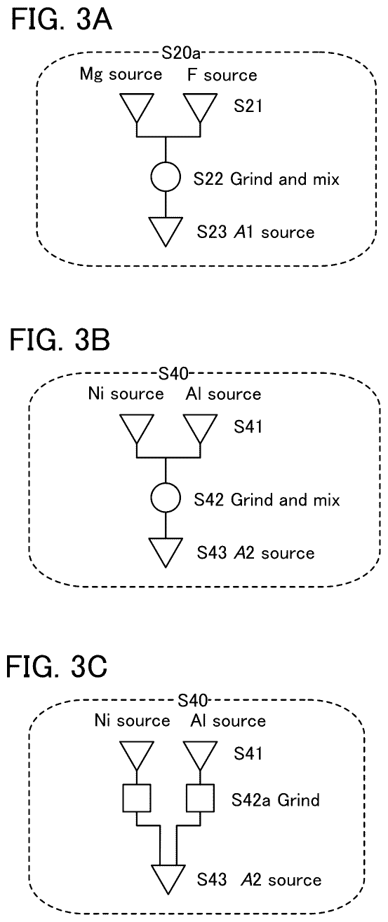

Next, as one embodiment of the present invention, a formation method 2 for the positive electrode active material 100, which is different from the formation method 1 for the positive electrode active material 100, is described with reference to FIGS. 2 to 3C. The formation method 2 of a positive electrode active material is different from the formation method 1 mainly in the number of times of adding additive elements and a mixing method. For the description except for the above, the description of the formation method 1 of a positive electrode active material can be referred to.

Steps S11 to S17 in FIG. 2 are performed as in FIGS. 1A and 1B to prepare lithium cobalt oxide that has been subjected to the initial heating.

### <Step S20a>

Next, as shown in Step S20a, an additive element A1 is preferably added to the lithium cobalt oxide that has been subjected to the initial heating.

### <Step S21>

In Steps S21 to S23 shown in FIG. 3A, the first additive element source (A1 source) is prepared. For the first additive element source, any of the elements exemplified as the additive element A in Step S21 with reference to FIG. 1C can be used. For example, one or more elements of magnesium, fluorine, and calcium can be suitably used as the additive element A1. FIG. 3A shows an example of using a magnesium source (Mg source) and a fluorine source (F source) as the first additive element source.

Steps S21 to S23 shown in FIG. 3A can be performed in a manner similar to that of Steps S21 to S23 shown in FIG. 1C. As a result, the additive element source (A1 source) can be obtained in Step S23.

Steps S31 to S33 shown in FIG. 2 can be performed in a manner similar to that of Steps S31 to S33 shown in FIG. 1A.

### <Step S34a>

Next, the material heated in Step S33 is collected to give lithium cobalt oxide containing the additive element A1. To be distinguished from the lithium cobalt oxide in Step S14, the lithium cobalt oxide obtained here is referred to as a composite oxide.

### <Step S40>

In Step S40 shown in FIG. 2, a second additive element source (A2 source) is prepared. FIGS. 3B and 3C are referred to in the following description.

### <Step S41>

In Steps S41 to S43 shown in FIG. 3B, the second additive element source (A2 source) is prepared. For the second additive element A2 in the second additive element source, any of the elements exemplified as the additive element A in Step S21 with reference to FIG. 1D can be used. For example, one or more elements selected from nickel, boron, zirconium, and aluminum can be suitably used as the additive element A2 source. FIG. 3B shows an example of using a nickel source (Ni source) and an aluminum source (Al source) as the second additive element source. As the nickel source, nickel hydroxide, nickel fluoride, or the like can be used. As the aluminum source, aluminum hydroxide, aluminum fluoride, or the like can be used.

The number of nickel atoms contained in the second additive element source (A2 source) is preferably greater than or equal to 0.05% and less than or equal to 4.0%, further preferably greater than or equal to 0.20% and less than or equal to 2.0%, still further preferably greater than or equal to 0.20% and less than or equal to 1.0% with respect to the number of cobalt atoms contained in the lithium cobalt oxide. For example, in the case of using nickel hydroxide as the nickel source, the number of moles of nickel hydroxide contained in the second additive element source is preferably greater than or equal to 0.05 and less than or equal to 4.0 (higher than or equal to 0.05 mol % and lower than or equal to 4.0 mol %), further preferably greater than or equal to 0.20 and less than or equal to 2.0 (higher than or equal to 0.20 mol % and lower than or equal to 2.0 mol %), still further preferably greater than or equal to 0.20 and less than or equal to 1.0 (higher than or equal to 0.20 mol % and lower than or equal to 1.0 mol %) with the number of moles of the lithium cobalt oxide in Step S10 assumed as 100.

The number of aluminum atoms contained in the second additive element source (A2 source) is preferably greater than or equal to 0.05% and less than or equal to 4.0%, further preferably greater than or equal to 0.20% and less than or equal to 2.0%, still further preferably greater than or equal to 0.20% and less than or equal to 1.0% with respect to the number of cobalt atoms contained in the lithium cobalt oxide. For example, in the case of using aluminum hydroxide as the aluminum source, the number of moles of aluminum hydroxide contained in the second additive element source is preferably greater than or equal to 0.05 and less than or equal to 4.0 (higher than or equal to 0.05 mol % and lower than or equal to 4.0 mol %), further preferably greater than or equal to 0.20 and less than or equal to 2.0 (higher than or equal to 0.20 mol % and lower than or equal to 2.0 mol %), still further preferably greater than or equal to 0.20 and less than or equal to 1.0 (higher than or equal to 0.20 mol % and lower than or equal to 1.0 mol %) with the number of moles of the lithium cobalt oxide in Step S10 assumed as 100.

Steps S41 to S43 shown in FIG. 3B can be performed in a manner similar to that of Steps S21 to S23 shown in FIG. 1D. As a result, the additive element source (A2 source) can be obtained in Step S43.

FIG. 3C shows a modification example of the steps which are described with reference to FIG. 3B. A nickel source (Ni source) and an aluminum source (A1 source) are prepared in Step S41 shown in FIG. 3C and are separately ground in Step S42a. In Step S43 shown in FIG. 3C, a plurality of second additive element sources (42 sources) are prepared.

### <Step S51 to Step S53>

Next, Steps S51 to S53 shown in FIG. 2 can be performed under conditions similar to those of Steps S31 to S34 shown in FIG. 1A. The heating in Step S53 is preferably performed at higher than or equal to 800° C. and lower than or equal to 1000° C., further preferably at higher than or equal to 800° C. and lower than or equal to 950° C., still further preferably at higher than or equal to 800° C. and lower than or equal to 900° C. The heating time is preferably longer than or equal to an hour and shorter than or equal to 60 hours, further preferably longer than or equal to two hours and shorter than or equal to 20 hours, still further preferably longer than or equal to two hours and shorter than or equal to 10 hours. Note that the heating in Step S53 is preferably performed at a lower heating temperature for a shorter heating time than the heating in Step S33. Through the above process, the positive electrode active material 100 of one embodiment of the present invention can be obtained in Step S54. The positive electrode active material of one embodiment of the present invention has a smooth surface.

As shown in FIGS. 2 to 3C, in the formation method 2, addition of the additive elements to the lithium cobalt oxide is separated into addition of the additive element A1 and that of the additive element A2. When the additive element A1 and the additive element A2 are separately added, the distribution in the depth direction can vary between the additive elements. The additive element A1 can be distributed such that its concentration is higher in the surface portion than in the inner portion, and the additive element A2 can be distributed such that its concentration is higher in the inner portion than in the surface portion, for example.

The contents in this embodiment can be freely combined with the contents in any of the other embodiments.

### Embodiment 2

In this embodiment, a battery and a positive electrode active material of one embodiment of the present invention will be described.

### [Battery]

A lithium-ion battery of one embodiment of the present invention includes a positive electrode, a negative electrode, and an electrolyte. When the electrolyte includes an electrolyte solution, a separator is positioned between the positive electrode and the negative electrode. An exterior body covering at least part of peripheries of the positive electrode, the negative electrode, and the electrolyte may be further provided.

In this embodiment, a positive electrode and a positive electrode active material of a battery of one embodiment of the present invention are mainly described. Note that the positive electrode active material described in this embodiment is the positive electrode active material 100 described in Embodiment 1. The details of the other components of the lithium-ion battery of one embodiment of the present invention will be described in Embodiment 3.

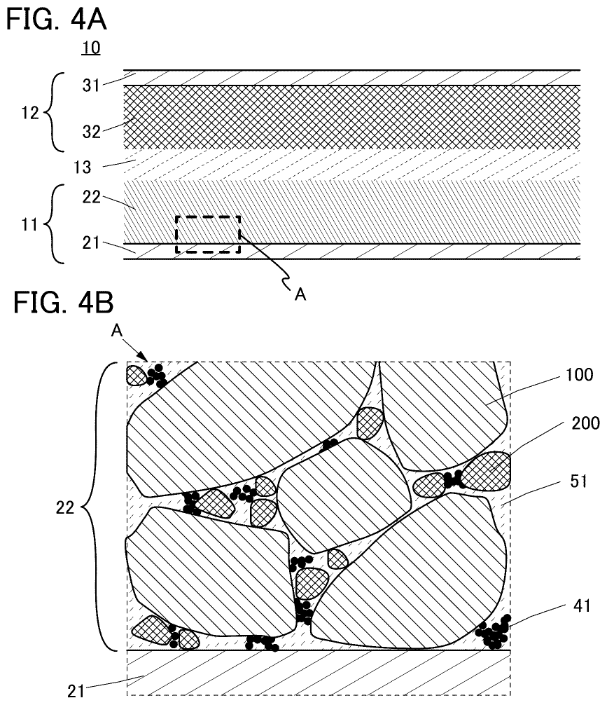

FIG. 4A is a schematic cross-sectional view illustrating an inner structure of a lithium-ion battery 10. The lithium-ion battery 10 includes a positive electrode 11, a negative electrode 12, and a separator 13. The positive electrode 11 includes a positive electrode current collector 21 and a positive electrode active material layer 22 over the positive electrode current collector 21, and the negative electrode 12 includes a negative electrode current collector 31 and a negative electrode active material layer 32. As illustrated, the positive electrode active material layer 22 and the negative electrode active material layer 32 are provided to face each other with the separator 13 therebetween. Although not illustrated in FIG. 4A, electrolytes are contained in a space included in the positive electrode active material layer 22, a space included in the separator 13, and a space included in the negative electrode active material layer 32.

Note that one positive electrode 11, one negative electrode 12, and one separator 13 are illustrated in FIG. 4A; however, the structure of the lithium-ion battery of one embodiment of the present invention is not limited thereto. Two positive electrodes 11, two negative electrodes 12, and two separators 13 may be provided, or more than two of each of the positive electrodes 11, the negative electrodes 12, and the separators 13 may be stacked. Not a stacked-layer structure illustrated in FIG. 4A but a wound structure may be employed.

FIG. 4B is an enlarged view illustrating a portion A surrounded by a dashed line in FIG. 4A.

The positive electrode active material layer 22 includes the positive electrode active material 100 (also referred to as a first positive electrode active material), a second positive electrode active material 200, and a conductive material 41. Although not illustrated, the positive electrode active material layer 22 may include a binder other than the positive electrode active material 100, the second positive electrode active material 200, and the conductive material 41.

The space included in the positive electrode active material layer 22 is preferably filled with an electrolyte 51 as illustrated. For example, the proportion of the space included in the positive electrode active material layer 22 filled with the electrolyte 51 is preferably higher than or equal to 60%, further preferably higher than or equal to 70%, still further preferably higher than or equal to 80%, yet further preferably higher than or equal to 90%, yet still further preferably higher than or equal to 95%, most preferably higher than or equal to 99%. Note that the space included in the positive electrode active material layer 22 refers to a region other than a solid component (e.g., a positive electrode active material or a conductive material) in the positive electrode active material layer 22.

### [Positive Electrode]

The positive electrode 11 includes the positive electrode current collector 21 and a positive electrode active material layer 22. The positive electrode active material layer 22 includes the positive electrode active material 100, and the positive electrode active material 100 is a particle group composed of a plurality of particles.

### <Positive Electrode Active Material 100>

The positive electrode active material 100 has functions of taking and releasing lithium ions in accordance with charge and discharge. For a positive electrode active material used as one embodiment of the present invention, can be used a material that less deteriorates due to charge and/or discharge (hereinafter, also called “charge and discharge”) even at high charge voltage. Specifically, a material that can be used is a positive electrode active material (composite oxide) with a particle diameter (median diameter (D50)) greater than 10 μm and less than or equal to 50 μm, preferably greater than 9 μm and less than or equal to 25 μm, which can be obtained by the formation method of a positive electrode active material described in Embodiment 1. This positive electrode active material 100 contains any one or more of an additive element X, an additive element Y, and an additive element Z. Details of the additive elements X, Y, and Z are described in <Contained element>. Note that the additive elements X, Y, and Z are collectively referred to as an additive element A in some cases.

Note that the positive electrode active material 100 is a main constituent material of the positive electrode active material layer 22, and the weight of the positive electrode active material 100 preferably accounts for higher than or equal to 50%, further preferably higher than or equal to 60%, still further preferably higher than or equal to 70% of the weight of the solid component in the positive electrode active material layer 22. Alternatively, when the particle diameter of the positive electrode active material 100 is too small, the surface area becomes too large, which might cause an excessive reaction between a positive electrode active material surface and the electrolyte. Accordingly, the particle diameter (median diameter (D50)) of the positive electrode active material is preferably larger than or equal to 10 μm. In the case where the particle diameter of the positive electrode active material is larger than the thickness of an active material layer described later, the particle density of the active material layer cannot be increased; thus, the particle diameter of the largest particle is preferably less than or equal to 50 μm.

The particle diameter can be measured with a particle size analyzer (laser diffraction particle size distribution analyzer,) or the like using a laser diffraction and scattering method. D50 is a particle diameter when accumulation of particles accounts for 50% of a cumulative curve in a measurement result of the particle size distribution. The particle size may be calculated by measuring the major diameter of the cross section of the particle obtained by analysis with a scanning electron microscope (SEM), a transmission electron microscope (TEM), or the like, instead of using laser diffraction particle size distribution measurement. Note that an example of a method for measuring D50 with a SEM, TEM, or the like includes a method for measuring 20 or more particles to make a cumulative curve, and setting a particle diameter when the accumulation of particles accounts for 50% as D50.

Note that in this specification and the like, unless otherwise specified, “charge voltage” is shown with reference to the potential of a lithium metal. In this specification and the like, high charge voltage is charge voltage, for example, higher than or equal to 4.5 V, preferably higher than or equal to 4.55 V, further preferably higher than or equal to 4.6 V, higher than or equal to 4.65 V, or higher than or equal to 4.7 V.

As described above, high charge voltage in this specification and the like is the voltage higher than or equal to 4.6 V with reference to the potential when a lithium metal is used for the negative electrode; however, high charge voltage is the voltage higher than or equal to 4.5 V with reference to the potential when a carbon material (e.g., graphite) is used for the negative electrode. In short, charge voltage higher than or equal to 4.6 V is referred to as high charge voltage in the case of using a lithium metal as the negative electrode in a half cell, and charge voltage higher than or equal to 4.5 V is referred to as high charge voltage in the case of using a carbon material (e.g., graphite) for the negative electrode in a full cell.

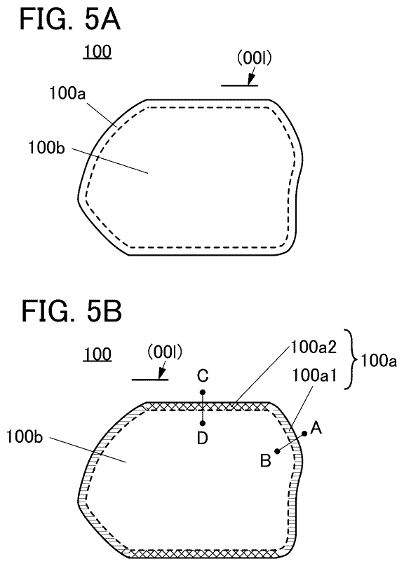

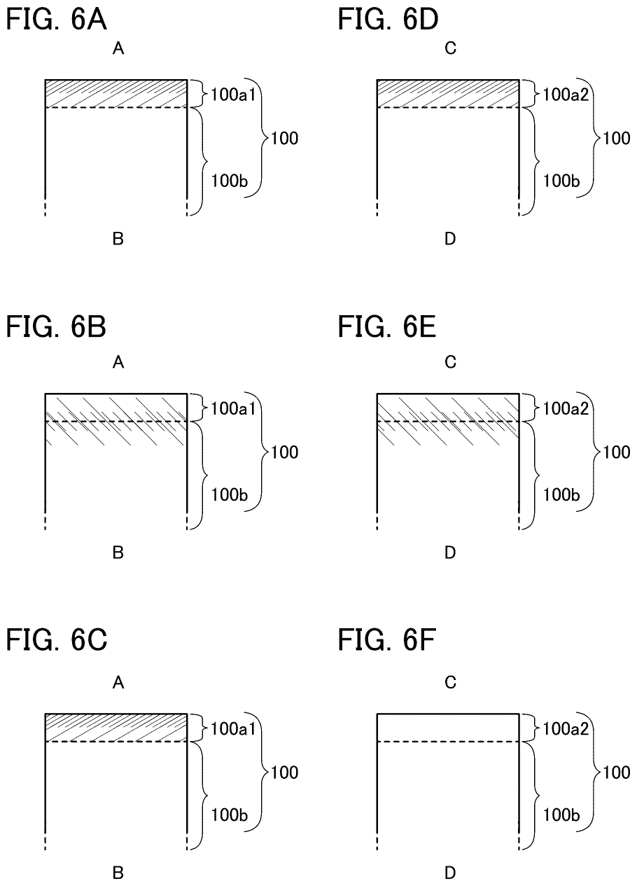

The positive electrode active material 100 that less deteriorates due to repetition of charge at high charge voltage and discharge is described with reference to FIGS. 5A to 6F.

FIGS. 5A and 5B are cross-sectional views of the positive electrode active material 100 of one embodiment of the present invention. FIGS. 6A to 6C illustrate enlarged views of a portion near the line A-B in FIG. 5B. FIGS. 6D to 6F illustrate enlarged views of a portion near the line C-D in FIG. 5B.

As illustrated in FIG. 5A, the positive electrode active material 100 includes a surface portion 100a and an inner portion 100b. In the drawings, the dashed line denotes a boundary between the surface portion 100a and the inner portion 100b.

The surface portion 100a of the positive electrode active material 100 refers to a region ranging from the surface toward the inner portion at a depth 50 nm or less, preferably 35 nm or less, further preferably 20 nm or less, and most preferably refers to a region ranging in a perpendicular direction or a substantially perpendicular direction from the surface toward the inner portion at a depth 10 nm or less. Note that “substantially perpendicular” refers to a state where an angle is greater than or equal to 80° and less than or equal to 100°. A plane generated by a crack can be considered as a surface. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

In the case where the positive electrode active material 100 has a layered rock-salt crystal structure of a space group R-3m, the surface portion 100a includes an edge region 100a1 and a basal region 100a2 as illustrated in FIG. 5B. Note that in FIGS. 5A and 5B, the straight line denoted by (001) represents a (001) plane. Here, the edge region 100a1 has a surface exposed in a direction intersecting with the (001) plane, and a region ranging from the surface toward the inner portion at a depth 50 nm or less, preferably 35 nm or less, further preferably 20 nm or less, and most preferably a region ranging in a perpendicular direction or a substantially perpendicular direction from the surface toward the inner portion at a depth 10 nm or less refer to the edge region 100a1. Here, “intersect” means that an angle between a perpendicular line of a first plane (the (001) plane) and a normal of a second plane (a surface of the positive electrode active material 100) is greater than or equal to 10° and less than or equal to 90°, preferably greater than or equal to 30° and less than or equal to 90°.

Moreover, the basal region 100a2 has a surface parallel to the (001) plane, and a region ranging from the surface toward the inner portion at a depth 50 nm or less, preferably 35 nm or less, further preferably 20 nm or less in depth, and most preferably a region ranging in a perpendicular direction or a substantially perpendicular direction from the surface toward the inner portion at a depth 10 nm or less refer to the basal region 100a2. Here, “parallel” means that an angle between the perpendicular line of the first plane (the (001) plane) and the normal of the second plane (the surface of the positive electrode active material 100) is greater than or equal to 0° and less than or equal to 5°, preferably greater than or equal to 0° and less than or equal to 2.5°.

The surface of the positive electrode active material 100 refers to a surface of a composite oxide that includes the surface portion 100a and the inner portion 100b, for example. Thus, the positive electrode active material 100 does not contain either a metal oxide, such as aluminum oxide (Al₂O₃), which is attached to a surface of the positive electrode active material 100 and does not include a lithium site contributing to charging and discharging; or a material such as a carbonate or a hydroxy group, which is chemically adsorbed after formation of the positive electrode active material. The attached metal oxide refers to, for example, a metal oxide having a crystal orientation different from that of the inner portion 100b.

The orientations of crystals in two regions being substantially aligned with each other can be judged, for example, from a TEM image, a STEM image, a HAADF-STEM image, an ABF-STEM image, an electron diffraction pattern, or an FFT pattern of a TEM image or the like. It can be determined also from an FFT pattern of a TEM image or an FFT pattern of a STEM image or the like. XRD, neutron diffraction, and the like can also be used for judging.

Furthermore, an electrolyte, a decomposition product, an organic solvent, a binder, a conductive material, and a compound originating from any of these that are attached to the positive electrode active material 100 are not contained either.

Since the positive electrode active material 100 is a compound containing oxygen and a transition metal into and from which lithium can be inserted and extracted, an interface between a region where oxygen and the transition metal M (Co, Ni, Mn, Fe, or the like) that is oxidized or reduced due to insertion and extraction of lithium exist and a region where oxygen and the transition metal M do not exist is considered as the surface of the positive electrode active material. A plane generated by slipping and/or a crack also can be considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

### <Contained Element>

The positive electrode active material 100 contains lithium, cobalt, oxygen, and an additive element. The positive electrode active material 100 can contain lithium cobalt oxide (LiCoO₂) to which an additive element is added. Note that the positive electrode active material 100 of one embodiment of the present invention preferably has a crystal structure described later, and thus the composition of the lithium cobalt oxide is not strictly limited to Li:Co:O=1:1:2.

A positive electrode active material of a lithium-ion secondary battery needs to contain a transition metal which can take part in an oxidation-reduction reaction in order to maintain a neutrally charged state even when lithium ions are inserted and extracted. It is preferable that the positive electrode active material 100 of one embodiment of the present invention mainly contain cobalt as a transition metal taking part in an oxidation-reduction reaction. In addition to cobalt, at least one or both of nickel and manganese may be contained. Using cobalt at higher than or equal to 75 at %, preferably higher than or equal to 90 at %, further preferably higher than or equal to 95 at % as the transition metal contained in the positive electrode active material 100 brings many advantages such as relatively easy synthesis, easy handling, and excellent cycle performance, which is preferable.

When cobalt is used as the transition metal contained in the positive electrode active material 100 at higher than or equal to 75 atomic %, preferably higher than or equal to 90 atomic %, further preferably higher than or equal to 95 atomic %, LiₓCoO₂ with small x is more stable than a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the d orbital of the transition metal. The influence of the Jahn-Teller effect is large in a composite oxide having a layered rock-salt crystal structure, such as lithium nickel oxide, in which octahedral coordinated low-spin nickel (III) accounts for the majority of the transition metal, and a layer having an octahedral structure formed of nickel and oxygen is likely to be distorted. Thus, there is a concern that the crystal structure may break in charge-discharge cycles. The size of a nickel ion is larger than the size of a cobalt ion and close to that of a lithium ion. Thus, there is a problem in that cation mixing between nickel and lithium is likely to occur in a composite oxide having a layered rock-salt crystal structure in which nickel accounts for the majority of the transition metal, such as lithium nickel oxide.

As the additive element contained in the positive electrode active material 100, one or more selected from magnesium, fluorine, nickel, aluminum, zirconium, vanadium, iron, manganese, chromium, niobium, arsenic, zinc, silicon, sulfur, phosphorus, boron, barium, bromine, and beryllium are preferably used. The total percentage of the transition metal among the additive elements is preferably lower than 25 atomic %, further preferably lower than 10 atomic %, still further preferably lower than 5 atomic %.

That is, for the positive electrode active material 100, one or more of lithium cobalt oxide containing magnesium, lithium cobalt oxide containing magnesium and aluminum, lithium cobalt oxide containing magnesium and nickel, lithium cobalt oxide containing magnesium, aluminum, and nickel, lithium cobalt oxide containing magnesium and fluorine, lithium cobalt oxide containing magnesium, fluorine, and nickel, lithium cobalt oxide containing magnesium, fluorine, nickel, and aluminum, and the like can be used.

As the positive electrode active material 100 in a lithium-ion battery, any one or more of a positive electrode active material containing cobalt, oxygen, and magnesium; a positive electrode active material containing cobalt, oxygen, magnesium, and aluminum; a positive electrode active material containing cobalt, oxygen, magnesium, and nickel; a positive electrode active material containing cobalt, oxygen, magnesium, aluminum, and nickel; a positive electrode active material containing cobalt, oxygen, magnesium, and fluorine; a positive electrode active material containing cobalt, oxygen, magnesium, fluorine, and aluminum; a positive electrode active material containing cobalt, oxygen, magnesium, fluorine, and nickel; a positive electrode active material containing cobalt, oxygen, magnesium, fluorine, nickel, and aluminum; and the like can be used.

The additive element is preferably dissolved in the positive electrode active material 100. For example, in STEM-EDX linear analysis, a position where the detection of the additive element in the depth direction begins is preferably at a deeper level than a position where the detection of the transition metal M begins, i.e., on the inner portion side of the positive electrode active material 100. The position where the detection of an element begins refers to a position where the amount of detected characteristic X-rays derived from the element starts to increase continuously.

Such an additive element further stabilizes the crystal structure of the positive electrode active material 100 as described later.

Note that as the additive element, magnesium, fluorine, nickel, aluminum, zirconium, vanadium, iron, manganese, chromium, niobium, arsenic, zinc, silicon, sulfur, phosphorus, boron, barium, bromine, or beryllium is not necessarily contained.

When the positive electrode active material 100 is substantially free from titanium, for example, the above advantage such as excellent cycle performance is enhanced. The weight of titanium contained in the positive electrode active material 100 is preferably less than or equal to 600 ppm, further preferably less than or equal to 100 ppm, for example. When the positive electrode active material 100 is subjected to STEM-EDX analysis, a characteristic X-ray attributed to titanium is not observed, that is, the characteristic X-ray indicating the presence of titanium is preferably lower than the lower detection limit (e.g., lower than 0.3 atomic %).

When the positive electrode active material 100 is substantially free from manganese, for example, the above advantages such as relatively easy synthesis, easy handling, and excellent cycle performance are enhanced. The weight of manganese contained in the positive electrode active material 100 is preferably less than or equal to 600 ppm, further preferably less than or equal to 100 ppm, for example.

The surface portion 100a is a region from which lithium ions are extracted first in charging, and tends to have a lower lithium concentration than the inner portion 100b. It can be said that bonds between atoms are partly cut on the surface of the particle of the positive electrode active material 100 included in the surface portion 100a. Therefore, the surface portion 100a is regarded as a region which is likely to be unstable and in which degradation of the crystal structure is likely to begin. Meanwhile, if the surface portion 100a can have sufficient stability, the layered structure, which is formed of octahedrons of cobalt and oxygen, of the inner portion 100b is difficult to break even when x in LiₓCoO₂ is small, e.g., 0.24 or less. Furthermore, a shift in layers, which are formed of octahedrons of cobalt and oxygen, of the inner portion 100b can be suppressed.

To obtain a stable composition and a stable crystal structure in the surface portion 100a, the surface portion 100a preferably contains an additive element, further preferably a plurality of additive elements. The surface portion 100a preferably contains one or more selected from the additive elements at higher concentrations than those in the inner portion 100b. The one or more selected from the additive elements contained in the positive electrode active material 100 preferably have concentration gradients. In addition, it is further preferable that the additive elements contained in the positive electrode active material 100 be differently distributed. For example, it is preferable that the additive elements exhibit concentration peaks at different depths from a surface. The concentration peak here refers to the local maximum value of the concentration in the surface portion 100a or the concentration in a portion ranging from the surface toward the inner portion at a depth 50 nm or less.

### [Distribution]

Distribution of the additive elements is described. FIGS. 6A to 6C illustrate enlarged views of a portion near the line A-B in FIG. 5B and describe the edge region 100al of the positive electrode active material 100. FIGS. 6D to 6F illustrate enlarged views of a portion near the line C-D in FIG. 5B and describe the basal region 100a2 of the positive electrode active material 100.

For example, some of the additive elements such as magnesium, fluorine, titanium, silicon, phosphorus, boron, and calcium preferably have a concentration gradient as illustrated in FIGS. 6A and 6D by gradation, in which the concentration increases from the inner portion 100b toward the surface. An additive element which has such a concentration gradient is referred to as the additive element X.

Another additive element such as aluminum or manganese preferably has a concentration gradient as represented by hatching in FIGS. 6B and 6E and exhibits a concentration peak in a deeper region than a concentration peek of the additive element X shown in FIGS. 6A and 6D. The concentration peak may be observed in the surface portion 100a or observed in a region deeper than the surface portion 100a. For example, the peak is preferably observed in a region that is greater than or equal to 5 nm and less than or equal to 30 nm in depth from the surface toward the inner portion. An additive element which has such a concentration gradient is referred to as the additive element Y.

Another additive element such as nickel or barium clearly exists in the edge region 100al but does not substantially exist in the basal region 100a2, in some cases, as represented by the presence or absence of hatching and the density of the hatching in FIGS. 6C and 6F. Note that here, “clearly exist” means a case where the energy spectrum of characteristic X-ray of the element is detected in cross-sectional STEM-EDX analysis of the positive electrode active material 100. Note that here, “not substantially exist” means a case where the energy spectrum of characteristic X-ray of the element is not detected in cross-sectional STEM-EDX analysis of the positive electrode active material 100. This phenomenon is also expressed that the amount of the element is below the lower detection limit in STEM-EDX analysis. This case can also be said that the amount of the element is below the lower detection limit in STEM-EDX analysis. An additive element which has such distribution is referred to as the additive element Z.

Magnesium, which is an example of the additive element X, is divalent, and a magnesium ion is more stable in lithium sites than in cobalt sites in a layered rock-salt crystal structure; thus, magnesium is likely to enter the lithium sites. An appropriate concentration of magnesium at the lithium sites of the surface portion 100a facilitates maintenance of the layered rock-salt crystal structure. This is probably because magnesium at the lithium sites serves as a column supporting the CoO₂ layers. Moreover, magnesium can inhibit extraction of oxygen therearound in a state where x in LiₓCoO₂ is, for example, 0.24 or less. The presence of magnesium is also expected to increase the density of the positive electrode active material 100. In addition, a high magnesium concentration in the surface portion 100a can be expected to increase the corrosion resistance to hydrofluoric acid generated by the decomposition of the electrolyte solution.

An appropriate concentration of magnesium can bring the above-described advantages without an adverse effect on insertion and extraction of lithium in charging and discharging. However, excess magnesium might adversely affect insertion and extraction of lithium. Furthermore, the effect of stabilizing the crystal structure might be reduced. This is probably because magnesium enters the cobalt sites as well as the lithium sites. Moreover, an excess magnesium compound (e.g., an oxide or a fluoride) which is substituted for neither the lithium site nor the cobalt site might segregate at the surface of the positive electrode active material or the like to serve as a resistance component of a secondary battery. As the magnesium concentration of the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100 preferably contains an appropriate amount of magnesium. The number of magnesium atoms is preferably greater than or equal to 0.001 times and less than or equal to 0.1 times, further preferably greater than 0.01 times and less than 0.04 times, still further preferably approximately 0.02 times the number of cobalt atoms, for example. The amount of magnesium contained in the entire positive electrode active material 100 may be, for example, a value obtained by element analysis on the entire positive electrode active material 100 with glow discharge mass spectrometry (GD-MS), inductively coupled plasma mass spectrometry (ICP-MS), or the like or may be a value based on the ratio of the raw materials mixed in the process of forming the positive electrode active material 100.

Aluminum, which is an example of the additive element Y, can exist in a cobalt site in a layered rock-salt crystal structure. Since aluminum is a trivalent representative element and its valence does not change, lithium around aluminum is less likely to move even in charging and discharging. Thus, aluminum and lithium around aluminum serve as columns to suppress a change in the crystal structure. Furthermore, aluminum has an effect of inhibiting elution of cobalt around aluminum and improving continuous charging tolerance. Moreover, an Al—O bond is stronger than a Co—O bond and thus extraction of oxygen around aluminum can be inhibited. These effects improve thermal stability. Therefore, a secondary battery that includes the positive electrode active material 100 containing aluminum as the additive element can have higher level of safety. In addition, the positive electrode active material 100 having a crystal structure that is unlikely to be broken by repeated charging and discharging can be provided.

Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably higher than or equal to 0.05% and lower than or equal to 4%, further preferably higher than or equal to 0.1% and lower than or equal to 2%, still further preferably higher than or equal to 0.3% and lower than or equal to 1.5% of the number of cobalt atoms. Alternatively, the number of aluminum atoms is preferably higher than or equal to 0.05% and lower than or equal to 2% of the number of cobalt atoms. Alternatively, the number of aluminum atoms is preferably higher than or equal to 0.1% and lower than or equal to 4% of the number of cobalt atoms. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

Nickel, which is an example of the additive element Z, can exist in both the cobalt site and the lithium site. Nickel preferably exists in the cobalt site because a lower oxidation-reduction potential can be obtained as compared with the case where only cobalt exists in the cobalt site, leading to an increase in discharge capacity.

In addition, when nickel exists at a lithium site, a shift in the layered structure formed of octahedrons of cobalt and oxygen can be inhibited. Moreover, a change in volume in charging and discharging is inhibited. Furthermore, an elastic modulus becomes large, i.e., hardness increases. This is probably because nickel at the lithium sites also serves as a column supporting the CoO₂ layers. Therefore, in particular, the crystal structure is expected to be more stable in a charged state at high temperatures, e.g., 45° C. or higher, which is preferable.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, in the positive electrode active material 100, the number of nickel atoms is preferably higher than 0% and lower than or equal to 7.5%, further preferably higher than or equal to 0.05% and lower than or equal to 4%, still further preferably higher than or equal to 0.1% and lower than or equal to 2%, yet still further preferably higher than or equal to 0.2% and lower than or equal to 1% of the number of cobalt atoms. Alternatively, it is preferably higher than 0% and lower than or equal to 4%. Alternatively, it is preferably higher than 0% and lower than or equal to 2%. Alternatively, the number of nickel atoms is preferably higher than or equal to 0.05% and lower than or equal to 7.5% of the number of cobalt atoms. Alternatively, the number of nickel atoms is preferably higher than or equal to 0.05% and lower than or equal to 2% of the number of cobalt atoms. Alternatively, the number of nickel atoms is preferably higher than or equal to 0.1% and lower than or equal to 7.5% of the number of cobalt atoms. Alternatively, the number of nickel atoms is preferably higher than or equal to 0.1% and lower than or equal to 4% of the number of cobalt atoms. The amount of nickel described here may be a value obtained by element analysis on the entire positive electrode active material with GD-MS, ICP-MS, or the like or may be a value based on the ratio of the raw materials mixed in the process of forming the positive electrode active material, for example.

When fluorine, which is a monovalent anion and is an example of the additive element X, is substituted for part of oxygen in the surface portion 100a, the lithium extraction energy is lowered. This is because the change in valence of cobalt ions associated with lithium extraction is trivalent to tetravalent in the case of not containing fluorine and divalent to trivalent in the case of containing fluorine, and the oxidation-reduction potential differs therebetween. It can thus be said that when fluorine is substituted for part of oxygen in the surface portion 100a of the positive electrode active material 100, lithium ions near fluorine are likely to be extracted and inserted smoothly. Thus, a secondary battery including the positive electrode active material 100 can have improved charge and discharge characteristics, improved large current characteristics, or the like. When fluorine exists in the surface portion 100a, which has a surface in contact with the electrolyte solution, the corrosion resistance to hydrofluoric acid can be effectively increased. As described in Embodiment 1, a fluoride such as lithium fluoride that has a lower melting point than another additive element source can serve as a fusing agent (also referred to as a flux) for lowering the melting point of the other additive element source.

As illustrated in FIGS. 6A and 6C, when the surface portion 100a contains both magnesium and nickel, divalent nickel might be able to exist more stably in the vicinity of divalent magnesium. Thus, elution of magnesium can be inhibited even when x in LiₓCoO₂ is small. This can contribute to stabilization of the surface portion 100a.

Additive elements that are differently distributed, such as the additive elements X, Y, and Z are preferably contained at a time, in which case the crystal structure of a wider region can be stabilized. For example, the crystal structure of a wider region can be stabilized in the case where the positive electrode active material 100 contains all of magnesium, which is an example of the additive element X; aluminum, which is an example of the additive element Y; and nickel, which is an example of the additive element Z as compared with the case where only one or two of the additive elements X, Y, and Z are contained. In the case where the positive electrode active material 100 contains all of the additive elements X, Y, and Z as described above, the surface can be sufficiently stabilized by the additive element X such as magnesium and the additive element Z such as nickel; thus, the additive element Y such as aluminum is not necessary for the surface. It is preferable that aluminum be widely distributed in a deeper region. For example, it is preferable that aluminum be continuously detected in a region extending from the surface to 1 nm to 25 nm, both inclusive, in depth. It is preferable that aluminum be widely distributed in such a manner because the crystal structure in a wider region can be stabilized.

In the case where a large number of additive elements Z are contained in the edge region 100a1 (also referred to as preferentially contained, selectively contained, or the like) as illustrated in FIGS. 6C and 6F, the stability of the crystal structure of the edge region 100a1 for insertion and extraction of lithium ions into/from the positive electrode active material 100 in charging and discharging of a lithium-ion battery is increased, which is preferable. In the case where the additive element Z has such distribution, for example, in the case where the positive electrode active material 100 is lithium cobalt oxide, an influence of adding the additive element Z, such as a decrease in discharge voltage or a decrease in discharge capacity, can be kept to the minimum, which is preferable.

When the plurality of additive elements are contained as described above, the effects of the additive elements can contribute synergistically to further stabilization of the surface portion 100a. In particular, magnesium, nickel, and aluminum are preferably contained, in which case a high effect of stabilizing the composition and the crystal structure can be obtained. In particular, the surface portion 100a of the positive electrode active material 100 preferably includes a region where distribution of magnesium is closer to the surface than distribution of aluminum. Furthermore, in addition to the above-described region where magnesium and aluminum are distributed, a region where the distribution of nickel and the distribution of magnesium overlap with each other is most preferably included in the edge region 100a1 in the surface portion 100a of the positive electrode active material 100.

### <Crystal Structure>

<x in LiₓCoO₂ being 1>

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt crystal structure has high discharge capacity and a two-dimensional diffusion path for lithium ions and is thus suitable for an insertion/extraction reaction of lithium ions, and is favorably used as a positive electrode active material of a secondary battery accordingly. For this reason, it is particularly preferable that the inner portion 100b, which accounts for the majority of the volume of the positive electrode active material 100, have a layered rock-salt crystal structure.

Meanwhile, the surface portion 100a of the positive electrode active material 100 of one embodiment of the present invention preferably has a function of reinforcing the layered structure, which is formed of octahedrons of the transition metal M and oxygen, of the inner portion 100b so that the layered structure does not break even when lithium is extracted from the positive electrode active material 100 by charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibition of a change in the structures of the surface portion 100a and the inner portion 100b of the positive electrode active material 100, due to extraction of oxygen and the like, and/or inhibition of oxidative decomposition of an electrolyte on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (25° C.). For example, at least part of the surface portion 100a of the positive electrode active material 100 of one embodiment of the present invention preferably has a rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

It is preferable that some additive elements A, in particular, magnesium, nickel, and aluminum have higher concentrations in the surface portion 100a than in the inner portion 100b and is present randomly also in the inner portion 100b at low concentrations. When magnesium and aluminum are present at the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of the transition metal M and oxygen can be inhibited in a manner similar to the above. Also in the case where both magnesium and nickel are contained, a synergistic effect of inhibiting elution of magnesium can be expected since divalent magnesium can be present more stably in the vicinity of divalent nickel.

It is preferable that the crystal structure continuously change from the inner portion 100b toward the surface owing to the above-described concentration gradient of the additive element A. Alternatively, it is preferable that the orientations of a crystal in the surface portion 100a and a crystal in the inner portion 100b be substantially aligned with each other.

For example, a crystal structure preferably changes continuously from the inner portion 100b that has a layered rock-salt crystal structure toward the surface and the surface portion 100a that have a feature of a rock-salt crystal structure or features of both a rock-salt crystal structure and a layered rock-salt crystal structure. Alternatively, the orientations of a crystal in the surface portion 100a that has the feature of a rock-salt crystal structure or the features of both a rock-salt crystal structure and a layered rock-salt crystal structure and a crystal in the layered rock-salt inner portion 100b are preferably substantially aligned with each other.

Note that in this specification and the like, a layered rock-salt crystal structure, which belongs to the space group R-3m, of a composite oxide containing lithium and a transition metal M such as cobalt refers to a crystal structure in which a rock-salt ion arrangement where cations and anions are alternately arranged is included and lithium and the transition metal M are regularly arranged to form a two-dimensional plane, so that lithium can diffuse two-dimensionally. Note that a defect such as a cation or anion vacancy may be present. In the layered rock-salt crystal structure, strictly, a lattice of a rock-salt crystal is distorted in some cases.

A rock-salt crystal structure is a structure in which a cubic crystal structure such as a crystal structure belonging to a space group Fm-3m is included and cations and anions are alternately arranged. Note that a cation or anion vacancy may be present.

Having features of both a layered rock-salt crystal structure and a rock-salt crystal structure can be determined by electron diffraction, a TEM image, a cross-sectional STEM image, or the like.

There is no distinction among cation sites in a rock-salt crystal structure. Meanwhile, a layered rock-salt crystal structure has two types of cation sites: one type is mostly occupied by lithium, and the other is occupied by the transition metal M. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in a rock-salt crystal structure in an ideal state, for instance, and on the (003) plane in a layered rock-salt crystal structure in an ideal state, for instance. For example, when electron diffraction patterns of rock-salt MgO and layered rock-salt LiCoO₂ are compared to each other, the distance between the bright spots on the (003) plane of LiCoO₂ is observed at a position approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged is seen in an electron diffraction pattern. A bright spot common between the rock-salt and layered rock-salt crystal structures has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium is present in part of the layers with low luminance, i.e., the lithium layers.

Anions of a layered rock-salt crystal and anions of a rock-salt crystal form a cubic close-packed structure (face-centered cubic lattice structure). Anions of an O3′ type crystal, which is described later, are presumed to form a cubic close-packed structure. Thus, when a layered rock-salt crystal and a rock-salt crystal are in contact with each other, there is a crystal plane at which orientations of cubic close-packed structures formed of anions are aligned with each other.

The description can also be made as follows. An anion on the {111} plane of a cubic crystal structure has a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111} plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that a space group of the layered rock-salt crystal and the O3′ type crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ type crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other.

<x in LiₓCoO₂ is Small>

The crystal structure in a state where x in LiₓCoO₂ is small of the positive electrode active material 100 of one embodiment of the present invention is different from that of a conventional positive electrode active material because the positive electrode active material 100 has the above-described distribution of the additive element A and/or crystal structure in a discharged state. Here, “x is small” means 0.1<x≤0.24.

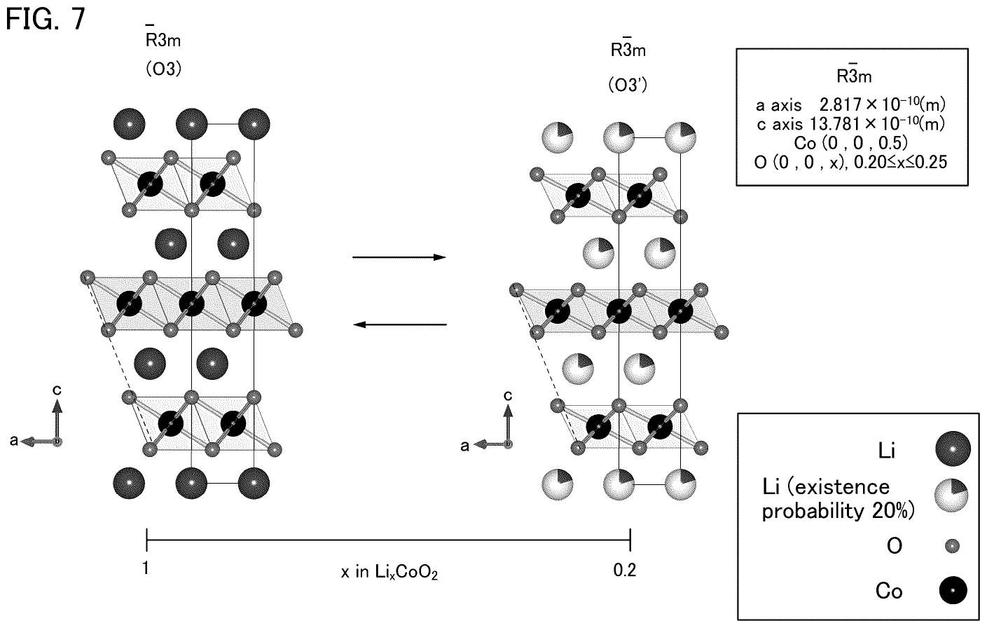

A conventional positive electrode active material and the positive electrode active material 100 of one embodiment of the present invention are compared, and changes in the crystal structures owing to a change in x in LiₓCoO₂ will be described with reference to FIGS. 7 to 10.

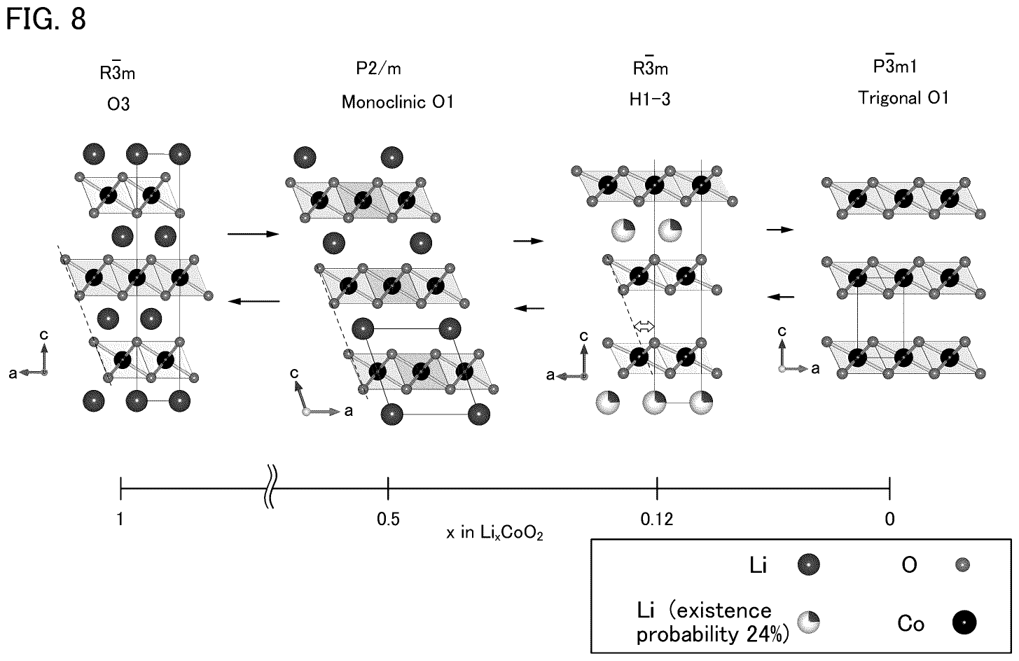

A change in the crystal structure of the conventional positive electrode active material is shown in FIG. 8. The conventional positive electrode active material shown in FIG. 8 is lithium cobalt oxide (LiCoO₂) containing no additive element A.

In FIG. 8, the crystal structure of lithium cobalt oxide with x in LiₓCoO₂ being 1 is denoted by R-3m O3. In this crystal structure, lithium occupies octahedral sites and a unit cell includes three CoO₂ layers. Thus, this crystal structure is referred to as an O3 type structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3 ml and includes one CoO₂ layer in a unit cell. Hence, this crystal structure is referred to as an O1 type structure or a trigonal O1 type structure in some cases. Moreover, in some cases, this crystal structure is referred to as a hexagonal O1 type structure when a trigonal crystal system is converted into a composite hexagonal lattice.

Conventional lithium cobalt oxide with x of approximately 0.12 has the crystal structure belonging to the space group R-3m. This structure can also be regarded as a structure in which CoO₂ structures such as a trigonal O1 type structure and LiCoO₂ structures such as an R-3m O3 type structure are alternately stacked. Thus, this crystal structure is sometimes referred to as an H1-3 type structure. Note that the number of cobalt atoms per unit cell in the actual H1-3 type structure is twice that in other structures. However, in this specification including FIG. 8, the c-axis of the H1-3 type structure is half that of the unit cell for easy comparison with the other crystal structures.

For the H1-3 type structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). Note that O1 and O2 are each an oxygen atom. A preferred unit cell for representing a crystal structure in a positive electrode active material can be selected by Rietveld analysis of XRD patterns, for example. In this case, a unit cell such that the value of goodness of fit (GOF) is small can be used.

When charging that makes x in LiₓCoO₂ be 0.24 or less and discharging are repeated, the crystal structure of conventional lithium cobalt oxide repeatedly changes between the R-3m O3 type structure in a discharged state and the H1-3 type structure (i.e., an unbalanced phase change).

However, there is a large shift in the CoO₂ layers between these two crystal structures. As denoted by the dotted lines and the arrows in FIG. 8, the CoO₂ layer in the H1-3 type structure largely shifts from that in the structure belonging to R-3m O3 in a discharged state. Such a dynamic structural change can adversely affect the stability of the crystal structure.

A difference in volume between the two crystal structures is also large. When the H1-3 type structure and the R-3m O3 type structure in a discharged state contain the same number of cobalt atoms, these structures have a difference in volume of greater than 3.5%, typically greater than or equal to 3.9%.

In addition, a structure in which CoO₂ layers are arranged continuously, as in the trigonal O1 type structure, included in the H1-3 type structure is highly likely to be unstable.

Accordingly, when charging that makes x be 0.24 or less and discharging are repeated, the crystal structure of conventional lithium cobalt oxide is gradually broken. The broken crystal structure triggers degradation of the cycle performance. This is because the broken crystal structure has a smaller number of sites which lithium can occupy stably and makes it difficult to insert and extract lithium.

Meanwhile, in the positive electrode active material 100 of one embodiment of the present invention shown in FIG. 7, a change in the crystal structure between a discharged state with x in LiₓCoO₂ of 1 and a state with x of 0.24 or less is smaller than that in a conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charging that makes x be 0.24 or less and discharging are repeated, and obtain excellent cycle performance. In addition, the positive electrode active material 100 of one embodiment of the present invention with x in LiₓCoO₂ of 0.24 or less can have a more stable crystal structure than a conventional positive electrode active material. Thus, in the positive electrode active material 100 of one embodiment of the present invention, a short circuit is less likely to occur in a state where x in LiₓCoO₂ is kept at 0.24 or less. This is preferable because the safety of a secondary battery is further improved.

FIG. 7 shows crystal structures of the inner portion 100b of the positive electrode active material 100 in a state where x in LiₓCoO₂ is 1 and approximately 0.2. The inner portion 100b, accounting for the majority of the volume of the positive electrode active material 100, largely contributes to charging and discharging and is accordingly a portion where a shift in CoO₂ layers and a volume change matter most.

The positive electrode active material 100 with x of 1 has the R-3m O3 type structure, which is the same as that of conventional lithium cobalt oxide.

However, in a state where x is 0.24 or less, e.g., approximately 0.2 or approximately 0.12, the positive electrode active material 100 has a crystal structure different from the H1-3 type structure of conventional lithium cobalt oxide.

The positive electrode active material 100 of one embodiment of the present invention with x of approximately 0.2 has a trigonal crystal structure belonging to the space group R-3m. The symmetry of the CoO₂ layers of this structure is the same as that of the O3 type structure. Thus, this crystal structure is referred to as an O3′ type structure. In FIG. 7, this crystal structure is denoted by R-3m O3′.

Note that in the unit cell of the O3′ type structure, the coordinates of cobalt and oxygen can be represented by Co (0, 0, 0.5) and ((0, 0, x) within the range of 0.20≤x≤0.25. In the unit cell, the lattice constant of the a-axis is preferably 2.797≤a≤2.837 (×10⁻¹ nm), further preferably 2.807≤a≤2.827 (×10⁻¹ nm), typically a=2.817 (×10⁻¹ nm). The lattice constant of the c-axis is preferably 13.681≤c≤13.881 (×10⁻¹ nm), further preferably 13.751≤c≤13.811 (×10⁻¹ nm), typically, c=13.781 (×10⁻¹ nm).

In the O3′ type structure, an ion of cobalt, nickel, magnesium, or the like occupies a site coordinated to six oxygen atoms. Note that a light element such as lithium sometimes occupies a site coordinated to four oxygen atoms.

As denoted by the dotted lines in FIG. 7, the CoO₂ layers hardly shift between the R-3m (O3) type structure in a discharged state and the O3′ type structure.

The R-3m (O3) type structure in a discharged state and the O3′ type structure that contain the same number of cobalt atoms have a difference in volume of 2.5% or less, specifically 2.2% or less, typically 1.8%.

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume in the case where the positive electrode active materials having the same number of cobalt atoms are compared is reduced. Thus, the crystal structure of the positive electrode active material 100 is less likely to break even when charging that makes x be 0.24 or less and discharging are repeated. Therefore, a decrease in charge and discharge capacity of the positive electrode active material 100 in charge-discharge cycles is reduced. Furthermore, the positive electrode active material 100 can stably use a large amount of lithium than a conventional positive electrode active material and thus has large discharge capacity per weight and per volume. Thus, with use of the positive electrode active material 100, a secondary battery with large discharge capacity per weight and per volume can be fabricated.

Note that the positive electrode active material 100 actually has the O3′ type structure in some cases when x in LiₓCo₂ is greater than or equal to 0.15 and less than or equal to 0.24, and is assumed to have the O3′ type structure even when x is greater than 0.24 and less than or equal to 0.27. However, the crystal structure is influenced by not only x in LiₓCoO₂ but also the number of charge-discharge cycles, a charge current and a discharge current, temperature, an electrolyte, and the like, so that the range of x is not limited to the above.

Hence, when x in LiₓCoO₂ in the positive electrode active material 100 is greater than 0.1 and less than or equal to 0.24, not all of the inner portion 100b of the positive electrode active material 100 has to have the O3′ type structure. Some of the particles may have another crystal structure or be amorphous.

In order to make x in LiₓCoO₂ small, charging at a high charge voltage is necessary in general. Therefore, the state where x in LiₓCoO₂ is small can be rephrased as a state where charging at a high charge voltage has been performed. For example, when CC/CV charging is performed at 25° C. and 4.6 V or higher using the potential of a lithium metal as a reference, the H1-3 type structure appears in a conventional positive electrode active material. Therefore, a charge voltage of 4.6 V or higher can be regarded as a high charge voltage with reference to the potential of a lithium metal.

That is, the positive electrode active material 100 of one embodiment of the present invention is preferable because the positive electrode active material 100 can maintain the R-3m O3 type structure having symmetry even when charging at a high charge voltage, e.g., 4.6 V or higher at 25° C., is performed. Moreover, the positive electrode active material 100 of one embodiment of the present invention is preferable because the O3′ type structure can be obtained when charging at a higher charge voltage, e.g., a voltage higher than or equal to 4.65 V and lower than or equal to 4.7 V is performed at 25° C.

At a far higher charge voltage, the H1-3 type structure is eventually observed in the positive electrode active material 100 in some cases. As described above, the crystal structure is affected by the number of charge-discharge cycles, a charge current and a discharge current, temperature, an electrolyte, and the like, so that the positive electrode active material 100 of one embodiment of the present invention sometimes has the O3′ type structure even at a lower charge voltage, e.g., a charge voltage higher than or equal to 4.5 V and lower than 4.6 V at 25° C.

Note that in the case where graphite is used as a negative electrode active material in a secondary battery, the voltage of the secondary battery is lower than the above-mentioned voltages by the potential of graphite. The potential of graphite is approximately 0.05 V to 0.2 V with reference to the potential of a lithium metal. Therefore, in the case of a secondary battery using graphite as a negative electrode active material, a similar crystal structure is obtained at a voltage corresponding to a difference between the above-described voltage and the potential of the graphite.

Although a chance of the presence of lithium in all lithium sites is the same in the O3′ type structure in FIG. 7, the present invention is not limited thereto. Lithium may exist unevenly in only some of the lithium sites. For example, lithium may be symmetrically present as in the monoclinic O1 type structure (Li_{0.5}CoO₂) in FIG. 8. Distribution of lithium can be analyzed by neutron diffraction, for example.

The O3′ type structure can be regarded as a crystal structure that contains lithium between layers randomly and is similar to a CdCl₂ crystal structure. The crystal structure similar to the CdCl₂ crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ crystal structure generally.

The concentration gradient of the additive element A is preferably similar in a plurality of portions of the surface portion 100a of the positive electrode active material 100. In other words, it is preferable that the reinforcement derived from the additive element A uniformly occurs in the surface portion 100a. Even when the surface portion 100a partly has reinforcement, stress might be concentrated on parts that do not have reinforcement. The concentration of stress on part of the positive electrode active material 100 might cause defects such as cracks from that part, leading to cracking of the positive electrode active material and a decrease in discharge capacity.

Note that the additive element A does not necessarily have similar concentration gradients throughout the surface portion 100a of the positive electrode active material 100. FIG. 6D shows an example of distribution of the additive element X in the portion near the line C-D in FIG. 5B, and FIG. 6E shows an example of distribution of the additive element Y in the portion near the line C-D in FIG. 5B.

Here, the portion near the line C-D has a layered rock-salt crystal structure belonging to R-3m and the surface of the portion has a (001) orientation. The distribution of the additive element A at the surface having a (001) orientation may be different from that at other surfaces. For example, concentration peaks of one or more selected from the additive element X and the additive element Y may be distributed shallower from the surface having a (001) orientation and the surface portion 100a thereof than from a surface having an orientation other than a (001) orientation. Alternatively, the surface having a (001) orientation and the surface portion 100a thereof may have a lower concentration of one or more selected from the additive element X and the additive element Y than a surface having an orientation other than a (001) orientation. Further alternatively, at the surface having a (001) orientation and the surface portion 100a thereof, the concentration of one or more selected from the additive element X and the additive element Y may be below the lower detection limit.

In a layered rock-salt crystal structure belonging to R-3m, cations are arranged parallel to the (001) plane. In other words, a CoO₂ layer and a lithium layer are alternately stacked parallel to the (001) plane. Accordingly, a diffusion path of lithium ions also exists parallel to the (001) plane.

The CoO₂ layer is relatively stable and thus, the surface of the positive electrode active material 100 is more stable when having the (001) orientation. A main diffusion path of lithium ions in charging and discharging is not exposed at the (001) plane.

By contrast, a diffusion path of lithium ions is exposed at a surface having an orientation other than the (001) orientation. Thus, the surface having an orientation other than the (001) orientation and the surface portion 100a easily lose stability because they are regions where extraction of lithium ions starts as well as important regions for maintaining a diffusion path of lithium ions. It is thus extremely important to reinforce the surface having an orientation other than a (001) orientation and the surface portion 100a for maintaining the crystal structure of the whole positive electrode active material 100.

Accordingly, in the positive electrode active material 100 of another embodiment of the present invention, it is important to distribute the additive element A at the surface having an orientation other than a (001) orientation and the surface portion 100a thereof as shown in FIGS. 6A to 6C. By contrast, at the surface having the (001) orientation and the surface portion 100a thereof, the concentration of the additive element A may be low as described above or the additive element A may be absent.

In the formation method as described in Embodiment 1, in which high-purity LiCoO₂ is formed, the additive element A is mixed afterwards, and heating is performed, the additive element A spreads mainly through a diffusion path of lithium ions. Thus, distribution of the additive element A at the surface having an orientation other than the (001) orientation and the surface portion 100a thereof can easily fall within a preferred range.

### <Crystal Grain Boundary>

It is further preferable that the additive element A contained in the positive electrode active material 100 of one embodiment of the present invention have the above-described distribution and be at least partly unevenly distributed at the crystal grain boundary and the vicinity thereof.

Note that in this specification and the like, uneven distribution means that the concentration of an element in a certain region differs from those in other regions. This may be rephrased as segregation, precipitation, unevenness, deviation, or a mixture of a high-concentration portion and a low-concentration portion.

For example, the magnesium concentration at the crystal grain boundary and the vicinity thereof in the positive electrode active material 100 is preferably higher than that in the other regions in the inner portion 100b. In addition, the fluorine concentration at the crystal grain boundary and the vicinity thereof is preferably higher than that in the other regions in the inner portion 100b. In addition, the nickel concentration at the crystal grain boundary and the vicinity thereof is preferably higher than that in the other regions in the inner portion 100b. In addition, the aluminum concentration at the crystal grain boundary and the vicinity thereof is preferably higher than that in the other regions in the inner portion 100b.

A crystal grain boundary is regarded as a plane defect. Thus, the crystal grain boundary tends to be unstable and the crystal structure easily starts to change like the surface of the particle. Thus, the higher the concentration of the additive element A at the crystal grain boundary and the vicinity thereof is, the more effectively the change in the crystal structure can be reduced.

In the case where the magnesium concentration and the fluorine concentration are high at the crystal grain boundary and the vicinity thereof, the magnesium concentration and the fluorine concentration in the vicinity of a surface generated by a crack are also high even if the crack is generated along the crystal grain boundary of the positive electrode active material 100 of one embodiment of the present invention. Thus, the positive electrode active material including a crack can also have an increased corrosion resistance to hydrofluoric acid.

### <Analysis Method>

Whether or not a positive electrode active material is the positive electrode active material 100 of one embodiment of the present invention, which has the O3′ type structure when x in LiₓCoO₂ is small, can be determined by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example. Among some kinds of XRD, powder XRD enables that diffraction peaks appearing in powder XRD patterns reflect the crystal structure of the inner portion 100b of the positive electrode active material 100, which accounts for the majority of the volume of the positive electrode active material 100.

In the case where the crystallite size is measured by powder XRD, the measurement is preferably performed while the influence of orientation of positive electrode active materials due to pressure or the like is removed. For example, it is preferable that the positive electrode active material be taken out from a positive electrode obtained from a disassembled secondary battery, the positive electrode active material be made into a powder sample, and then the measurement be performed.

As described above, the feature of the positive electrode active material 100 of one embodiment of the present invention is a small change in the crystal structure between a state with x in LiₓCoO₂ of 1 and a state with x of 0.24 or less. A material 50% or more of which has the crystal structure to be largely changed by high-voltage charge is not preferable because the material cannot withstand repetition of high-voltage charging and discharging.

It is noted that the O3′ type structure is not obtained in some cases only by addition of the additive element. For example, in a state with x in LiₓCoO₂ of 0.24 or less, lithium cobalt oxide containing magnesium and fluorine or lithium cobalt oxide containing magnesium and aluminum has the O3′ type structure at 60% or more in some cases, and has the H1-3 type structure at 50% or more in other cases, depending on the concentration and distribution of the additive element.

In addition, in a state where x in LiₓCoO₂ is too small, e.g., 0.1 or less, or charge voltage is higher than 4.9 V, the positive electrode active material 100 of the present invention might have the H1-3 structure or the trigonal O1 structure. Thus, to determine whether or not a positive electrode active material is the positive electrode active material 100 of one embodiment of the present invention, analysis of the crystal structure by XRD and other methods and data such as charge capacity or charge voltage are needed.

Note that the crystal structure of a positive electrode active material in a state with small x may be changed when the positive electrode active material is exposed to the air. For example, the O3′ type structure changes into the H1-3 type structure in some cases. For that reason, all samples to be used for analysis of the crystal structure are preferably handled in an inert atmosphere such as an argon atmosphere.

Whether the additive element contained in a positive electrode active material has the above-described distribution can be judged by analysis using XPS, EDX, an electron probe microanalyzer (EPMA), or the like.

The crystal structure of the surface portion 100a, the crystal grain boundary, or the like can be analyzed by electron diffraction of a cross section of the positive electrode active material 100, for example.

### <Charing Method>

Whether or not a composite oxide is the positive electrode active material 100 of one embodiment of the present invention can be determined by charging a CR2032 coin cell (with a diameter of 20 mm and a height of 3.2 mm) that is formed using the composite oxide for a positive electrode and a lithium metal for a counter electrode, for example. The coin cell includes an electrolyte solution, a separator, a positive electrode can, and a negative electrode can.

More specifically, a positive electrode can be formed by application of a slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at a volume ratio of 3:7 and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated with the above conditions is charged with a given voltage (e.g., 4.5 V, 4.55 V, 4.58 V, 4.60 V, 4.62 V, 4.65 V, 4.7 V, 4.75 V, or 4.8 V). The charging method is not particularly limited as long as charging with a given voltage can be performed for sufficient time. Note that in this specification and the like, the term “approximately 4.6 V” refers to a voltage higher than or equal to 4.58 V and lower than or equal to 4.62 V. In the case of CCCV charging, for example, CC charging can be performed with a current higher than or equal to 20 mA/g and lower than or equal to 100 mA/g, and CV charging can be ended with a current higher than or equal to 2 mA/g and lower than or equal to 10 mA/g. To observe a phase change of the positive electrode active material, charging with such a small current value is preferably performed. The temperature is set to 25° C. or 45° C. After the charging is performed in this manner, the coin cell is disassembled in a glove box with an argon atmosphere to take out the positive electrode, whereby the positive electrode active material with predetermined charge capacity can be obtained. In order to inhibit a reaction with components in the external environment, the taken positive electrode active material is preferably enclosed in an argon atmosphere for various analyses to be performed later. For example, XRD can be performed on the positive electrode active material enclosed in an airtight container with an argon atmosphere. After the charging is completed, the positive electrode is preferably taken out immediately and analyzed. Specifically, the positive electrode is preferably analyzed within an hour after the completion of the charging, further preferably 30 minutes after the completion of the charging.

In the case where the crystal structure in a charged state after multiple-time charging and discharging is analyzed, the charging and discharging can be performed in the following manner. As charging, constant current charging is performed with a current value greater than or equal to 20 mA/g and less than or equal to 100 mA/g until the voltage reaches a given value (e.g., 4.50 V, 4.55 V, 4.58 V, 4.60 V, 4.62 V, 4.65 V, 4.70 V, 4.75 V, or 4.80 V), and then constant voltage charging is performed until the current value becomes greater than or equal to 2 mA/g and less than or equal to 10 mA/g; as discharging, constant current discharging is performed with a current value greater than or equal to 20 mA/g and less than or equal to 100 mA/g until the voltage reaches 2.5 V. Alternatively, as discharging, constant current discharging can be performed with a current value greater than or equal to 20 mA/g and less than or equal to 200 mA/until the voltages reaches 3.0 V.

Also in the case where the crystal structure in a discharged state after multiple-time charging and discharging is analyzed, constant current discharging can be performed with a current value greater than or equal to 20 mA/g and less than or equal to 200 mA/g until the voltage reaches 2.5 V, for example. Alternatively, constant current discharging can be performed with a current value greater than or equal to 20 mA/g and less than or equal to 200 mA/g until the voltage reaches 3.0 V.

### <XRD>

The apparatus and conditions adopted in the XRD measurement are not particularly limited. The measurement can be performed with the apparatus and conditions as described below, for example. XRD apparatus: D8 ADVANCE produced by Bruker AXS, X-ray source: CuKα₁ radiation, output: 40 kV, 40 mA, slit width: Div. Slit, 0.5°, detector: LynxEye, scanning method: 2θ/θ continuous scanning, measurement range (2θ): from 15° to 90°, step width (2θ): 0.01°, counting time: 1 second/step, rotation of sample stage: 15 rpm.

In the case where the measurement sample is a powder, the sample can be set by, for example, being put in a glass sample holder or being sprinkled on a reflection-free silicon plate to which grease is applied. In the case where the measurement sample is a positive electrode, the positive electrode can be set by being attached to a substrate with a double-sided adhesive tape such that the position of the positive electrode active material layer and the measurement plane required by the apparatus are aligned.

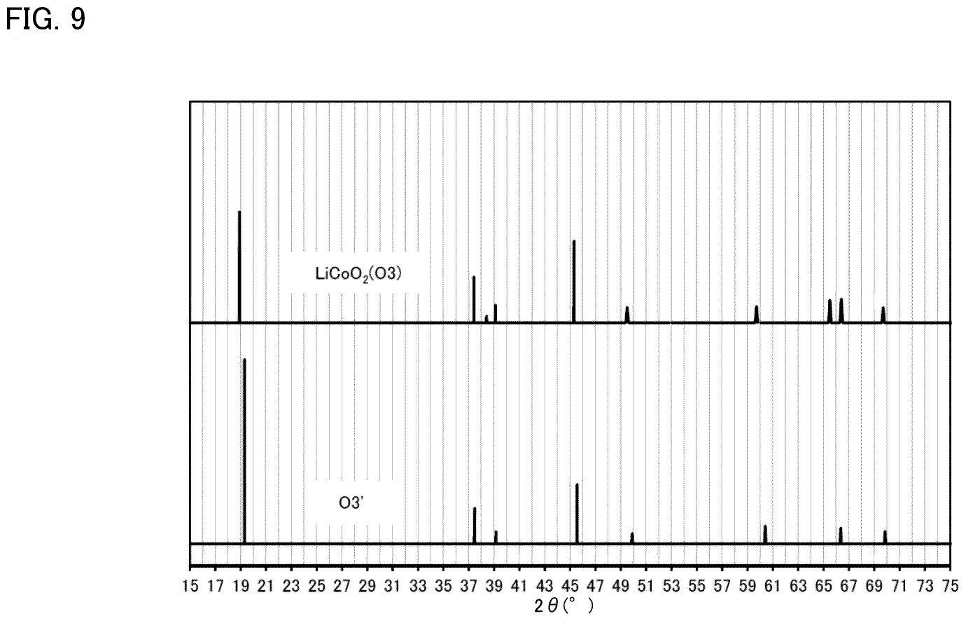

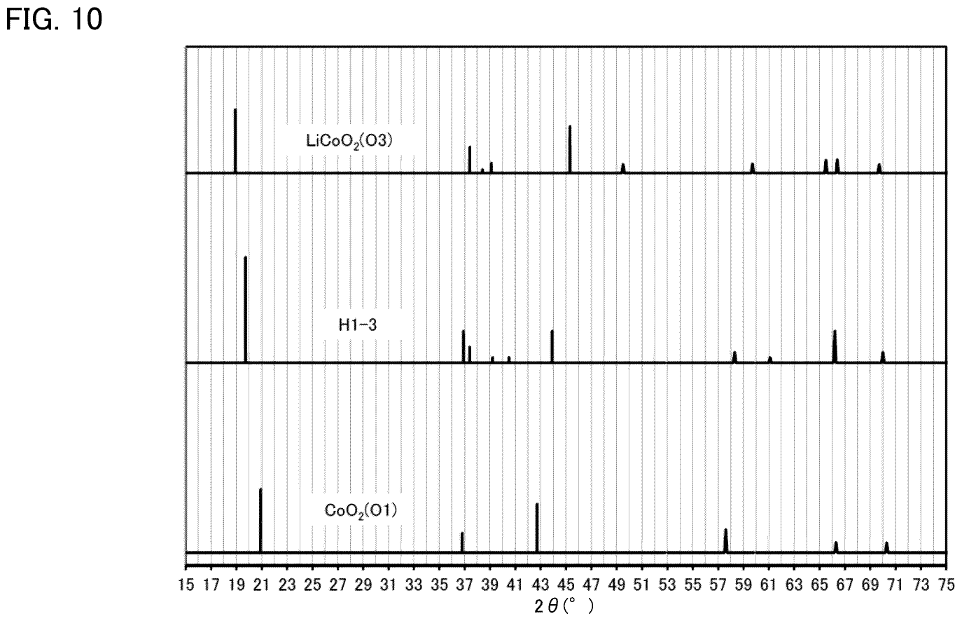

FIG. 9 and FIG. 10 show ideal powder XRD patterns with CuKα₁ radiation that are calculated from models of the O3′ type structure and the H1-3 type structure. For comparison, ideal XRD patterns calculated from the crystal structure of LiCoO₂ (O3) with x in LiₓCoO₂ of 1 and the trigonal O1 type structure with x of 0 are also shown. Note that the patterns of LiCoO₂ (O3) and CoO₂ (O1) are made from crystal structure data obtained from ICSD with Reflex Powder Diffraction, which is a module of Materials Studio (BIOVIA). The 2θ range is from 15° to 75°, the step size is 0.01, the wavelength λ1 is 1.540562×10⁻¹⁰ m, the wavelength λ2 is not set, and a single monochromator is used. XRD patterns of the H1-3 type structure are made from crystal structure data of the H1-3 type structure shown in FIG. 8 in a manner similar to the above-described method. The O3′ type structure was estimated from the XRD pattern of the positive electrode active material of one embodiment of the present invention, the crystal structure was fitted with TOPAS Version 3 (crystal structure analysis software produced by Bruker Corporation), and the XRD pattern of the O3′ type structure was made in a similar manner to other structures.

As shown in FIG. 9, the O3′ type structure exhibits diffraction peaks at 2θ of 19.25±0.12° (greater than or equal to 19.13° and less than or equal to) 19.37° and 2θ of 45.47±0.10° (greater than or equal to 45.37° and less than or equal to 45.57°).

However, as shown in FIG. 10, the H1-3 type structure and the trigonal O1 type structure do not exhibit peaks at these positions. Thus, the diffraction peaks at 2θ of 19.25±0.12° (greater than or equal to 19.13° and less than or equal to) 19.37° and 2θ of 45.47±0.10° (greater than or equal to 45.37° and less than or equal to) 45.57° in a state where x in LiₓCoO₂ is small can be the features of the positive electrode active material 100 of one embodiment of the present invention.

Note that in the case where the O3′ type crystal structure is such that the value of x in LiₓCoO₂ is slightly larger than that in the XRD pattern shown in FIG. 9, observed peaks are shifted in the lower angle side from the above peaks, for example, when charging is performed with a voltage slightly lower than 4.60 V (4.56 V, 4.57 V, 4.58 V, or 4.59 V) as an upper limit of the charge voltage. For example, when the charging is performed with 4.58 V as the upper limit of the charge voltage, the positive electrode active material 100 exhibits diffraction peaks at 2θ of 18.85±0.20° and 2θ of 45.15±0.10° as diffraction peaks derived from the O3′ type crystal structure.

It can be said that, the position of an XRD diffraction peak exhibited by the crystal structure with x of 1 is close to that of an XRD diffraction peak exhibited by the crystal structure with x of 0.24 or less. More specifically, it can be said that in the 20 range of 42° to 46°, a difference in 2θ between the main diffraction peak exhibited by the crystal structure with x of 1 and the main diffraction peak exhibited by the crystal structure with x of 0.24 or less is 0.7° or less, preferably 0.5° or less.

Although the positive electrode active material 100 of one embodiment of the present invention has the O3′ type structure when x in LiₓCoO₂ is small, not all the particles necessarily have the O3′ type structure. Some of the particles may have another crystal structure or be amorphous. Note that when the XRD patterns are subjected to the Rietveld analysis, the O3′ type structure preferably accounts for higher than or equal to 50%, further preferably higher than or equal to 60%, still further preferably higher than or equal to 66% of the positive electrode active material. The positive electrode active material in which the O3′ type structure accounts for higher than or equal to 50%, preferably higher than or equal to 60%, further preferably higher than or equal to 66% enables sufficiently good cycle performance.

Furthermore, even when 5 or more cycles, 30 or more cycles, 50 or more cycles, or 100 or more cycles of charging and discharging have passed after the measurement starts, the O3′ type structure preferably accounts for higher than or equal to 35%, further preferably higher than or equal to 40%, still further preferably higher than or equal to 43%, in the Rietveld analysis.

Sharpness of a diffraction peak in an XRD pattern indicates the degree of crystallinity. Thus, it is preferable that the diffraction peaks after charge be sharp or in other words, have a narrow half width. Even peaks that are derived from the same crystal phase have different half widths depending on the XRD measurement conditions or the 2θ value. In the case of the above-described measurement conditions, the peak observed in the 2θ range greater than or equal to 43° and less than or equal to 46° preferably has a half width less than or equal to 0.2°, further preferably less than or equal to 0.15°, still further preferably less than or equal to 0.12°, for example. Note that not all peaks need to fulfill the requirement. A crystal phase can be regarded as having high crystallinity when one or more peaks derived from the crystal phase fulfill the requirement. Such high crystallinity greatly contributes to stability of the crystal structure after charging.

The crystallite size of the O3′ type structure of the positive electrode active material particle is decreased to approximately one-twentieth that of LiCoO₂ (O3) in a discharged state. Thus, the peak of the O3′ type structure can be clearly observed when x in LiₓCoO₂ is small even under the same XRD measurement conditions as those of a positive electrode before charging and discharging. By contrast, the conventional LiCoO₂ has a small crystallite size and exhibits a broad and small peak although it can partly have a structure similar to the O3′ type structure. The crystallite size can be calculated from the half width of the XRD peak.

### <XPS>

In an inorganic oxide, a region ranging from the surface to a depth of approximately 2 nm to 8 nm (normally, less than or equal to 5 nm) can be analyzed by X-ray photoelectron spectroscopy (XPS) using monochromatic aluminum Kα radiation as an X-ray source; thus, the concentrations of elements in approximately half the depth of the surface portion 100a can be quantitatively analyzed by XPS. The bonding states of the elements can be analyzed by narrow scanning. The quantitative accuracy of XPS is about ±1 atomic % in many cases. The lower detection limit is approximately 1 atomic % but depends on the element.

In the positive electrode active material 100 of one embodiment of the present invention, the concentration of one or more selected from the additive elements is preferably higher in the surface portion 100a than in the inner portion 100b. This means that the concentration of one or more selected from the additive elements in the surface portion 100a is preferably higher than the average concentration of the selected element(s) in the entire positive electrode active material 100. For this reason, for example, it is preferable that the concentration of one or more additive elements selected from the surface portion 100a, which is measured by XPS or the like, be higher than the average concentration of the additive elements in the entire positive electrode active material 100, which is measured by inductively coupled plasma mass spectrometry (ICP-MS), glow discharge mass spectrometry (GD-MS), or the like. For example, the concentration of magnesium of at least part of the surface portion 100a, which is measured by XPS or the like, is preferably higher than the average concentration of magnesium of the entire positive electrode active material 100. The concentration of nickel of at least part of the surface portion 100a is preferably higher than the average concentration of nickel of the entire positive electrode active material 100. The concentration of aluminum of at least part of the surface portion 100a is preferably higher than the average concentration of aluminum of the entire positive electrode active material 100. The concentration of fluorine of at least part of the surface portion 100a is preferably higher than the average concentration of fluorine of the entire positive electrode active material 100.

Note that the surface and the surface portion 100a of the positive electrode active material 100 of one embodiment of the present invention do not contain a carbonate, a hydroxy group, or the like which is chemically adsorbed after formation of the positive electrode active material 100.

Furthermore, an electrolyte solution, a binder, a conductive material, and a compound originating from any of these that are attached to the surface of the positive electrode active material 100 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

The concentration of the additive element may be compared using the ratio of the additive element to cobalt. The use of the ratio of the additive element to cobalt is preferable because it enables comparison while reducing the influence of a carbonate or the like which is chemically adsorbed after formation of the positive electrode active material. For example, the atomic ratio of magnesium to cobalt (Mg/Co) in the XPS analysis is preferably greater than or equal to 0.400 and less than or equal to 1.20, further preferably greater than or equal to 0.500 and less than or equal to 1.00, still further preferably greater than or equal to 0.500 and less than or equal to 0.900, yet still further preferably greater than or equal to 0.500 and less than or equal to 0.700.

For example, the atomic ratio of nickel to cobalt (Ni/Co) in the XPS analysis is preferably greater than or equal to 0.050 and less than or equal to 0.200, further preferably greater than or equal to 0.050 and less than or equal to 0.150, still further preferably greater than or equal to 0.050 and less than or equal to 0.100, yet still further preferably greater than or equal to 0.500 and less than or equal to 0.070.

For example, the atomic ratio of aluminum to cobalt (Al/Co) in the XPS analysis is preferably greater than or equal to 0.010 and less than or equal to 0.100, further preferably greater than or equal to 0.010 and less than or equal to 0.050, still further preferably greater than or equal to 0.010 and less than or equal to 0.040.

For example, the atomic ratio of fluorine to magnesium (F/Mg) in the XPS analysis is preferably greater than or equal to 0.100 and less than or equal to 1.00, further preferably greater than or equal to 0.100 and less than or equal to 0.800, still further preferably greater than or equal to 0.100 and less than or equal to 0.500, yet still further preferably greater than or equal to 0.100 and less than or equal to 0.300, yet still further preferably greater than or equal to 0.100 and less than or equal to 0.200.

When the ratio is within the above range, it can be said that the additive element is not attached to the surface of the positive electrode active material 100 in a narrow range but widely distributed at a preferable concentration in the surface portion 100a of the positive electrode active material 100. That is, when the ratios are within the above ranges in the XPS analysis results of the positive electrode active material 100, the crystal structure is less likely to be broken even when charging that makes x be 0.24 or less and discharging are repeated, so that excellent cycle performance can be achieved. In addition, lithium can be inserted and extracted favorably in/from the positive electrode active material 100, and excellent rate characteristics can be achieved.

In the XPS analysis, monochromatic aluminum Kα radiation can be used as an X-ray, for example. Furthermore, an XPS apparatus enabling energy resolution such that the half width of Ag3d5/2 peak (112 eV) is 1.0 eV±0.1 eV in an XPS spectrum of an Ag sample may be used. An extraction angle can be, for example, 45°. For example, the measurement can be performed using the following XPS apparatus and conditions.
Measurement apparatus: Quantera II by PHI, Inc.
X-ray: monochromatic Al Kα (1486.6 eV)
   Energy resolution: 1.0 eV±0.1 eV as the half width of the Ag3d5/2 peak
   Detection area: 100 μmϕ
   Detection depth: approximately 4 to 5 nm (extraction angle) 45°
   Measurement spectrum: wide scan, narrow scan of each detected element

Furthermore, when the positive electrode active material 100 of one embodiment of the present invention is analyzed by XPS, a peak indicating the binding energy of magnesium with another element (Mg1s peak) is preferably at higher than or equal to 1303.0 eV and lower than 1305.0 eV, further preferably approximately 1304.0 eV. This value is different from the binding energy of magnesium fluoride (1306.0 eV) and is close to that of magnesium oxide.

In the XPS analysis of the positive electrode active material 100 of one embodiment of the present invention, the measured XPS spectrum is preferably corrected such that the C1s peak is aligned with the reference value (284.8 eV), i.e., the whole XPS spectrum is preferably shifted. Thus, the influence of a mechanical difference, a difference in measurement conditions, or the like of the XPS apparatus on XPS measurement can be reduced.

In the XPS analysis of the positive electrode active material 100 of one embodiment of the present invention, the peak component derived from an O—Mg—O bond is preferably contained as a result of analyzing the Mg1s peak to analyze the ratio of peak components derived from the O—Mg—O bond, an O—Mg—F bond, and a F—Mg—F bond. Note that the peak component derived from the O—Mg—F bond may be contained, but the proportion thereof is preferably lower than or equal to 30% of the total of the above three peak components, further preferably lower than or equal to 20% thereof, still further preferably lower than or equal to 10% thereof, yet still further preferably lower than the detection limit thereof. Furthermore, the peak component derived from the F—Mg—F bond may be contained, but the proportion thereof is preferably lower than or equal to 10% of that of the total peak components, further preferably lower than the detection limit thereof.

Thus, in the XPS analysis of the positive electrode active material 100 of one embodiment of the present invention, as a result of analyzing the ratio of the peak components derived from the O—Mg—O bond, the O—Mg—F bond, and the F—Mg—F bond, the proportion of the peak component derived from the O—Mg—O bond is preferably higher than or equal to 70%, further preferably higher than or equal to 80%, still further preferably higher than or equal to 80%, yet still further preferably higher than or equal to 90%, the most preferably 100%.

An analysis method of the Mg1s peak on an XPS spectrum in XPS analysis is described. Assuming that the peak component derived from the O—Mg—O bond is a fit peak 1, that from the O—Mg—F bond is a fit peak 2, and that from the F—Mg—F bond is a fit peak 3 in the analysis of the Mg1s peak, it is preferable to calculate a ratio of these three fit peaks synthesized so that a difference from the Mg1s peak on the XPS spectrum obtained by the XPS analysis is the smallest. The analysis results can be output on the assumption that the area ratio of the fit peak 1, the fit peak 2, and the fit peak 3 in this calculation is the existence ratio of the O—Mg—O bond, the O—Mg—F bond, and the F—Mg—F bond.

Note that in the analysis method of the XPS spectrum, for an energy value (Ep1) at the maximum value (also referred to as a peak top) of the fit peak 1, the energy value at the maximum value of the Mg1s peak separately measured using a standard sample of LiCoO₂ coated with MgO can be referred to. For an energy value (Ep3) at the maximum value of the fit peak 3, the energy value at the maximum value of the Mg1s peak separately measured using a standard sample of magnesium fluoride (MgF₂) (e.g., MGH18XB with purity of 99.9% (3N) up produced by Kojundo Chemical Laboratory Co., Ltd.) can be referred to. An energy value (Ep2) at the maximum value of the fit peak 2 can be an intermediate value between Ep1 and Ep3. Moreover, Ep1 is positioned on the lower energy side than Ep3. Note that the energy value at the maximum peak value is also referred to as a peak position.

In the XPS analysis of the positive electrode active material 100 of one embodiment of the present invention, it can be found from the peak position and the half width of the peak that the analysis results of the Mg1s peak is within the above preferable range. For example, the half width of the Mg1s peak is preferably greater than or equal to 1.0 eV and less than or equal to 3.0 eV, further preferably greater than or equal to 1.0 eV and less than or equal to 2.8 eV, and particularly preferably greater than or equal to 1.0 eV and less than or equal to 2.6 eV. In the above, the peak position of the Mg1s peak is on the lower energy side than the energy value at the maximum value of the Mg1s peak measured separately using the standard sample of magnesium fluoride.

### <EDX>

One or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated by exposing a cross section of the positive electrode active material 100 using a focus ion beam (FIB) or the like and analyzing the cross section using EDX, electron probe microanalysis (EPMA), or the like.

EDX measurement for evaluating an area two-dimensionally while the area is being scanned is referred to as EDX area analysis. EDX measurement for evaluation of the atomic concentration distribution in a positive electrode active material by line scan is referred to as EDX line analysis. Furthermore, extracting data of a linear region from EDX area analysis is referred to as EDX line analysis in some cases. The measurement of a region without scanning is referred to as point analysis.

By EDX area analysis (e.g., element mapping), the concentrations of the additive element in the surface portion 100a, the inner portion 100b, the vicinity of the crystal grain boundary, and the like of the positive electrode active material 100 can be quantitatively analyzed. By EDX line analysis, the concentration distribution and the highest concentration of the additive element can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

Since the positive electrode active material 100 is a compound containing oxygen and a transition metal into and from which lithium can be inserted and extracted, an interface between a region where oxygen and the transition metal M (Co, Ni, Mn, Fe, or the like) that is oxidized or reduced due to insertion and extraction of lithium are present and a region where oxygen and the transition metal M are absent is considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

In STEM-EDX line analysis or the like, it is sometimes difficult to precisely determine the surface because a steep change in the detected amount of the characteristic X-ray of an element is not seen in principle or due to a measurement error. Therefore, when STEM-EDX line analysis or the like in the depth direction is described, the reference point is a point where the detected amount of the characteristic X-ray of the transition metal M is equal to 50% of the sum of the average value M_{AVE} of the detected amounts of the characteristic X-ray of the transition metal M in the inner portion and the average value M_{BG} of the detected amounts of the characteristic X-ray of the transition metal M of the background or a point where the detected amount of the characteristic X-ray of oxygen is equal to 50% of the sum of the average value O_{AVE} of the detected amounts of the characteristic X-ray of oxygen in the inner portion and the average value O_{BG} of the detected amounts of the characteristic X-ray of oxygen of the background. Note that when the position of the point where the detected amount of the characteristic X-ray of the transition metal M is equal to 50% of the sum of the average value of the detected amounts of the characteristic X-ray of the transition metal M in the inner portion and the average value of the detected amounts of the characteristic X-ray of the transition metal M of the background is different from the position of the point where the detected amount of the characteristic X-ray of oxygen is equal to 50% of the sum of the average value of the detected amounts of the characteristic X-ray of oxygen in the inner portion and the average value of the detected amounts of the characteristic X-ray of oxygen of the background, the difference is probably due to the influence of a carbonate, a metal oxide containing oxygen, or the like, which is attached to the surface. Thus, in such a case, the point where the detected amount of the characteristic X-ray of the transition metal M is equal to 50% of the sum of the average value M_{AVE} of the detected amounts of the characteristic X-ray of the transition metal M in the inner portion and the average value M_{BG} of the detected amounts of the characteristic X-ray of the transition metal M of the background can be employed as the reference point. In the case of a positive electrode active material containing a plurality of the transition metals M, the reference point can be determined using M_{AVE} and M_{BG} of the transition metal element whose detected amount of the characteristic X-ray in the inner portion is larger than that of any other element.

The average value M_{BG} of the detected amounts of the characteristic X-ray of the transition metal M of the background can be calculated by averaging the detected amounts in the range outside a portion of a positive electrode active material in the vicinity of the portion at which the detected amount of the characteristic X-ray of the transition metal M begins to increase, for example. Note that the detected range is greater than or equal to 2 nm, preferably greater than or equal to 3 nm. The average value M_{AVE} of the detected amounts of the characteristic X-ray of the transition metal M in the inner portion can be calculated by averaging the detected amounts in the range greater than or equal to 2 nm, preferably greater than or equal to 3 nm at the depth at which the detected amounts of the characteristic X-ray of the transition metal M and oxygen are saturated and stabilized, e.g., at a depth larger than, by greater than or equal to 30 nm, preferably greater than 50 nm, the depth at which the detected amount of the characteristic X-ray of the transition metal M begins to increase. The average value O_{BG} of the detected amounts of the characteristic X-ray of oxygen of the background and the average value O_{AVE} of the detected amounts of the characteristic X-ray of oxygen in the inner portion can be calculated in a similar manner.

The surface of the positive electrode active material 100 in, for example, a cross-sectional STEM image is a boundary between a region where an image derived from the crystal structure of the positive electrode active material is observed and a region where the image is not observed. The surface of the positive electrode active material 100 is also determined as the outermost surface of a region where an atomic column derived from an atomic nucleus of, among metal elements which constitute the positive electrode active material, a metal element that has a larger atomic number than lithium is observed in the cross-sectional STEM image.

A peak in STEM-EDX line analysis refers to the local maximum value of a projecting shape appearing in the graph of the characteristic X-ray intensity of each element or the maximum value of the characteristic X-ray of each element. As a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by performing scanning two times can be used as the detected value of each element. The number of scanning is not limited to two and an average of integrated values obtained by performing scanning three or more times can be used as the detected value of each element.

STEM-EDX line analysis can be performed as follows, for example. First, a protective film is deposited by evaporation over the surface of a positive electrode active material. For example, carbon can be deposited by evaporation with an ion sputtering apparatus (MC1000, produced by Hitachi High-Tech Corporation).

Next, the positive electrode active material is thinned to fabricate a cross-section sample to be subjected to STEM analysis. For example, the positive electrode active material can be thinned with an FIB-SEM apparatus (XVision 200TBS, produced by Hitachi High-Tech Corporation). Here, picking up can be performed by a micro probing system (MPS), and the acceleration voltage at final processing can be, for example, 10 kV.

The STEM-EDX line analysis can be performed using, for example, a STEM apparatus (HD-2700, Hitachi High-Tech Corporation) and Octane T Ultra W (EDAX Inc) as an EDX detector. As one example of conditions for the EDX line analysis using HD-2700 by Hitachi High-Tech Corporation, the emission current of the STEM apparatus is set to be within the range of 6 μA to 10 μA, and a portion of the thinned sample, which is not positioned at a deep level and has little unevenness, is measured. The magnification is approximately 150,000 times, for example. The EDX line analysis can be performed under conditions where drift correction is performed, the line width is 42 nm, the pitch is 0.2 nm, and the number of frames is 6 or more.

To increase the spatial resolution in STEM-EDX line analysis, the beam diameter of an electron beam (also referred to as a beam diameter or a probe diameter) is preferably small. The beam diameter in STEM-EDX line analysis is preferably less than or equal to 0.3 nm, further preferably less than or equal to 0.2 nm, still further preferably less than or equal to 0.1 nm. To increase the analysis sensitivity in STEM-EDX line analysis, a beam current of an electron beam (also referred to as a probe current) is preferably increased. That is, the apparatus used for STEM-EDX line analysis preferably includes a spherical aberration corrector (Cs collector) that can make a beam diameter small and increase a beam current.

When the positive electrode active material 100 contains magnesium and fluorine as the additive elements, the distribution of fluorine preferably includes a region that overlaps with the distribution of magnesium. For example, a difference in the depth direction between a peak of the concentration or detected amount of fluorine and a peak of the concentration or detected amount of magnesium is preferably within 10 nm, further preferably within 3 nm, still further preferably within 1 nm, yet still further preferably within 0.5 nm.

In the positive electrode active material 100 containing nickel as the additive element, a peak of the concentration or detected amount of nickel in the surface portion 100a is preferably observed in a region ranging from the surface of the positive electrode active material 100 or a reference point to a depth of 3 nm, further preferably in a region extending to a depth of 1 nm. When the positive electrode active material 100 contains magnesium and nickel, the distribution of nickel preferably includes a region that overlaps with the distribution of magnesium. For example, a difference in the depth direction between a peak of the concentration or detected amount of nickel and a peak of the concentration or detected amount of magnesium is preferably within 3 nm, further preferably within 1 nm.

In the case where the positive electrode active material 100 contains aluminum as the additive element, in the EDX line analysis, the peak of the concentration or detected amount of magnesium, nickel, or fluorine is preferably located closer to the surface than the peak of the concentration or detected amount of aluminum in the surface portion 100a. In other words, the peak of the concentration or detected amount of aluminum in the surface portion 100a is preferably located more inwardly than the peak of the concentration or detected amount of magnesium, nickel, or fluorine. For example, the peak of the concentration or detected amount of aluminum is preferably observed in a region ranging from the surface of the positive electrode active material 100 or a reference point to a depth of from 0.5 nm to 50 nm, both inclusive, further preferably a depth of from 5 nm and to 50 nm, both inclusive, toward the center of the positive electrode active material 100.

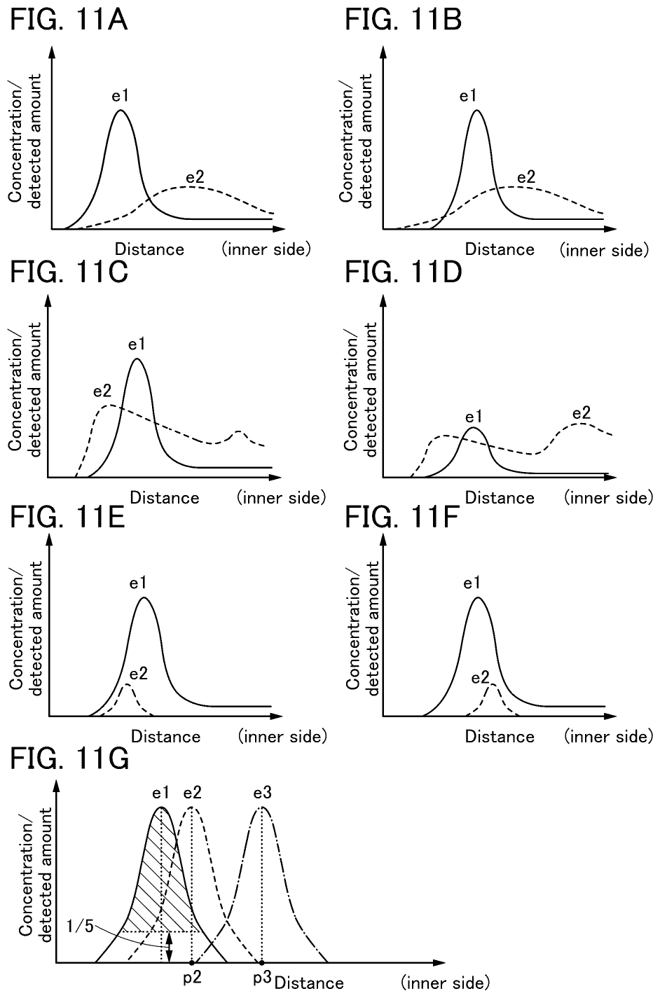

Here, how to express the positional relation of distributed elements subjected to EDX line analysis is described with reference to FIGS. 11A to 11G. FIGS. 11A to 11F are schematic diagrams showing the distribution of concentrations or detected amounts of a first element e1 and a second element e2. FIG. 11G is a schematic diagram showing the distribution of concentrations or detected amounts of the first element e1, the second element e2, and a third element e3.

For example, in the case where the distribution of concentrations or detected amounts of the first element e1 and the second element e2 has a shape as shown in FIG. 11A, it is expressed that the position where the concentration or detected amount of the second element e2 is the maximum is located more inwardly than the position where the concentration or detected amount of the first element e1 is the maximum. For example, in the case where the distribution of concentrations or detected amounts of the first element e1 and the second element e2 has a shape as shown in FIG. 11B, it is expressed that the position where the concentration or detected amount of the second element e2 is the maximum is located more inwardly than the position where the concentration or detected amount of the first element e1 is the maximum. For example, in the case where the distribution of the concentrations or detected amounts of the first element e1 and the second element e2 has a shape as shown in FIG. 11C, it is expressed that the position where the concentration or detected amount of the first element e1 is the maximum is located more inwardly than the position where the concentration or detected amount of the second element e2 is the maximum. For example, in the case where the distribution of the concentrations or detected amounts of the first element e1 and the second element e2 has a shape as shown in FIG. 11D, it is expressed that the position where the concentration or detected amount of the second element e2 is the maximum is located more inwardly than the position where the concentration or detected amount of the first element e1 is the maximum. For example, in the case where the distribution of the concentrations or detected amounts of the first element e1 and the second element e2 has a shape as shown in FIG. 11E, it is expressed that the position where the concentration or detected amount of the first element e1 is the maximum is located more inwardly than the position where the concentration or detected amount of the second element e2 is the maximum. For example, in the case where the distribution of the concentrations or detected amounts of the first element e1 and the second element e2 has a shape as shown in FIG. 11F, it is expressed that the position where the concentration or detected amount of the second element e2 is the maximum is located more inwardly than the position where the concentration or detected amount of the first element e1 is the maximum.

The expression “the distribution of one element has a region overlapping with the distribution of another element” is described with the case where the distribution of the concentrations or detected amounts of the first element e1, the second element e2, and the third element e3 has a positional relation as shown in FIG. 11G as an example. In this specification and the like, the expression “distribution of two elements has an overlapping region” means that a position at the maximum value in the distribution of the concentration or detected amount of at least one element is located in the range where the concentration or detected amount of the other element is higher than or equal to ⅕ of the maximum value in the distribution of the concentration or detected amount of the other element, for example. Note that in the case where the background detection intensity in the EDX line analysis is higher than or equal to “⅕ of the maximum value”, “⅕ of the maximum value” in the above sentence indicates “the background detection intensity (also referred to as lower detection limit).

For example, in the case of the positional relation as shown in FIG. 11G, the position at the maximum value in the distribution of the concentration or detected amount of the second element e2 (the position is denoted as p2) is located within a range (a hatched region in the diagram) higher than or equal to ⅕ of the maximum value (or the lower detection limit) in the distribution of the concentration or detected amount of the first element e1. Thus, such an expression that the distribution of the first element e1 and the distribution of the second element e2 have an overlapping region is used. The position at the maximum value in the distribution of the concentration or detected amount of the third element e3 (the position is denoted as p3) is not located within a range (a hatched region in the diagram) where the concentration or detected amount of the first element e1 is higher than or equal to ⅕ of the maximum value (or the lower detection limit) in the distribution of the concentration or detected amount of the first element e1. Thus, the expression such that the distribution of the first element e1 and the distribution of the third element e3 have an overlapping region is not made.

In the case of the positional relation as shown in FIG. 11G, it can be said that the distribution of the second element e2 and the distribution of the third element e3 are located more inwardly than the distribution of the first element e1. Alternatively, it can be said that the distribution of the second element e2 and the distribution of the third element e3 are present more unevenly on the inner side than the distribution of the first element e1.

### <Powder Resistivity Measurement>

The positive electrode active material 100 of one embodiment of the present invention has a stable crystal structure even at a high voltage. The stable crystal structure of the positive electrode active material in a charged state can inhibit a decrease in charge/discharge capacities due to repeated charging and discharging. In the <XRD> section, the positive electrode active material 100 having an excellent characteristics as described above has a feature of having the O3′ type structure and/or the monoclinic O1(15) type structure when x in LiₓCoO₂ is small. In the <EDX> section, the preferable existence distribution of the additive element A (e.g., Mg, Al, and Ni) when the positive electrode active material 100 is subjected to the STEM-EDX analysis is described. In the <XPS> section, the preferable existence ratio of the additive element A (e.g., Mg, Al, and Ni) when the positive electrode active material 100 is subjected to the XPS analysis is described. Furthermore, the positive electrode active material 100 of one embodiment of the present invention also has a feature in the volume resistivity of powder.

As the feature of the positive electrode active material 100 of one embodiment of the present invention, the volume resistivity of the powder of the positive electrode active material 100 is preferably higher than or equal to 1.0×10⁸ Ω·cm and lower than or equal to 1.0×10¹⁰ Ω·cm under a pressure of 64 MPa. The positive electrode active material 100 with the above volume resistivity has a stable crystal structure at a high voltage, and can indicate the favorable formation of a surface portion 100a, which is an important factor for a stable crystal structure of a positive electrode active material in a charged state.

Furthermore, the volume resistivity of the powder of the positive electrode active material 100 is further preferably higher than or equal to 1.0×10⁸ Ω·cm and lower than or equal to 1.0×10⁹ Ω·cm, still further preferably higher than or equal to 1.0×10⁸ Ω·cm and lower than or equal to 5.0×10⁸ Ω·cm under a pressure of 64 MPa. The positive electrode active material 100 with the above volume resistivity has a stable crystal structure at a high voltage, can indicate the favorable formation of the surface portion 100a, which is an important factor for a stable crystal structure of a positive electrode active material in a charged state, and also can indicate that lithium can be inserted and extracted favorably into/from the positive electrode active material.

A method for measuring the volume resistivity of the powder of the positive electrode active material 100 of one embodiment of the present invention is described.

A measurement instrument for the volume resistivity of the powder preferably includes a device portion including terminals for measuring resistance and a mechanism for applying pressure to powder serving as a measurement target. The terminals for measuring resistance are preferably four terminals (also referred to as four probes). As such a measurement instrument that includes the terminals for resistance measurement and the mechanism for applying pressure to the powder as a measurement target (sample), for example, MCP-PD600 (by Nittoseiko Analytech Co., Ltd.) can be used. As the device portion for a four-probe method, Loresta-GXII or Hiresta-UX can be used. The Loresta-GXII can be used for measurement of a low-resistant sample, and the Hiresta-UX can be used for measurement of a high-resistant sample. Note that the measurement environment is preferably a stable environment such as a dry room. An example of a preferable environment of the dry room is that the temperature is 25° C. and the dew point is lower than or equal to −40° C.

The measurement of the volume resistivity of the powder using the above-described measurement instrument is described. First, a powder sample is set in the measurement unit. The measurement unit has a structure in which the powder sample and the terminals for measuring resistance are in contact with each other, and pressure can be applied to the powder sample. A structure for measuring the volume of a powder sample set in the measurement unit is also included. Specifically, the measurement unit includes a cylindrical space, and the powder sample is set in the space. In the structure for measuring the volume of the powder sample, the volume occupied by the powder set in the space can be measured by measuring the height of the powder.

In the measurement of the volume resistivity of powder, the electric resistance and volume of the powder under pressure are measured. The pressure applied to the powder can be varied. For example, the electric resistance and volume of the powder can be measured under pressures of 13 MPa, 25 MPa, 38 MPa, 51 MPa, and 64 MPa. The volume resistivity of the powder can be calculated from the measured electric resistance and volume of the powder.

In the case where the above-described measurement is performed and the volume resistivity of the powder of the positive electrode active material 100 of one embodiment of the present invention is higher than or equal to 1.0×10⁸ Ω·cm and lower than or equal to 1.0×10¹⁰ Ω·cm under the pressure of 64 MPa, good cycle performance is obtained in a charge and discharge cycle test under the high charge voltage condition. In addition, in the case where the volume resistivity is higher than or equal to 1.0×10⁸ Ω·cm and lower than or equal to 1.0×10⁹ Ω·cm, better cycle performance is obtained in a charge and discharge cycle test under the high charge voltage condition, and better discharge characteristics are exhibited in a discharge rate test. Moreover, in the case where the volume resistivity is higher than or equal to 1.0×10⁸ Ω·cm and lower than or equal to 5.0×10⁹ Ω·cm, even better discharge characteristics are exhibited in the discharge rate test.

### <EPMA>

The concentration of the additive element contained in the positive electrode active material 100 can be analyzed using EPMA as well as using EDX. As analysis methods of elements slight amounts of which exist in a sample, EPMA enables higher detection capability (i.e., lowering the bar of the lower detection limit) than EDX. Thus, EPMA is preferably used when a region including a slight amount of the additive element is analyzed.

In the EPMA analysis, a cross section of the positive electrode active material 100 is exposed by mechanical polishing, ion polishing, FIB, or the like, and its cross section is analyzed. As an apparatus for the EPMA, an electron probe microanalyzer, JXA-iHP200F (by JEOL Ltd.), can be used, for example.

Using a wavelength-dispersive detector, EPMA has higher capability of detecting a slight quantity of elements than EDX using an energy-dispersive detector. In contrast, the spatial resolution in the EPMA analysis is inferior to that in EDX (in particular, STEM-EDX). Therefore, STEM-EDX is suitable for analysis focusing on the detailed distribution of the additive elements in the surface portion 100a of the positive electrode active material 100, and EPMA is suitable for analysis of a slight amount of the additive elements in the inner portion 100b. Note that since EPMA and EDX have a difference in analyzing ways, the values of the concentrations obtained by the respective methods even when the region analyzed is the same in the both methods are not the same in some cases.

### <Nanobeam Electron Diffraction Pattern>

As in Raman spectroscopy, features of both a layered rock-salt crystal structure and a rock-salt crystal structure are preferably observed in a nanobeam electron diffraction pattern. Note that in consideration of the above-described difference in sensitivity, in a STEM image and a nanobeam electron diffraction pattern, it is preferable that the features of a rock-salt crystal structure not be too significant at the surface portion 100a, in particular, the outermost surface (e.g., a region extending to a depth of 1 nm from the surface). This is because a diffusion path of lithium can be ensured and a function of stabilizing a crystal structure can be enhanced in the case where the additive element such as magnesium is present in the lithium layer while the outermost surface has a layered rock-salt crystal structure as compared with the case where the outermost surface is covered with a rock-salt crystal structure.

Therefore, for example, when a nanobeam electron diffraction pattern of a region that extends from the surface to a depth less than or equal to 1 nm and a nanobeam electron diffraction pattern of a region that extends from a depth of 3 nm to a depth of 10 nm are obtained, a difference between lattice constants calculated from the patterns is preferably small.

For example, a difference between lattice constants calculated from a measured portion that is at a depth less than or equal to 1 nm from the surface and a measured portion that is at a depth greater than or equal to 3 nm and less than or equal to 10 nm from the surface is preferably less than or equal to 0.1×10⁻¹⁰ m for a-axis and less than or equal to 1.0×10⁻¹⁰ m for c-axis. It is further preferably less than or equal to 0.03×10⁻¹⁰ m for the a-axis and less than or equal to 0.6×10⁻¹⁰ m for the c-axis. It is still further preferably less than or equal to 0.04×10⁻¹⁰ m for the a-axis and less than or equal to 0.3×10⁻¹⁰ m for the c-axis.

### <Second Positive Electrode Active Material>

In addition to the positive electrode active material 100, the positive electrode of one embodiment of the present invention can include the second positive electrode active material different from the positive electrode active material 100. Like the positive electrode active material 100, the second positive electrode active material 200 has functions of taking and releasing lithium ions in accordance with charge and discharge. As the second positive electrode active material 200 used as one embodiment of the present invention, can be used a material that less deteriorates due to charge and/or discharge (hereinafter, also called “charge and discharge”) even at high charge voltage, which is similar to the positive electrode active material 100 other than a particle diameter. Specifically, a material that can be used is a positive electrode active material (composite oxide) with a particle diameter (median diameter (D50)) greater than or equal to 0.1 μm and less than 9 μm, preferably greater than or equal to 1 μm and less than or equal to 5 μm, which is obtained by reducing the particle diameter of the starting material and performing heat treatment at lower temperature or heat treatment for a shorter time compared to the particle diameter and the heat treatment in the formation method of the positive electrode active material described in Embodiment 1. Like the positive electrode active material 100 described above, the second positive electrode active material 200 preferably contains one or more of the additive element X, the additive element Y, and the additive element Z.

The contents in this embodiment can be freely combined with the contents in any of the other embodiments.

### Embodiment 3

In this embodiment, components included in a battery will be described.

### [Positive Electrode]

A positive electrode includes a positive electrode active material layer and a positive electrode current collector. The positive electrode active material layer contains a positive electrode active material and may further contain at least one of a conductive material and a binder. As the positive electrode active material, the positive electrode active material 100 described in Embodiment 1 and Embodiment 2 can be used.

For example, metal foil can be used for the positive electrode current collector. The positive electrode can be formed by applying slurry onto the metal foil and drying the slurry. Note that pressing may be performed after drying. The positive electrode is a component obtained by forming an active material layer over the positive electrode current collector 21.

Slurry refers to a material solution that is used to form an active material layer over the positive electrode current collector and contains an active material, a binder, and a solvent, preferably also contains a conductive material mixed therein. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

A positive electrode active material has functions of taking and releasing lithium ions in accordance with charge and discharge. For the positive electrode active material 100 described above and used as one embodiment of the present invention, a material with less deterioration due to charge at high charge voltage and discharge even can be used.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymer, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. An example of a water-soluble polymer having a significant viscosity modifying effect is the above-mentioned polysaccharide; for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification and the like, cellulose and a cellulose derivative used as a binder of an electrode include salts thereof.

A water-soluble polymer can stabilize the viscosity by being dissolved in water and can allow stable dispersion of the active material and another material combined as the binder, e.g., styrene-butadiene rubber, in an aqueous solution. Furthermore, a water-soluble polymer is expected to be easily and stably adsorbed on an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferable that the passivation film can conduct lithium ions while suppressing electrical conduction.

### <Conductive Material>

A conductive material is also referred to as a conductivity-imparting agent or a conductive additive, and a carbon material is used as the conductive material. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following: a case where covalent bonding occurs, a case where bonding with the Van der Waals force occurs, a case where a conductive material covers part of the surface of an active material, a case where a conductive material is embedded in surface roughness of an active material, and a case where an active material and a conductive material are electrically connected to each other without being in contact with each other.

An active material layer such as a positive electrode active material layer or a negative electrode active material layer preferably includes a conductive material.

As the conductive material, for example, one or more of carbon black such as acetylene black or furnace black, graphite such as artificial graphite or natural graphite, carbon fibers such as a carbon nanofiber and a carbon nanotube, and a graphene compound can be used.

Examples of the carbon fiber include a mesophase pitch-based carbon fiber and an isotropic pitch-based carbon fiber. As the carbon fiber, a carbon nanofiber, a carbon nanotube, or the like can be used. Carbon nanotube can be formed by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

The content of the conductive material to the total amount of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of a battery can be increased.

A compound containing particulate carbon such as carbon black or graphite or a compound containing fibrous carbon such as a carbon nanotube easily enters a microscopic space. A microscopic space refers to, for example, a region between a plurality of active materials. When a carbon-containing compound that easily enters a microscopic space and a compound containing sheet-like carbon, such as graphene, that can impart conductivity to a plurality of particles are used in combination, the density of the electrode increases and an excellent conductive path can be formed. The battery obtained by the fabrication method of one embodiment of the present invention can have high capacitive density and stability, and is effective as an in-vehicle battery.

### <Positive Electrode Current Collector>

For the current collector, a material that has high conductivity, such as a metal like stainless steel, gold, platinum, aluminum, or titanium, or an alloy thereof, can be used. It is preferable that a material used for the positive electrode current collector not be dissolved at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer contains a negative electrode active material, and may also contain a conductive material and a binder.

### <Negative Electrode Active Material>

As the negative electrode active material, for example, an alloy-based material or a carbon material can be used.

As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. Thus, it is preferable to use silicon for a negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases.

In this specification and the like, “SiO” refers, for example, to silicon monoxide. SiO can alternatively be expressed as SiOₓ. Here, it is preferable that x be 1 or have an approximate value of 1. For example, x is preferably greater than or equal to 0.2 and less than or equal to 1.5, further preferably greater than or equal to 0.3 and less than or equal to 1.2.

As the carbon material, graphite, graphitizing carbon (soft carbon), non-graphitizing carbon (hard carbon), carbon fiber (carbon nanotube), graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into the graphite (while a lithium-graphite intercalation compound is generated). For this reason, a lithium-ion battery using graphite can have a high operating voltage. In addition, graphite is preferred because of its advantages such as a relatively high capacity per unit volume, relatively small volume expansion, low cost, and a higher level of safety than that of lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Still alternatively, as the negative electrode active material, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of its high discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for the positive electrode active material which does not contain lithium ions, such as V₂O₅ or Cr₃O₈. Note that in the case of using a material containing lithium ions as the positive electrode active material, the nitride containing lithium and a transition metal can be used as the negative electrode active material by extracting the lithium ions contained in the positive electrode active material in advance.

A material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

As another mode of the negative electrode, a negative electrode that does not contain a negative electrode active material after completion of the fabrication of the battery may be used. As the negative electrode that does not contain a negative electrode active material, for example, a negative electrode can be used in which only a negative electrode current collector is included after completion of the fabrication of the battery and in which lithium ions extracted from the positive electrode active material due to charge of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

When the negative electrode that does not contain a negative electrode active material is used, a film may be included over a negative electrode current collector for making lithium deposition uniform. For the film for making lithium deposition uniform, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over a negative electrode current collector relatively easily, and thus is preferable as the film for making lithium deposition uniform. Moreover, as the film for making lithium deposition uniform, for example, a metal film that forms an alloy with lithium can be used. As the metal film that forms an alloy with lithium, for example, a magnesium metal film can be used. It is suitable for the film for making lithium deposition uniform because lithium and magnesium form a solid solution in a wide range of compositions.

When the negative electrode that does not contain a negative electrode active material is used, a negative electrode current collector having unevenness can be used. When the negative electrode current collector having unevenness is used, a depression of the negative electrode current collector becomes a cavity in which lithium contained in the negative electrode current collector is easily deposited, so that the lithium can be prevented from having a dendrite-like shape when being deposited.

For the conductive material and the binder that can be included in the negative electrode active material layer, materials similar to those of the conductive material and the binder that can be included in the positive electrode active material layer can be used.

### <Negative Electrode Current Collector>

For the negative electrode current collector, copper or the like can be used in addition to a material similar to that of the positive electrode current collector. Note that a material that does not alloy with carrier ions of lithium or the like is preferably used for the negative electrode current collector.

### [Electrolyte]

The secondary battery includes an electrolyte containing carrier ions. The electrolyte in this specification and the like is not limited to an electrolyte containing an organic solvent that is liquid at room temperature but includes a solid electrolyte and an electrolyte (a semisolid electrolyte) containing both an organic solvent that is liquid at room temperature and a solid electrolyte that is a solid at room temperature. Note that an electrolyte obtained by dissolving lithium salt in an organic solvent that is liquid at room temperature is sometimes referred to as an electrolyte solution.

### <Organic Solvent in a Liquid Form at Room Temperature>

Examples of the organic solvent in a liquid form at room temperature are described below.

As an organic solvent in a liquid form at room temperature, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate (EP), propyl propionate (PP), methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used.

Alternatively, the use of one or more ionic liquids (room temperature molten salts) that are unlikely to burn and volatize as the organic solvent in a liquid form at room temperature can prevent the battery cell from exploding and/or igniting even when the battery cell internally shorts out or the internal temperature increases owing to overcharging or the like. An ionic liquid contains a cation and an anion, specifically, an organic cation and an anion. Examples of the organic cation used for the organic solvent include aliphatic onium cations such as a quaternary ammonium cation, a tertiary sulfonium cation, and a quaternary phosphonium cation, and aromatic cations such as an imidazolium cation and a pyridinium cation. Examples of the anion used for the organic solvent include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the lithium salt dissolved in the organic solvent, for example, one or more of LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LIN (CF₃SO₂)₂, LiN(C₄F₉SO₂) (CF₃SO₂), LiN(C₂F₅SO₂)₂, and the like can be used.

### <Additive Agent>

The above-described organic solvent may contain an additive agent. An additive agent can inhibit a decomposition reaction of an electrolyte which might occur on a positive electrode surface or a negative electrode surface when a secondary battery operates at a high voltage and/or high temperatures. As the additive agent, for example, vinylene carbonate (VC), propane sultone (PS), tert-butylbenzene (TBB), fluoroethylene carbonate (FEC), or lithium bis(oxalate) borate (LiBOB) is preferably used. LiBOB is particularly preferable because it facilitates formation of a favorable coating film. VC or FEC is preferable because it forms a favorable coating film on a negative electrode at the time of aging the secondary battery or charging the secondary battery at the initial use, which improves the cycle performance.

The additive agent may contain a compound represented by General Formula (G1) shown below. The compound of General Formula (G1) include two cyano groups and can be referred to as a dinitrile compound.

[Chemical Formula 1]

CN—R—CN (G1)

In General Formula (G1) above, R represents a hydrocarbon having 1 to 5 carbon atoms. In General Formula (G1) above, R preferably represents a hydrocarbon having 2 to 4 carbon atoms.

Specific examples of General Formula (G1) include succinonitrile, glutaronitrile, adiponitrile (ADN), and ethylene glycol bis(propionitrile) ether (EGBE).

Structural Formula (H1) of succinonitrile is shown below.

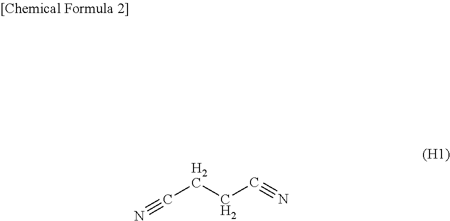

Structural Formula (H2) of glutaronitrile is shown below.

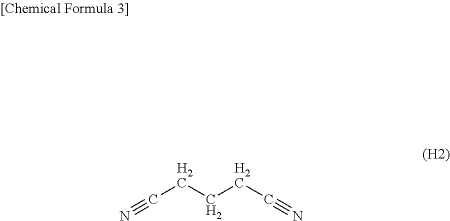

Structural Formula (H3) of adiponitrile is shown below.

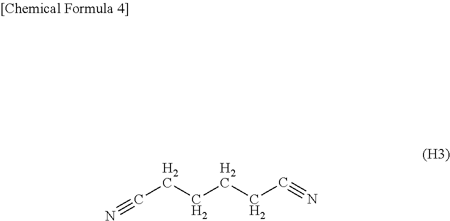

Structural Formula (H4) of ethylene glycol bis(propionitrile) ether is shown below.

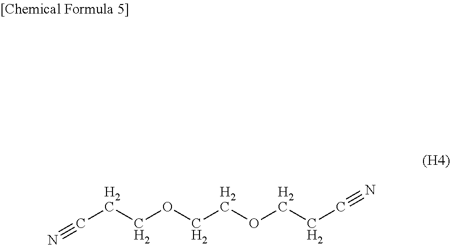 [SMILES: N#CCCOCCOCCC#N]

As the additive agent, one or more, or two or more kinds of dinitrile compounds can be used.

Furthermore, fluorobenzene may be added to the above organic solvent. The concentration of such an additive agent in the whole electrolyte solution can be, for example, higher than or equal to 0.1 wt % and lower than or equal to 5 wt %. PS or EGBE is preferable because it forms a favorable coating film on a positive electrode at the time of charging and discharging, which improves the cycle performance. FB is preferable because it improves the wettability of the organic solvent with respect to the positive electrode and the negative electrode. The dinitrile compound is preferable because its nitrile groups are oriented in normal lines of the surface of the positive electrode active material and the surface of the negative electrode active material and oxidative decomposition of the organic solvent is hindered, whereby resistance against a high voltage can be increased. Furthermore, the dinitrile compound is preferable because it can inhibit dissolution of copper used in the current collector of the negative electrode at the time of overdischarging. Considering the usage of the secondary battery at a high voltage, a dinitrile compound is preferably added.

The additive agent does not have to be liquid at room temperature. A semi-solid-state material that is called a polymer gel electrolyte may be used for an organic solvent. When a polymer gel electrolyte is used, safety against liquid leakage and the like is improved. Further, a battery cell can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-hexafluoropropylene (HFP), which is a copolymer of PVDF an HFP d, can be used. The formed polymer may be porous.

### [Separator]

When the electrolyte includes an electrolyte solution, the separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to wrap one of the positive electrode and the negative electrode.

The separator may have a multilayer structure. For example, an organic material film of polypropylene, polyethylene, or the like can be coated with a ceramic-based material, a hydroxide-based material, a fluorine-based material, a polyamide-based material, a mixture thereof, or the like. Examples of the ceramic-based material include aluminum oxide particles, silicon oxide particles, and magnesium oxide. Examples of the hydroxide-based material include magnesium hydroxide and aluminum hydroxide. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator in high-voltage charging can be suppressed and thus the reliability of the secondary battery can be improved. When the separator is coated with the fluorine-based material, the separator is easily brought into close contact with the electrode, resulting in high output characteristics. When the separator is coated with the polyamide-based material, in particular, aramid, heat resistance is improved; thus, the safety of the secondary battery is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With use of a separator having a multilayer structure, the capacity per volume of the secondary battery can be increased because the safety of the secondary battery can be maintained even when the total thickness of the separator is small.

### [Exterior Body]

For an exterior body included in the battery, a resin material or a metal material such as aluminum, stainless steel, or titanium can be used, for example. A film-like exterior body can also be used. As the film, for example, it is possible to use a film having a three-layer structure in which a highly flexible metal thin film or metal foil of aluminum, stainless steel, titanium, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. Such a film with a multilayer structure can be referred to as a laminated film. At this time, the laminated film is sometimes referred to as an aluminum laminated film, a stainless steel laminated film, a titanium laminated film, a copper laminated film, a nickel laminated film, or the like using the material name of the metal layer included in the laminated film.

The material or thickness of the metal layer included in the laminated film sometimes affects the flexibility of a battery. As an exterior body used for a battery in which flexible or lightweight is required, for example, an aluminum laminated film including a polypropylene layer, an aluminum layer, and an nylon layer is preferably used. Here, the thickness of the aluminum layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the aluminum layer is smaller than 10 μm, a gas barrier property might be lowered by pinholes of the aluminum layer; thus, the thickness of the aluminum layer is desirably larger than or equal to 10 μm.

For an exterior body used for a battery emphasizing physical intensity and safety, it is preferable to use a stainless steel laminated film including a polypropylene layer, a stainless steel layer, and a nylon layer. Furthermore, a polyethylene terephthalate layer may be provided over the nylon layer. Here, the thickness of the stainless steel layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the stainless steel layer is smaller than 10 μm, a gas barrier property might be lowered by pinholes of the stainless steel layer; thus, the thickness of the stainless steel layer is desirably larger than or equal to 10 μm. Note that stainless steel in this specification refers to steel containing chromium at approximately 12% or more (i.e., an alloy of iron and carbon), and can be roughly classified into martensitic stainless steel, ferritic stainless steel, or austenite stainless steel according to the composition. Moreover, stainless steel to which one or more kinds of elements selected from Ti, Nb, Mo, Cu, Ni, and Si are added is also included.

Alternatively, for example, it is preferable to use a titanium laminated film including a polypropylene layer, a titanium layer, and a nylon layer. Furthermore, a polyethylene terephthalate layer may be provided over the nylon layer. Here, the thickness of the titanium layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the titanium layer is smaller than 10 μm, a gas barrier property might be lowered by pinholes of the titanium layer; thus, the thickness of the titanium layer is desirably larger than or equal to 10 μm.

The contents in this embodiment can be freely combined with the contents in any of the other embodiments.

### Embodiment 4

This embodiment describes examples of shapes of a secondary battery including a positive electrode formed by the formation method described in the foregoing embodiments.

### [Coin-Type Secondary Battery]

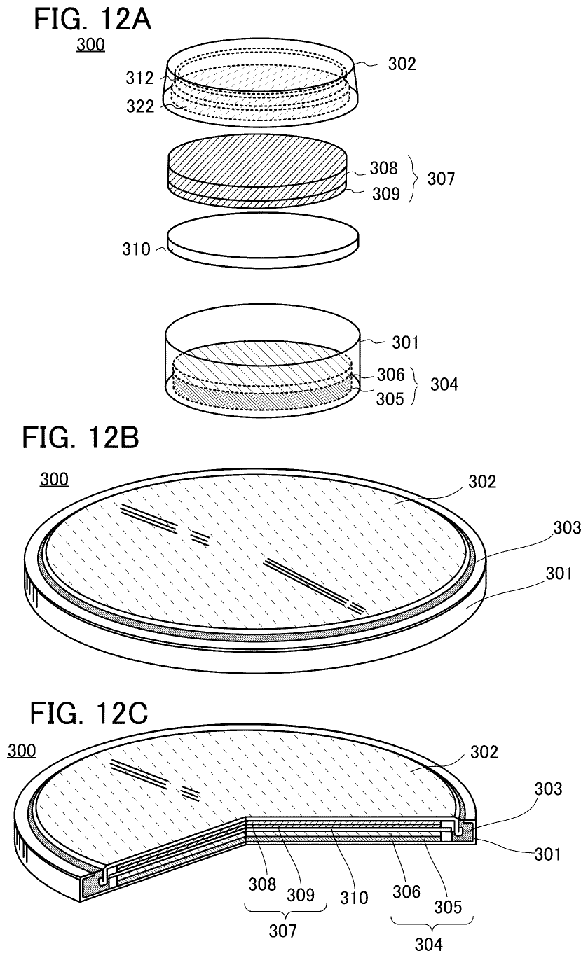

An example of a coin-type secondary battery is described. FIG. 12A, FIG. 12B, and FIG. 12C are an exploded perspective view, an external view, and a cross-sectional view of a coin-type (single-layer flat) secondary battery. Coin-type secondary batteries are mainly used in small electronic devices.

For easy understanding, FIG. 12A is a schematic view illustrating overlap (a vertical relation and a positional relation) between components. Thus, FIGS. 12A and 12B do not completely correspond with each other.

In FIG. 12A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 12A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

FIG. 12B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and a lithium metal foil or lithium-aluminum alloy foil may be used.

Note that only one surface of each of the positive electrode 304 and the negative electrode 307 used for the coin-type secondary battery 300 may be provided with an active material layer. For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 12C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above structure, the coin-type secondary battery 300 can have high discharge capacity and excellent cycle performance.

### [Cylindrical Secondary Battery]

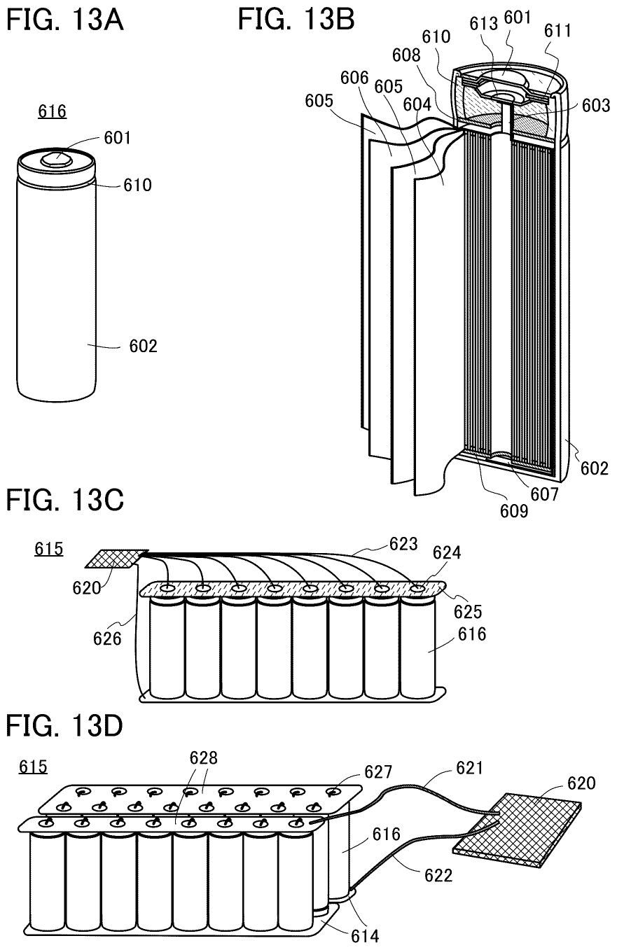

An example of a cylindrical secondary battery is described with reference to FIG. 13A. As illustrated in FIG. 13A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 13B is a diagram schematically illustrating a cross section of the cylindrical secondary battery. The cylindrical secondary battery illustrated in FIG. 13B includes the positive electrode cap (battery cap) 601 on the top surface and the battery can (outer can) 602 on the side and bottom surfaces. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a central axis. One end of the battery can 602 is closed and the other end thereof is opened. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, and the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, the inside of the battery can 602 provided with the battery element is filled with a nonaqueous electrolyte solution (not illustrated). As the nonaqueous electrolyte solution, an electrolyte solution similar to that for the coin-type secondary battery can be used.

Since a positive electrode and a negative electrode that are used for a cylindrical storage battery are wound, active materials are preferably formed on both surfaces of a current collector.

The positive electrode active material 100 described in Embodiments 1, 2, and the like is used in the positive electrode 604, whereby the cylindrical secondary battery 616 can have high capacity, high discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 13C illustrates an example of a power storage system 615. The power storage system 615 includes a plurality of secondary batteries 616. The positive electrodes of the secondary batteries are in contact with and electrically connected to conductors 624 isolated by an insulator 625. The conductors 624 are electrically connected to a control circuit 620 through wirings 623. The negative electrodes of the secondary batteries are electrically connected to the control circuit 620 through a wiring 626. As the control circuit 620, a charge and discharge control circuit for performing charging, discharging, and the like or a protection circuit for preventing overcharge and/or overdischarge can be used.

FIG. 13D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 13D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### [Other Structure Examples of Secondary Battery]

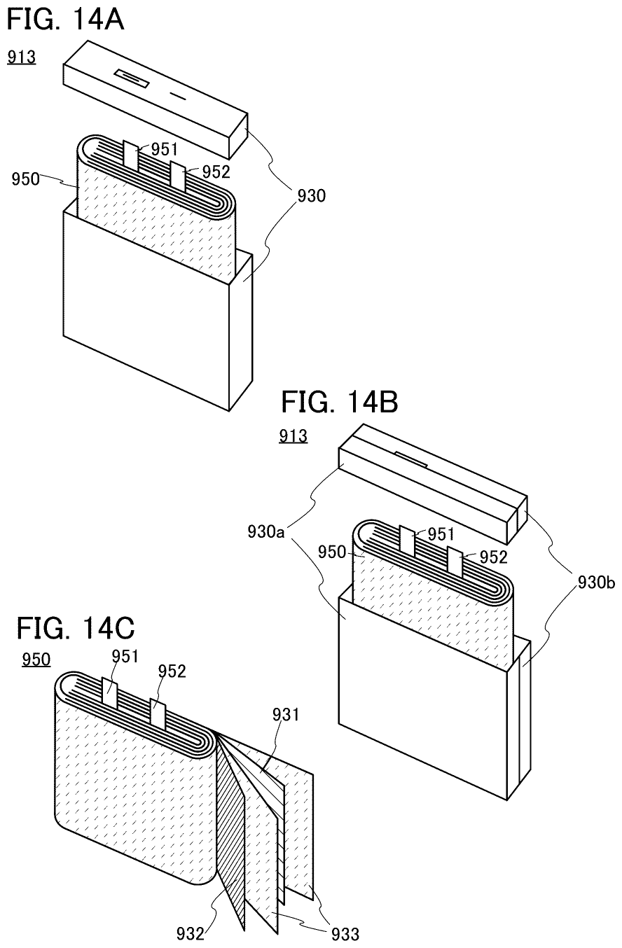

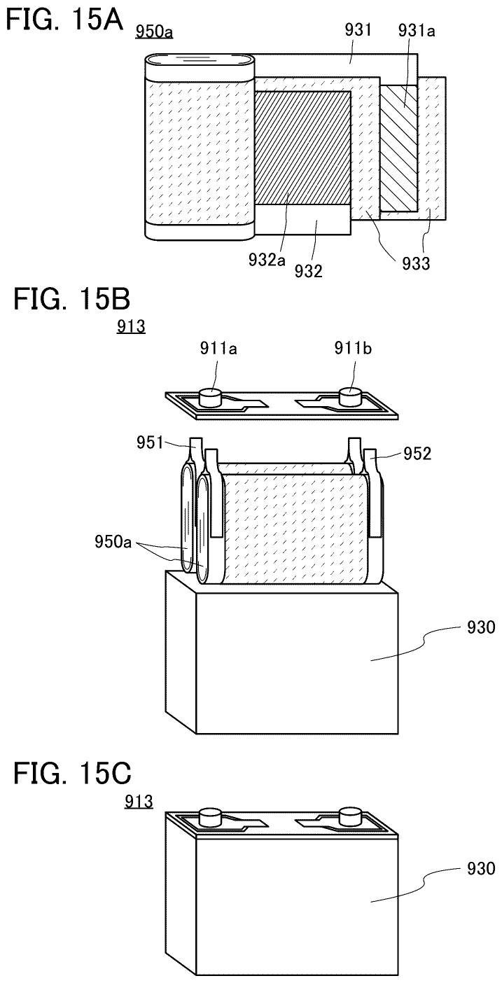

Structure examples of secondary batteries are described with reference to FIGS. 14A to 14C and FIGS. 15A to 15C.

The secondary battery 913 illustrated in FIG. 14A includes a wound body 950 provided with the terminals 951 and 952 inside a housing 930. The wound body 950 is immersed in an electrolyte solution inside the housing 930. The terminal 952 is in contact with the housing 930. The terminal 951 is not in contact with the housing 930 with use of an insulator or the like. Note that in FIG. 14A, the housing 930 divided into two pieces is illustrated for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 14B, the housing 930 in FIG. 14A may be formed using a plurality of materials. For example, in the secondary battery 913 in FIG. 14B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 14C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

As illustrated in FIGS. 15A to 15C, the secondary battery 913 may include a wound body 950a. The wound body 950a illustrated in FIG. 15A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 described in Embodiments 1, 2 and the like is used in the positive electrode 932, whereby the secondary battery 913 can have high capacity, high discharge capacity, and excellent cycle performance.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 15B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 15C, the wound body 950a and an electrolyte solution are covered with the housing 930, whereby the secondary battery 913 is completed. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 15B, the secondary battery 913 may include a plurality of wound bodies 950a. The use of the plurality of wound bodies 950a enables the secondary battery 913 to have higher discharge capacity. The description of the secondary battery 913 in FIGS. 14A to 14C can be referred to for the other components of the secondary battery 913 in FIGS. 15A and 15B.

### <Laminated Secondary Battery>

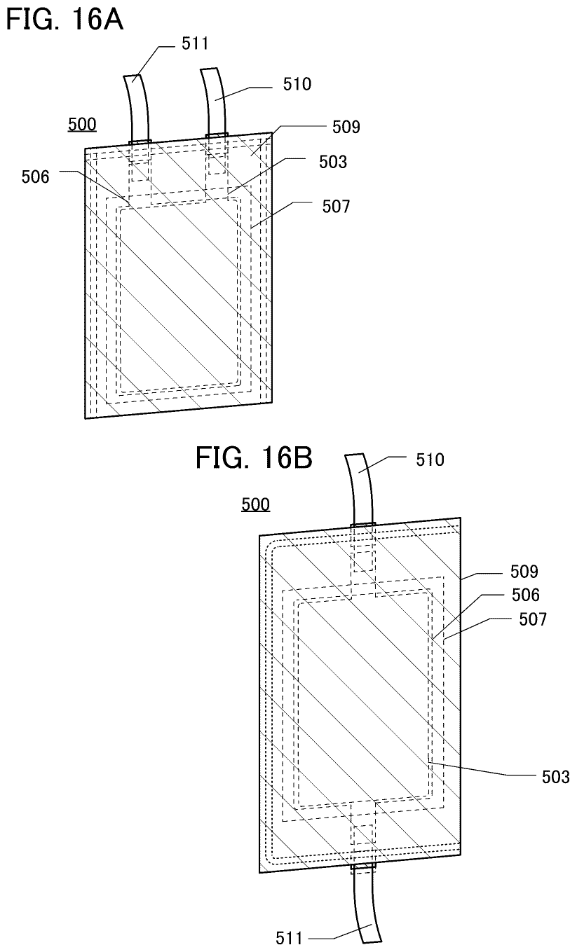

Next, examples of the appearance of a laminated secondary battery are illustrated in FIGS. 16A and 16B. FIGS. 16A and 16B each illustrate a positive electrode 503, a negative electrode 506, a separator 507, an exterior body 509, a positive electrode lead electrode 510, and a negative electrode lead electrode 511.

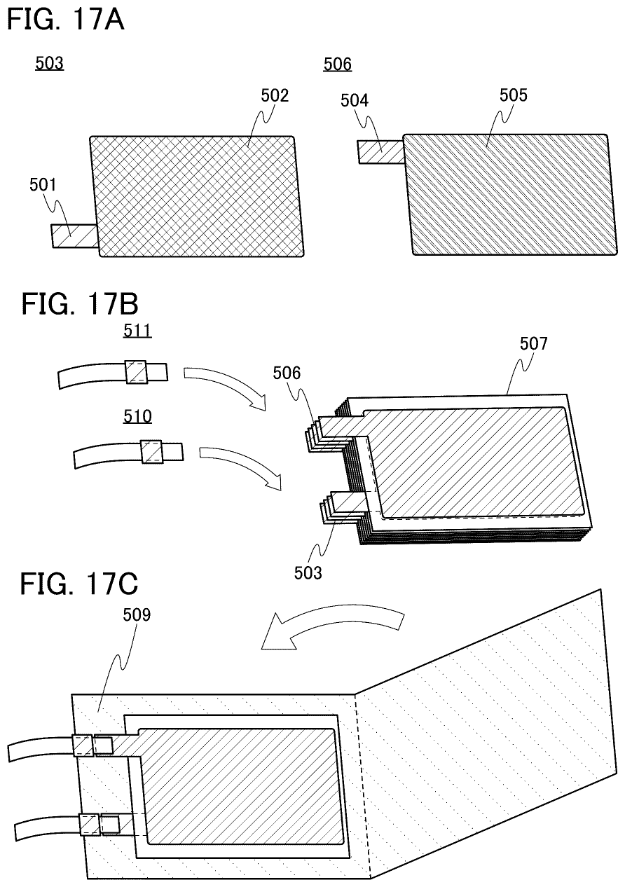

FIG. 17A illustrates external views of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to those in the example illustrated in FIG. 17A.

### <Formation Method of Laminated Secondary Battery>

An example of a method for forming the laminated secondary battery having the appearance illustrated in FIG. 16A will be described with reference to FIGS. 17B and 17C.

First, the negative electrode 506, the separator 507, and the positive electrode 503 are stacked. FIG. 17B illustrates the stacked negative electrodes 506, separators 507, and positive electrodes 503. The secondary battery described here as an example includes five negative electrodes and four positive electrodes. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 17C. Then, the outer edges of the exterior body 509 are bonded to each other. The bonding can be performed by thermocompression, for example. At this time, a part (or one side) of the exterior body 509 is left unbonded (to provide an inlet) so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

The positive electrode active material 100 described in Embodiments 1, 2, and the like is used in the positive electrodes 503, whereby the secondary battery 500 can have high capacity, high discharge capacity, and excellent cycle performance.

### [Examples of Battery Pack]

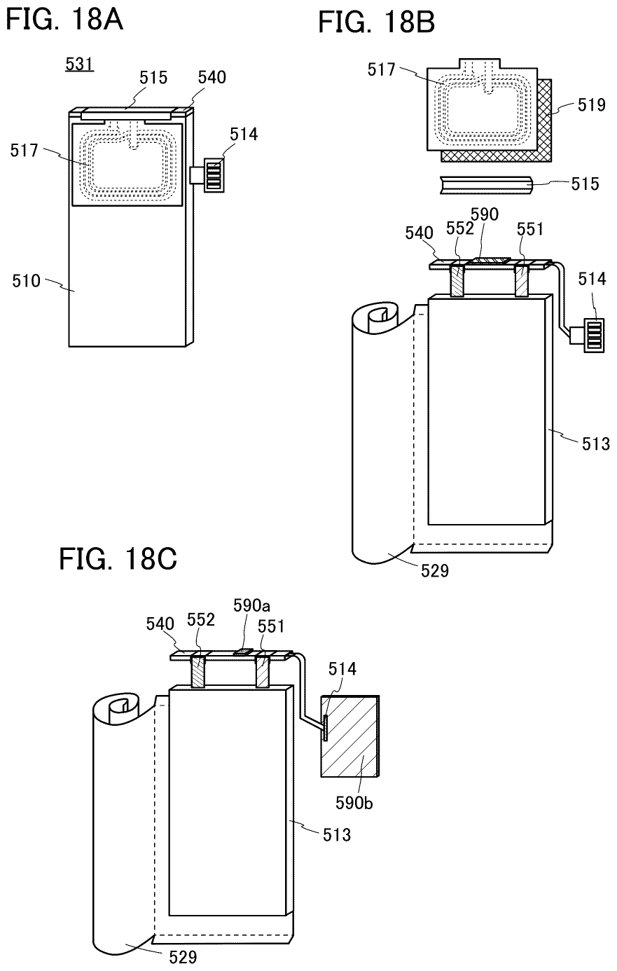

Examples of a secondary battery pack of one embodiment of the present invention that is capable of wireless charging using an antenna will be described with reference to FIGS. 18A to 18C.

FIG. 18A illustrates the appearance of a secondary battery pack 531 that has a rectangular solid shape with a small thickness (also referred to as a flat plate shape with a certain thickness). FIG. 18B illustrates the structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

As for the internal structure of the secondary battery 513, the secondary battery 513 may include a wound body or a stack.

In the secondary battery pack 531, a control circuit 590 is provided over the circuit board 540 as illustrated in FIG. 18B, for example. The circuit board 540 is electrically connected to a terminal 514. Moreover, the circuit board 540 is electrically connected to the antenna 517 and a positive electrode lead and a negative electrode lead 551 and 552 of the secondary battery 513.

Alternatively, as illustrated in FIG. 18C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

The contents in this embodiment can be freely combined with the contents in any of the other embodiments.

### Embodiment 5

In this embodiment, examples of vehicles each including the secondary battery of one embodiment of the present invention are described.

The secondary battery can be used in vehicles, typically automobiles. Examples of the automobiles include next-generation clean energy vehicles such as hybrid vehicles (HVs), electric vehicles (EVs), and plug-in hybrid vehicles (also referred to as PHEVs or PHVs). The secondary battery can be used as one of the power sources provided in the automobiles. The vehicle is not limited to an automobile. Examples of the vehicles include a train, a monorail train, a ship, a submarine (a deep-submergence vehicle and an unmanned submarine), a flying object (a helicopter, an unmanned aircraft (a drone), an airplane, a rocket, and artificial satellite), an electric bicycle, and an electric motorcycle. The secondary battery of one embodiment of the present invention can be used in these vehicles.

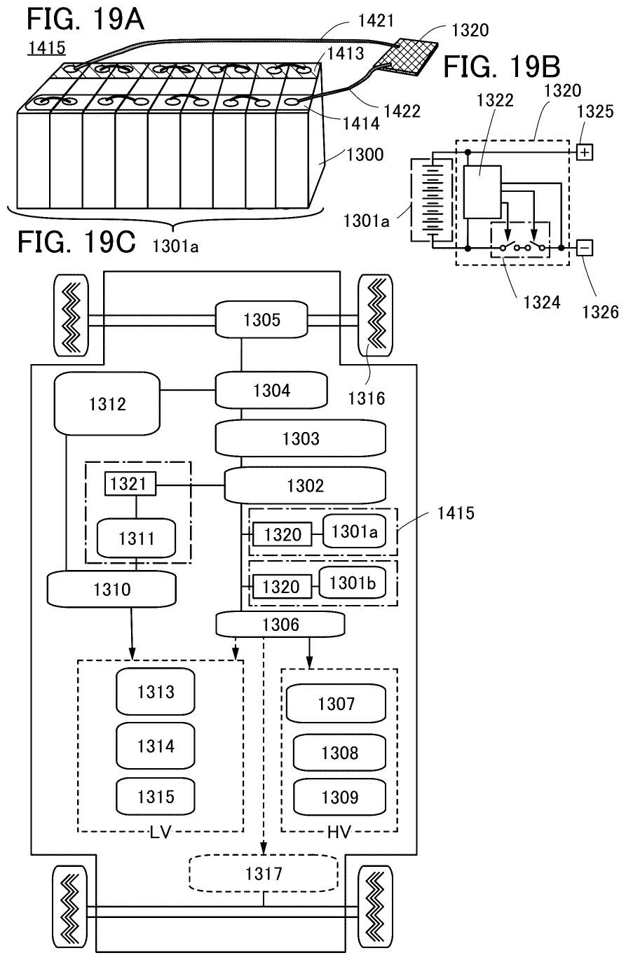

The electric vehicle is provided with first batteries 1301a and 1301b as main secondary batteries for driving and a second battery 1311 that supplies electric power to an inverter 1312 for starting a motor 1304, as illustrated in FIG. 19C. The second battery 1311 is also referred to as a cranking battery and a starter battery. The second battery 1311 only needs high output and does not necessarily have high capacity, and the capacity of the second battery 1311 is lower than that of the first batteries 1301a and 1301b.

The internal structure of the first battery 1301a may be the wound structure illustrated in FIG. 14C or FIG. 15A or the stacked structure illustrated in FIG. 16A or FIG. 16B.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries can be collectively referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

Next, the first battery 1301a is described with reference to FIG. 19A.

FIG. 19A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment describes an example in which the lithium-ion batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrode is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charging control circuit or a battery control system that includes a memory circuit including a transistor using an oxide semiconductor is referred to as a battery operating system or a battery oxide semiconductor (BTOS) in some cases.

A metal oxide functioning as an oxide semiconductor is preferably used. For example, as the metal oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the metal oxide is preferably a c-axis aligned crystal oxide semiconductor (CAAC-OS) or a cloud-aligned composite oxide semiconductor (CAC-OS). Alternatively, an In—Ga oxide or an In—Zn oxide may be used as the metal oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement.

Note that the CAC-OS has a composition in which materials are separated into a first region and a second region to form a mosaic pattern, and the first regions are distributed in the film. This composition is hereinafter also referred to as a cloud-like composition. That is, the CAC-OS is a composite metal oxide having a composition in which the first regions and the second regions are mixed. Note that a clear boundary between the first region and the second region cannot be observed in some cases.

For example, according to EDX mapping obtained by EDX, the CAC-OS in the In—Ga—Zn oxide has a composition in which the region containing In as its main component (the first region) and the region containing Ga as its main component (the second region) are unevenly distributed and mixed.

In the case where the CAC-OS is used for a transistor, a switching function (on/off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Thus, when the CAC-OS is used for a transistor, high on-state current (Ion), high field-effect mobility (u), and excellent switching operation can be achieved.

An oxide semiconductor can have any of various structures that show various different properties. Two or more of an amorphous oxide semiconductor, a polycrystalline oxide semiconductor, an a-like OS, the CAC-OS, an nc-OS, and the CAAC-OS may be included in an oxide semiconductor of one embodiment of the present invention.

The control circuit portion 1320 preferably uses a transistor using an oxide semiconductor because the transistor using an oxide semiconductor can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C. inclusive, which is wider than that of a single crystal Si transistor, and thus shows a smaller change in characteristics than the single crystal Si transistor when the secondary battery is overheated. The off-state current of the transistor using an oxide semiconductor is lower than the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion 1320 is used in combination with a secondary battery having a positive electrode using the positive electrode active material 100 described in Embodiments 1, 2, and the like, the synergy on safety can be obtained. The secondary battery including the positive electrode using the positive electrode active material 100 described in Embodiments 1, 2, and the like and the control circuit portion 1320 can contribute greatly to elimination of accidents due to secondary batteries, such as fires.

The control circuit portion 1320 that uses a memory circuit including a transistor using an oxide semiconductor can also function as an automatic control device for the secondary battery to resolve ten items of causes of instability, such as a micro-short circuit. Examples of functions of resolving the ten items of causes of instability include prevention of overcharging, prevention of overcurrent, control of overheating during charging, cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery. A micro-short circuit refers to not a state where the positive electrode and the negative electrode of a secondary battery are short-circuited so that charge and discharge are impossible, but a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the supposed causes of a micro-short circuit is as follows. Uneven distribution of a positive electrode active material due to multiple charges and discharges causes local current concentration at part of the positive electrode and part of the negative electrode; thus, a malfunction of part of a separator is caused. Another supposed cause is generation of a by-product due to a side reaction.

It can be said that the control circuit portion 1320 not only detects a micro-short circuit but also detects a terminal voltage of the secondary battery and controls the charge and discharge state of the secondary battery. For example, to prevent overcharging, an output transistor of a charge circuit and an interruption switch can be turned off substantially at the same time. Next, FIG. 19B illustrates an example of a block diagram of the battery pack 1415 illustrated in FIG. 19A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, or the like. The range from the lower limit voltage to the upper limit voltage of the secondary battery falls within the recommended voltage range. When a voltage falls outside the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor containing germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), gallium oxide (GaOₓ, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system HV), and the second battery 1311 supplies electric power to in-vehicle parts for 14 V (for a low-voltage system LV). Lead storage batteries are usually used for the second battery 1311 due to cost advantage. Lead storage batteries have disadvantages compared with lithium ion batteries in that they have a larger amount of self-discharge and are more likely to deteriorate due to a phenomenon called sulfation. There is an advantage that the second battery 1311 can be maintenance-free when a lithium-ion battery is used; however, in the case of long-term use, for example three years or more, anomaly that is difficult to determine at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium-ion battery is used as both the first battery 1301a and the second battery 1311 is described. As the second battery 1311, a lead storage battery, an all-solid-state battery, or an electric double layer capacitor may alternatively be used.

Regenerative energy generated by rolling of tires 1316 is transmitted to the motor 1304 through a gear 1305, and is stored in the second battery 1311 through a motor controller 1303, a battery controller 1302, or the control circuit portion 1321. Alternatively, the regenerative energy is stored in the first battery 1301a through the battery controller 1302 and the control circuit portion 1320. Alternatively, the regenerative energy is stored in the first battery 1301b through the battery controller 1302 and the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charge can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a plug of the charger or a connection cable of the charger is sometimes provided with a control circuit. The control circuit portion 1320 is also referred to as an electronic control unit (ECU). The ECU is connected to a controller area network (CAN) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, or a three-phase 200V outlet with 50 KW, for example. Furthermore, charging can be performed with electric power supplied from external charging equipment by a contactless power feeding method or the like.

For fast charging, secondary batteries that can withstand charging at high voltage have been desired to perform charging in a short time.

It is possible to achieve a secondary battery in which graphene is used as a conductive material, the electrode layer is formed thick to suppress a reduction in capacity while increasing the loading amount, and the electrical characteristics are significantly improved in synergy with maintenance of high capacity. This secondary battery is particularly effectively used in a vehicle and can achieve a vehicle that has a long range, specifically a driving range per charge of 500 km or greater, without increasing the proportion of the weight of the secondary battery to the weight of the entire vehicle.

Specifically, in the secondary battery in this embodiment, the use of the positive electrode active material 100 described in Embodiments 1, 2, and the like can increase the operating voltage, and the increase in charge voltage can increase the available capacity. Moreover, using the positive electrode active material 100 described in Embodiments 1, 2, and the like in the positive electrode can provide an automotive secondary battery having excellent cycle performance.

Next, examples in which the secondary battery of one embodiment of the present invention is mounted on a vehicle, typically a transport vehicle, will be described.

Mounting the secondary battery illustrated in any one of FIG. 13D, FIG. 15C, and FIG. 19A on vehicles can achieve next-generation clean energy vehicles such as hybrid vehicles (HVs), electric vehicles (EVs), and plug-in hybrid vehicles (PHVs). The secondary battery can also be mounted on agricultural machines, motorized bicycles including motor-assisted bicycles, motorcycles, electric wheelchairs, electric carts, vessels, submarines, aircraft, rockets, artificial satellites, space probes, planetary probes, or spacecraft. The secondary battery of one embodiment of the present invention can have high capacity. Thus, the secondary battery of one embodiment of the present invention is suitable for reduction in size and weight and is preferably used in transport vehicles.

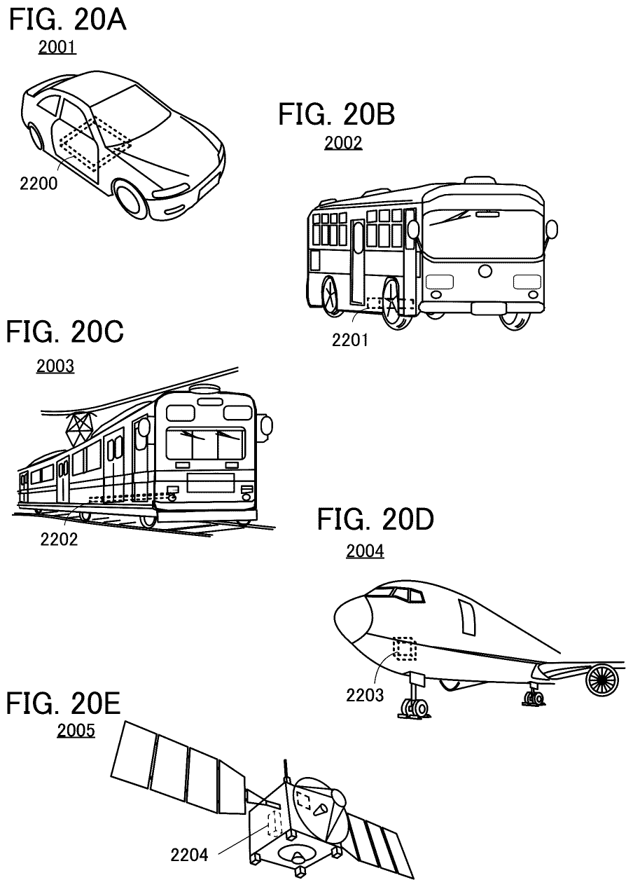

FIGS. 20A to 20D illustrate examples of transport vehicles using one embodiment of the present invention. An automobile 2001 illustrated in FIG. 20A is an electric vehicle that runs using an electric motor as a driving power source. Alternatively, the automobile 2001 is a hybrid electric vehicle capable of driving using either an electric motor or an engine as appropriate. In the case where the secondary battery is mounted on the vehicle, the secondary battery exemplified in Embodiment 4 is provided at one position or several positions. The automobile 2001 illustrated in FIG. 20A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power through external charge equipment by a plug-in system, a contactless power feeding system, or the like. In charging, a given method such as CHAdeMO (registered trademark) or Combined Charging System can be employed as a charge method, the standard of a connector, and the like as appropriate. Charge equipment may be a charging station provided in a commerce facility or a power source in a house. For example, with use of the plug-in technique, the power storage device mounted on the automobile 2001 can be charged by being supplied with electric power from the outside. Charging can be performed by converting AC power into DC power through a converter such as an ACDC converter.

Although not illustrated, the vehicle may be provided with a power receiving device so that it can be charged by being supplied with electric power from an above-ground power transmitting device in a contactless manner. In the case of the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 20B illustrates a large transporter 2002 having a motor controlled by electricity, as an example of a transport vehicle. A secondary battery module of the transporter 2002 includes, for example, a cell unit of four secondary batteries with a nominal voltage of 3.0 V or higher and 5.0 V or lower, and 48 cells are connected in series to have a maximum voltage of 170 V. A battery pack 2201 has the same function as that in FIG. 20A except, for example, the number of secondary batteries configuring the secondary battery module; thus, the description is omitted.

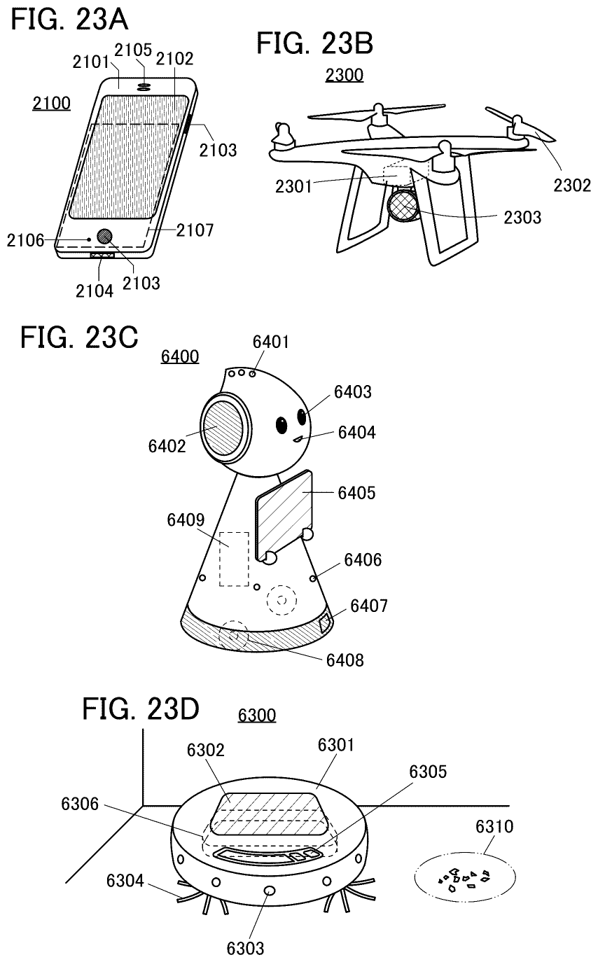

FIG. 20C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V. Thus, the secondary batteries are required to have few variations in the characteristics. With use of a secondary battery with the positive electrode active material 100 described in Embodiments 1, 2, and the like, a secondary battery with stable battery characteristics can be fabricated, which enables the volume production at low costs in terms of the yield. A battery pack 2202 has the same function as that in FIG. 23A except, for example, the number of secondary batteries configuring the secondary battery module; thus, the description is omitted.

FIG. 20D illustrates an aircraft 2004 having a combustion engine as an example. The aircraft 2004 illustrated in FIG. 20D is regarded as a kind of transportation vehicles because it has wheels for takeoff and landing, and includes a battery pack 2203 that includes a charge control device and a secondary battery module configured by connecting a plurality of secondary batteries.

The secondary battery module of the aircraft 2004 has eight 4 V secondary batteries connected in series and has a maximum voltage of 32 V, for example. The battery pack 2203 has the same function as that in FIG. 204A except, for example, the number of secondary batteries configuring the secondary battery module; thus, the description is omitted.

FIG. 20E illustrates an artificial satellite 2005 including a secondary battery 2204 as an example. It is further preferable that the secondary battery 2204 be mounted inside the artificial satellite 2005 while being covered with a heat-retaining member.

The contents in this embodiment can be freely combined with the contents in any of the other embodiments.

### Embodiment 6

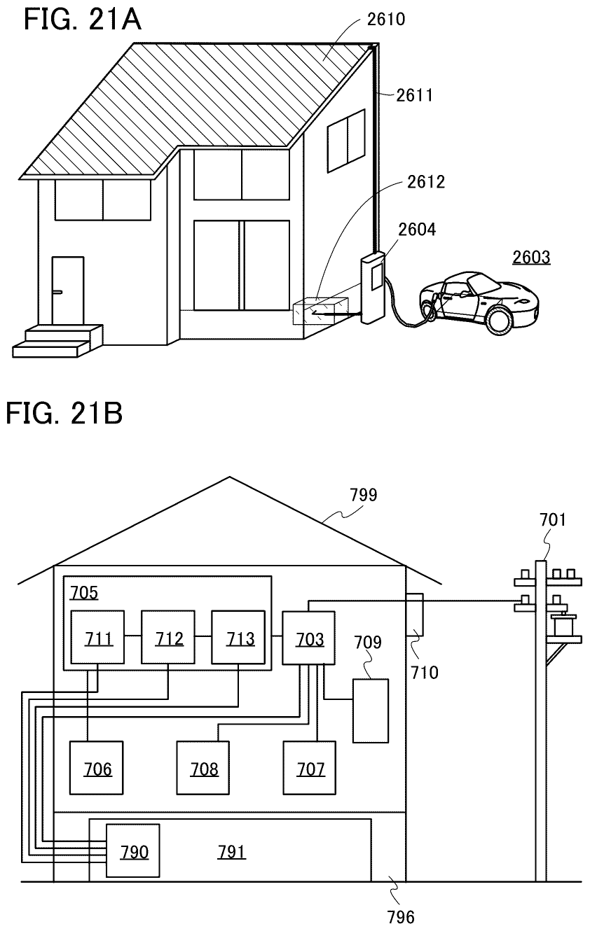

In this embodiment, examples in which the secondary battery of one embodiment of the present invention is mounted on a building will be described with reference to FIGS. 21A and 21B.

A house illustrated in FIG. 21A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charging device 2604. The power storage device 2612 can be charged with electric power generated by the solar panel 2610. A secondary battery included in a vehicle 2603 can be charged with the electric power stored in the power storage device 2612 through the charging device 2604. The power storage device 2612 is preferably provided in an underfloor space. The power storage device 2612 is preferably provided in the underfloor space, in which case the space on the floor can be effectively used. Alternatively, the power storage device 2612 may be provided on the floor.

The electric power stored in the power storage device 2612 can also be supplied to other electronic devices in the house. Thus, the electronic devices can be operated with use of the power storage device 2612 of one embodiment of the present invention as an uninterruptible power source even when electric power cannot be supplied from the commercial power supply due to power failure or the like.

FIG. 21B illustrates an example of a power storage device of one embodiment of the present invention. As illustrated in FIG. 21B, a power storage device 791 of one embodiment of the present invention is provided in an underfloor space 796 of a building 799. With use of a secondary battery including a positive electrode including the positive electrode active material 100 described in Embodiments 1, 2, and the like for the power storage device 791, the synergy on safety can be obtained. The secondary battery including the positive electrode including the positive electrode active material 100 described in Embodiments 1, 2, and the like can contribute greatly to elimination of accidents due to the power storage device 791 including secondary batteries, such as fires.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may also have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The indicator 706 can show the amount of electric power consumed by the general load 707 and the power storage load 708 that is measured by the measuring portion 711. An electronic device such as a TV or a personal computer can also show it through the router 709. Furthermore, a portable electronic terminal such as a smartphone or a tablet can also show it through the router 709. The indicator 706, the electronic device, and the portable electronic terminal can also show the demand for electric power depending on a time period (or per hour) that is predicted by the predicting portion 712.

The contents in this embodiment can be freely combined with the contents in any of the other embodiments.

### Embodiment 7

This embodiment will describe examples in which the lithium-ion battery of one embodiment of the present invention is mounted on a two-wheeled vehicle and a bicycle as examples of mounting a secondary battery in a vehicle.

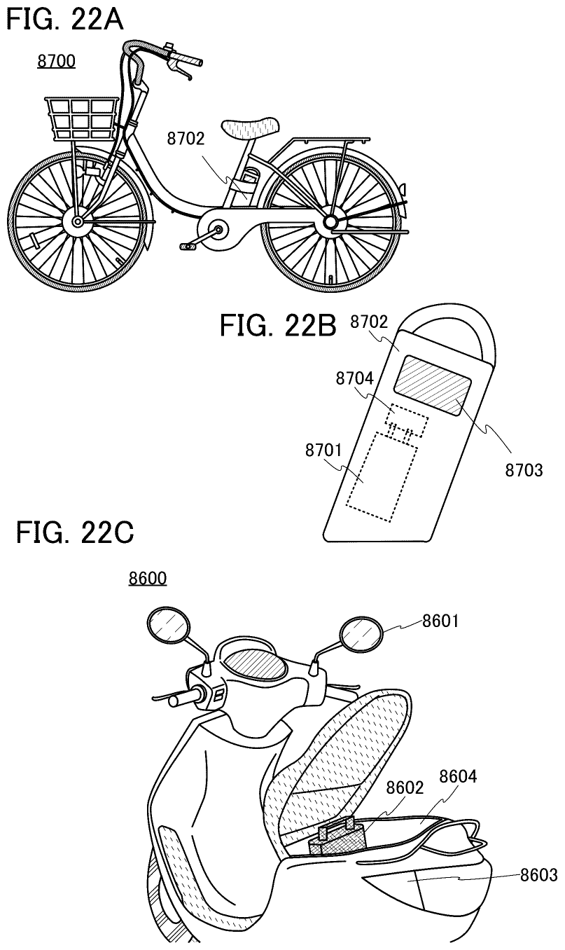

FIG. 22A illustrates an example of an electric bicycle using the power storage device of one embodiment of the present invention. The power storage device of one embodiment of the present invention can be used for an electric bicycle 8700 in FIG. 22A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 22B illustrates the state where the power storage device 8702 is detached from the bicycle. The power storage device 8702 incorporates a plurality of storage batteries 8701 included in the power storage device of one embodiment of the present invention, and can display the remaining battery level and the like on a display portion 8703. The power storage device 8702 includes a control circuit 8704 capable of charge control or anomaly detection for the secondary battery. The control circuit 8704 is electrically connected to a positive electrode and a negative electrode of the storage battery 8701. When the control circuit 8704 is used in combination with a secondary battery including a positive electrode including the positive electrode active material 100 described in Embodiments 1, 2, and the like, the synergy on safety can be obtained. The secondary battery including the positive electrode including the positive electrode active material 100 described in Embodiments 1, 2, and the like and the control circuit 8704 can contribute greatly to elimination of accidents due to secondary batteries, such as fires.

FIG. 22C illustrates an example of a two-wheeled vehicle using the power storage device of one embodiment of the present invention. A motor scooter 8600 illustrated in FIG. 22C includes a power storage device 8602, side mirrors 8601, and indicator lights 8603. The power storage device 8602 can supply electricity to the indicator lights 8603. The power storage device 8602 including a plurality of secondary batteries including a positive electrode including the positive electrode active material 100 described in Embodiments 1, 2, and the like can have high capacity and contribute to a reduction in size.

In the motor scooter 8600 illustrated in FIG. 22C, the power storage device 8602 can be held in an under-seat storage unit 8604. The power storage device 8602 can be stored in the under-seat storage unit 8604 even when the under-seat storage unit 8604 is small.

The contents in this embodiment can be freely combined with the contents in any of the other embodiments.

### Embodiment 8

In this embodiment, examples of electronic devices each including the secondary battery of one embodiment of the present invention will be described. Examples of the electronic device provided with the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

FIG. 23A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a secondary battery 2107. The use of the secondary battery 2107 including a positive electrode including the positive electrode active material 100 described in Embodiments 1, 2, and the like achieves high capacity and a structure that accommodates space saving due to a reduction in size of the housing.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 23B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode including the positive electrode active material 100 described in Embodiments 1, 2, and the like has a high energy density and a high degree of safety, and thus can be used safely for a long time over a long period of time and is preferable as the secondary battery included in the unmanned aircraft 2300.

FIG. 23C illustrates an example of a robot. A robot 6400 illustrated in FIG. 23C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode including the positive electrode active material 100 described in Embodiments 1, 2, and the like has a high energy density and a high degree of safety, and thus can be used safely for a long time over a long period of time and is preferable as the secondary battery 6409 included in the robot 6400.

FIG. 23D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on a bottom surface.

The cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 further includes, in its inner region, the secondary battery 6306 of one embodiment of the present invention and a semiconductor device or an electronic component. A secondary battery including a positive electrode including the positive electrode active material 100 described in Embodiments 1, 2, and the like has a high energy density and a high degree of safety, and thus can be used safely for a long time over a long period of time and is preferable as the secondary battery 6306 included in the cleaning robot 6300.

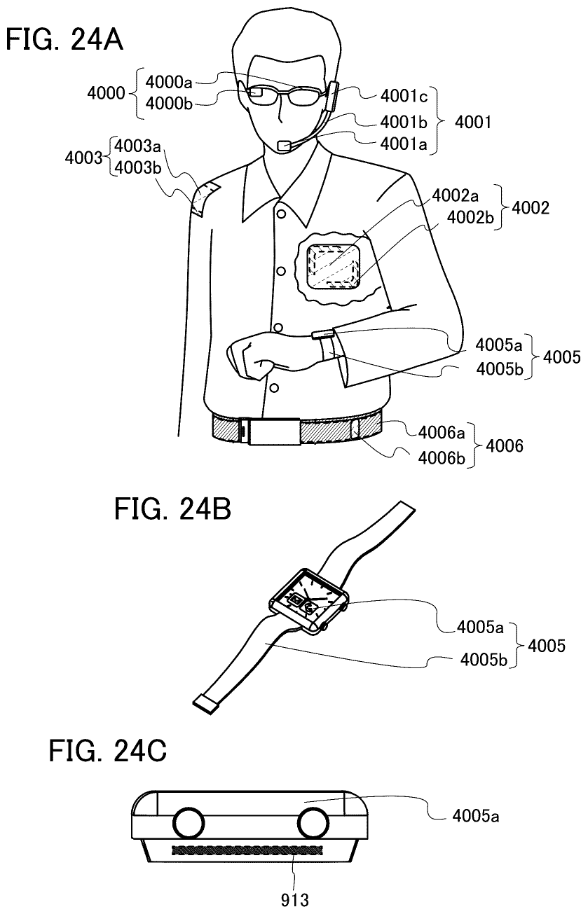

FIG. 24A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 24A. The glasses-type device 4000 includes a frame 4000a and a display part 4000b. The secondary battery is provided in a temple of the frame 4000a having a curved shape, whereby the glasses-type device 4000 can be lightweight, can have a well-balanced weight, and can be used continuously for a long time. A secondary battery including a positive electrode including the positive electrode active material 100 described in Embodiments 1, 2, and the like has a high energy density and achieves a structure that accommodates space saving due to a reduction in size of the housing.

The secondary battery of one embodiment of the present invention can be provided in a headset-type device 4001. The headset-type device 4001 includes at least a microphone unit 4001a, a flexible pipe 4001b, and an earphone unit 4001c. The secondary battery can be provided in the flexible pipe 4001b or the earphone portion 4001c. A secondary battery including a positive electrode including the positive electrode active material 100 described in Embodiments 1, 2, and the like has a high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode including the positive electrode active material 100 described in Embodiments 1, 2, and the like has a high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode including the positive electrode active material 100 described in Embodiments 1, 2, and the like has a high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode including the positive electrode active material 100 described in Embodiments 1, 2, and the like has a high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode including the positive electrode active material 100 described in Embodiments 1, 2, and the like has a high energy density and achieves a structure that accommodates space saving due to a reduction in size of the housing.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 24B is a perspective view of the watch-type device 4005 that is detached from an arm.

FIG. 24C is a side view thereof. FIG. 24C illustrates a state where the secondary battery 913 is incorporated in the inner region. The secondary battery 913 is the secondary battery described in Embodiment 4. The secondary battery 913 is provided to overlap the display portion 4005a, can have a high density and high capacity, and is small and lightweight.

Since the secondary battery in the watch-type device 4005 is required to be small and lightweight, the use of the positive electrode active material 100 described in Embodiments 1, 2, and the like in the positive electrode enables the secondary battery 913 to have a high energy density and a small size.

The contents in this embodiment can be freely combined with the contents in any of the other embodiments.

### Example 1

In Example 1, a positive electrode active material in which magnesium, nickel, and aluminum were added to lithium cobalt oxide that had been subjected to initial heating was formed with reference to Embodiment 1, and characteristics of the positive electrode active material were evaluated.

### <Formation of Positive Electrode Active Material>

The formation of the positive electrode active material in this example will be described with reference to the formation method shown in FIG. 2 to FIG. 3B.

### <Sample 2>

As the LiCoO₂ (starting material) in Step S10 in FIG. 2, commercially available lithium cobalt oxide (Cellseed C-10N produced by NIPPON CHEMICAL INDUSTRIAL CO., LTD.) containing cobalt as the transition metal M and no additive element was prepared. As the second lithium source (Li source 2) in Step S15, lithium fluoride was prepared. In Step S16, the lithium cobalt oxide and lithium fluoride were mixed, and then the mixture was put in a crucible, covered with a lid, and heated at 850° C. for two hours in a muffle furnace as the initial heating of Step S17. No flowing was performed after the muffle furnace was filled with an oxygen atmosphere (O2 purged). In the mixing of Step S16, the lithium fluoride was weighed such that the number of moles of lithium fluoride was 0.33 (0.33 mol %) assuming that the number of moles of lithium cobalt oxide was 100. In the mixing, a ball mill was used and a grinding medium was zirconium oxide balls.

In accordance with Steps S21 to S23 and Steps S41 to S43 shown in FIGS. 3A and 3B, Mg, F, Ni, and Al were separately added as the added elements.

In accordance with Step S21 shown in FIG. 3A, lithium fluoride (LiF) was prepared as the F source, and magnesium fluoride (MgF₂) was prepared as the Mg source. The lithium fluoride and the magnesium fluoride were weighed so that LiF:MgF₂=1:3 (molar ratio). Then, the lithium fluoride and magnesium fluoride were mixed into dehydrated acetone and the mixture was stirred at a rotational speed of 400 rpm for 12 hours, whereby the additive element source (the A1 source) was produced. In the mixing, a ball mill was used and a grinding medium was zirconium oxide balls. After the mixing, the mixture was made to pass through a sieve with an aperture of 300 μm, whereby the A1 source was obtained.

Next, as Step S31, the magnesium fluoride contained in the A1 source was weighed such that the number of moles of magnesium fluoride was 1 (1 mol %) assuming that the number of moles of lithium cobalt oxide was 100, and mixed with the lithium cobalt oxide that had been subjected to the initial heating by a dry method. Stirring was performed at a rotational speed of 150 rpm for an hour. These conditions were milder than those of the stirring in the production of the A1 source. Finally, the mixture was made to pass through a sieve with an aperture of 300 μm, whereby the mixture 903 having a uniform particle diameter was obtained (Step S32).

Next, as Step S33, the mixture 903 was heated. The heating was performed at 900° C. for 20 hours. During the heating, the mixture 903 was in a crucible covered with a lid. The crucible was filled with an atmosphere containing oxygen and the entry and exit of the oxygen were blocked (purged). By the heating, a composite oxide containing Mg and F was obtained (Step S34a).

Then, in Step S51, the composite oxide and the additive element source (the A2 source) were mixed. In accordance with Step S41 shown in FIG. 3B, nickel hydroxide and aluminum hydroxide were prepared as the Ni source and the A1 source, respectively. The nickel hydroxide and aluminum hydroxide were weighed such that number of moles of nickel hydroxide contained was 0.5 (0.5 mol %) and the number of moles of aluminum hydroxide was 0.5 (0.5 mol %) in the A2 source assuming that the number of moles of lithium cobalt oxide was 100, and mixed with the composite oxide by a dry method. Stirring was performed at a rotational speed of 150 rpm for an hour. In the mixing, a ball mill was used and a grinding medium was zirconium oxide balls. After the mixing, the mixture was made to pass through a sieve with an aperture of 300 μm, whereby a mixture 904 having a uniform particle diameter was obtained (Step S52).

Next, as Step S53, the mixture 904 was heated. The heating was performed at 850° C. for 10 hours. During the heating, the mixture 904 was in a crucible covered with a lid. The crucible was filled with an atmosphere containing oxygen and the entry and exit of the oxygen were blocked (purged). By the heating, lithium cobalt oxide containing Mg, F, Ni, and Al was obtained (Step S54). This positive electrode active material (composite oxide), which was obtained through the above steps, was used as Sample 2.

### <Sample 1>

Sample 1 was formed in a manner similar to that of Sample 2 except that lithium fluoride (F source) was not prepared in Step S21 and the A1 source in Step 23 only contains magnesium fluoride.

### <Sample 3>

Sample 3 was formed in a manner similar to that of Sample 1 except that the heating temperature in Step S17 was 900° C.

### <Sample 4>

Sample 4 was formed in a manner similar to that of Sample 2 except that the heating temperature in Step S17 was 900° C.

### <Sample 5>

Sample 5 was formed in a manner similar to that of Sample 2 except that lithium fluoride (Li source 2) was not prepared in Step S15 and Step S16 was not performed, i.e., only the lithium cobalt oxide as a starting material was heated in Step S17.

### <Sample 6>

Sample 6 was formed in a manner similar to that of Sample 4 except that lithium fluoride (Li source 2) was not prepared in Step S15 and Step S16 was not performed, i.e., only the lithium cobalt oxide as a starting material was heated in Step S17.

The formation conditions of the samples are shown in Table 1. Note that “mol %” in Table 1 represents the proportion of the number of moles of the additive element to that of LiCoO₂. Furthermore, “None” in the table indicates that the initial heating was performed without addition of the second lithium source (Li source 2). In other words, Sample 5 and Sample 6 are comparative examples in this example.

TABLE 1

| | Initial heating | | A1 source | | A2 source | |
|---|---|---|---|---|---|---|
| | Second | | | Additive | | Additive |
| | lithium source | Temperature | Material | amount | Material | amount |
| Sample 1 | LiF | 850° C. | MgF₂ | 1 mol % | Ni(OH)₂ + | 0.5 mol % + |
| | | | | | Al(OH)₃ | 0.5 mol % |
| Sample 2 | LiF | 850° C. | LiF + MgF₂ | 0.33 mol % + | Ni(OH)₂ + | 0.5 mol % + |
| | | | | 1.0 mol % | Al(OH)₃ | 0.5 mol % |
| Sample 3 | LiF | 900° C. | MgF₂ | 1 mol % | Ni(OH)₂ + | 0.5 mol % + |
| | | | | | Al(OH)₃ | 0.5 mol % |
| Sample 4 | LiF | 900° C. | LiF + MgF₂ | 0.33 mol % + | Ni(OH)₂ + | 0.5 mol % + |
| | | | | 1.0 mol % | Al(OH)₃ | 0.5 mol % |
| Sample 5 | None | 850° C. | LiF + MgF₂ | 0.33 mol % + | Ni(OH)₂ + | 0.5 mol % + |
| | | | | 1.0 mol % | Al(OH)₃ | 0.5 mol % |
| Sample 6 | None | 900° C. | LiF + MgF₂ | 0.33 mol % + | Ni(OH)₂ + | 0.5 mol % + |
| | | | | 1.0 mol % | Al(OH)₃ | 0.5 mol % |

### <Particle Size Distribution Measurement>

The particle size distributions of Sample 1 to Sample 6 were measured with a laser diffraction particle size distribution analyzer. As the measurement results of particle size distribution, D50, D10, and D90 are shown in Table 2.

TABLE 2

| | Particle size distribution | | |
|---|---|---|---|
| | D50 | D10 | D90 |
| Sample 1 | 15.81 μm | 8.99 μm | 24.53 μm |
| Sample 2 | 13.13 μm | 7.46 μm | 21.48 μm |
| Sample 3 | 13.33 μm | 7.53 μm | 21.80 μm |
| Sample 4 | 13.82 μm | 7.77 μm | 22.43 μm |
| Sample 5 | 13.92 μm | 7.76 μm | 22.63 μm |
| Sample 6 | 14.42 μm | 8.37 μm | 22.55 μm |

### <HAADF-STEM Analysis and EELS Analysis>

In order to examine the influence of the initial heating in Step S17, analysis was conducted on materials at the midway stage of the formation process of Sample 4 and materials at the midway stage of the formation process of Sample 5. As the analysis, HAADF-STEM analysis and electron energy-loss spectroscopy (EELS) analysis were conducted using LiCoO₂ as the starting material (Step S10), LiCoO₂ that was subjected to the initial heating at the midway stage of forming Sample 4 (that is, this LiCoO₂ experienced the mixing with lithium fluoride as the second lithium source and Step S17), and LiCoO₂ that was subjected to the initial heating at the midway stage of forming Sample 5 (that is, this LiCoO₂ experienced Step S17 without the mixing with lithium fluoride as the second lithium source).

Apparatuses shown below were used for the HAADF-STEM analysis and the EELS analysis.

### <<HAADF-STEM Analysis>>

Analysis method: high-angle annular dark field method (HAADF)
Transmission electron microscope: JEM-ARM200F NEOARM by JEOL Ltd.
Acceleration voltage: 200 kV

### <<EELS Analysis>>

Analysis method: electron energy-loss spectroscopy (EELS)
Transmission electron microscope: JEM-ARM200F NEOARM by JEOL Ltd.
Acceleration voltage: 200 kV
EELS detector: Continuum K3 produced by Gatan, Inc
Dwell time: 0.5 sec
Frame number: 40

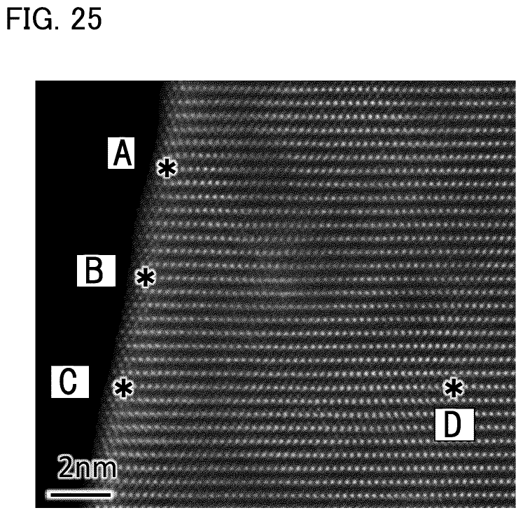

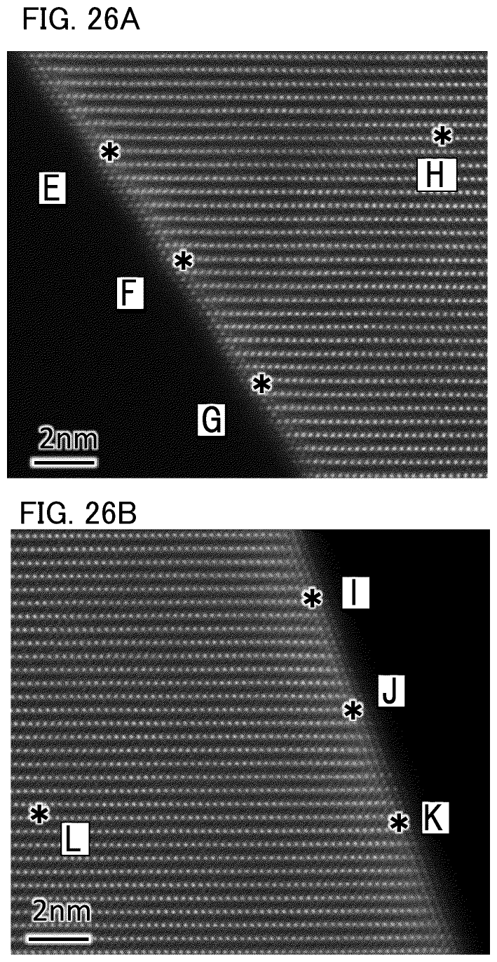

FIG. 25 shows a HAADF-STEM image of LiCoO₂ as the starting material (Step S10). FIG. 26A shows a HAADF-STEM image of LiCoO₂ that was subjected to the initial heating at the midway stage of forming Sample 4. FIG. 26B shows a HAADF-STEM image of LiCoO₂ that was subjected to the initial heating at the midway stage of forming Sample 5.

EELS analysis was conducted on points denoted by A to L in FIG. 25 and FIGS. 26A and 26B. The EELS results are shown in Table 3. In the EELS analysis, the valences of cobalt were analyzed at the analysis points (the points A, B, C, E, F, G, I, J, and K mentioned above) within 2 nm from the surface (a position where bright spots can be clearly seen) of the samples on the HAADF-STEM images. For the analysis of the valences of cobalt, the valence of cobalt in measured data was calculated from a calibration curve that was formed in advance on the basis of the relation of the cobalt valence with the position of the local maximum value of the cobalt L3 peak. Note that for the formation of the calibration curve, EELS analysis data in the bulk portions (inside the particles) of lithium cobalt phosphate (LiCoPO₄, divalent cobalt), tricobalt tetraoxide (Co₃O₄, 2.7-valent cobalt), and lithium cobalt oxide (LiCoO₂, trivalent cobalt). From the above valences of cobalt, the proportion of rock-salt crystal structure (trivalent cobalt) and the proportion of layered rock-salt crystal structure (divalent cobalt) were calculated on the assumption that only these two crystal structures exist in the analysis points. Table 3 shows the calculated proportions of rock-salt crystal structure and layered rock-salt crystal structure (“Rock-salt proportion” and “Layered rock-salt proportion”).

TABLE 3

| | Starting material LiCoO₂ | | | Sample 4_post initial heating | | | Sample 5_post initial heating | | |
|---|---|---|---|---|---|---|---|---|---|
| | | | Layered | | | Layered | | | Layered |
| | Cobalt | Rock-salt | rock-salt | Cobalt | Rock-salt | rock-salt | Cobalt | Rock-salt | rock-salt |
| | valence | proportion | proportion | valence | proportion | proportion | valence | proportion | proportion |
| Inside | 3.00 | 0% | 100% | 3.00 | 0% | 100% | 3.00 | 0% | 100% |
| (D, H, L) | | | | | | | | | |
| Surface portion 1 | 2.25 | 75% | 25% | 2.47 | 53% | 47% | 2.22 | 78% | 22% |
| (A, E, I) | | | | | | | | | |
| Surface portion 2 | 2.18 | 82% | 18% | 2.46 | 54% | 46% | 2.26 | 74% | 26% |
| (B, F, J) | | | | | | | | | |
| Surface portion 3 | 2.22 | 78% | 22% | 2.52 | 48% | 52% | 2.17 | 83% | 17% |
| (C, G, K) | | | | | | | | | |

According to the EELS analysis results, the LiCoO₂ subjected to the initial heating at the midway stage of forming Sample 4 has relatively high cobalt valence, i.e., has a small proportion of the rock-salt crystal structure in the vicinity of the surface of the surface portion of the particle. In other words, it was revealed that LiCoO₂ subjected to the initial heating at the midway stage of forming Sample 4 had a high proportion of the layered rock-salt crystal structure in the vicinity of the surface of the surface portion of the particle.

### <STEM-EDX Analysis>

Cross-sectional STEM-EDX analysis was conducted on edge regions of the surface portions of Sample 4 and Sample 5.

As pretreatment before the analysis, Sample 4 and Sample 5 were sliced by an FIB method (μ-sampling method)

Apparatuses shown below were used for the analysis with STEM and EDX.

### <<STEM Observation>>

Scanning transmission electron microscope: HF5000 by Hitachi High-Tech Corporation
Observation condition, acceleration voltage: 200 kV
Magnification accuracy: +3%

### <<STEM-EDX Analysis>>

Analysis method: energy dispersive X-ray spectroscopy (EDX)
Scanning transmission electron microscope: HF5000 by Hitachi High-Tech Corporation
Acceleration voltage: 200 kV
Observation mode: HR mapping mode
Element analysis apparatus: including 2 devices, UltimMax TLE
X-ray detector: Si drift detector
Energy resolution: approximately 127 eV
X-ray extraction angle: 23.9°
Solid angle: 2.02 sr
Number of captured pixels: 256× 256

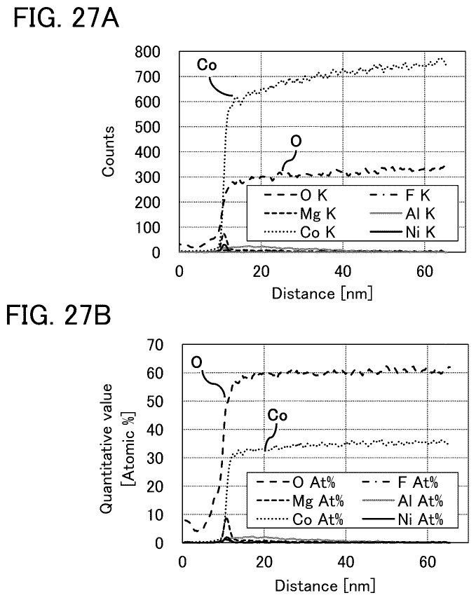

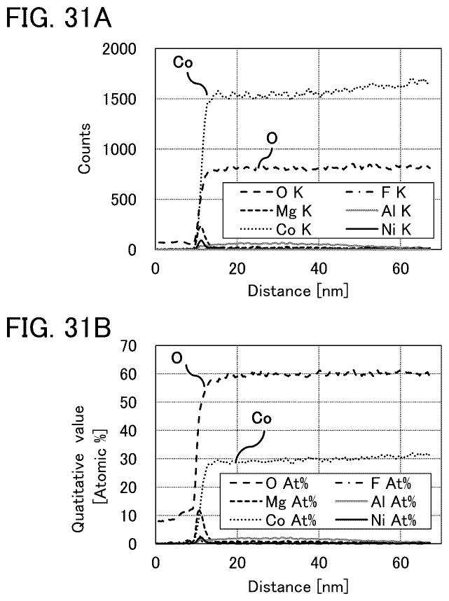

FIGS. 27A to 30B show results of the cross-sectional STEM-EDX analysis performed on Sample 4. FIGS. 31A to 34B show results of the cross-sectional STEM-EDX analysis performed on Sample 5. Note that the cross-sectional STEM-EDX analysis is linear analysis carried out from the outside to the inside of a sample.

FIG. 27A is a graph showing the results of the cross-sectional STEM-EDX analysis on the edge region of the surface portion of Sample 4 with a vertical axis representing count values of the characteristic X-ray, and FIG. 27B is a graph with a vertical axis representing quantitative values as Atomic % instead of the vertical axis in FIG. 27A. On each of horizontal axes of FIGS. 27A and 27B, a reference point of the particle surface is presumed at a position of 10 nm. Note that the position of the reference point was determined by the method described in Embodiment 2 (using the half of the count values of the characteristic X-ray of oxygen).

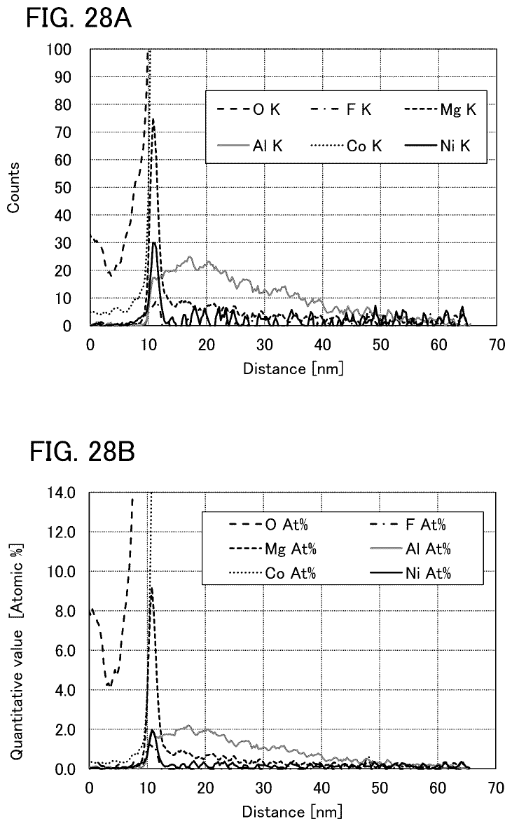

FIG. 28A is a graph with an enlarged vertical axis of FIG. 27A, and FIG. 28B is a graph with an enlarged vertical axis of FIG. 27B.

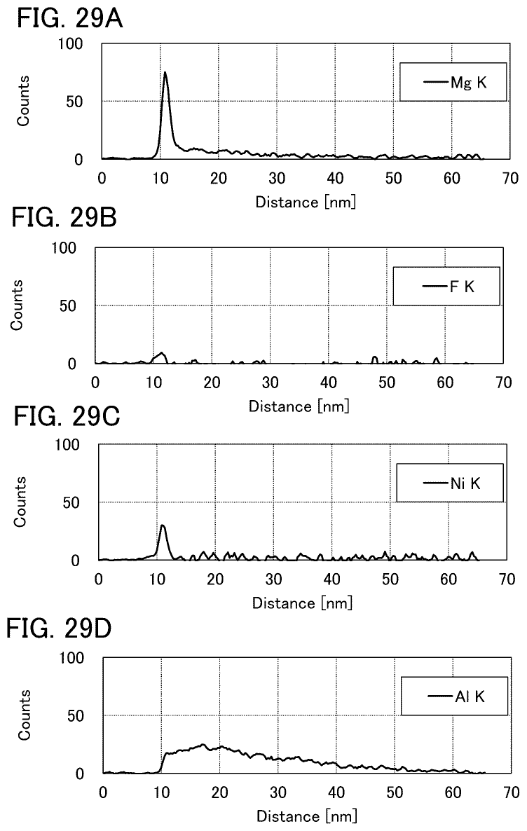

FIG. 29A is a graph of magnesium (Mg K) extracted from FIG. 28A; FIG. 29B is a graph of fluorine (F K) extracted from FIG. 28A; FIG. 29C is a graph of nickel (Ni K) extracted from FIG. 28A; and FIG. 29D is a graph of aluminum (Al K) extracted from FIG. 28A.

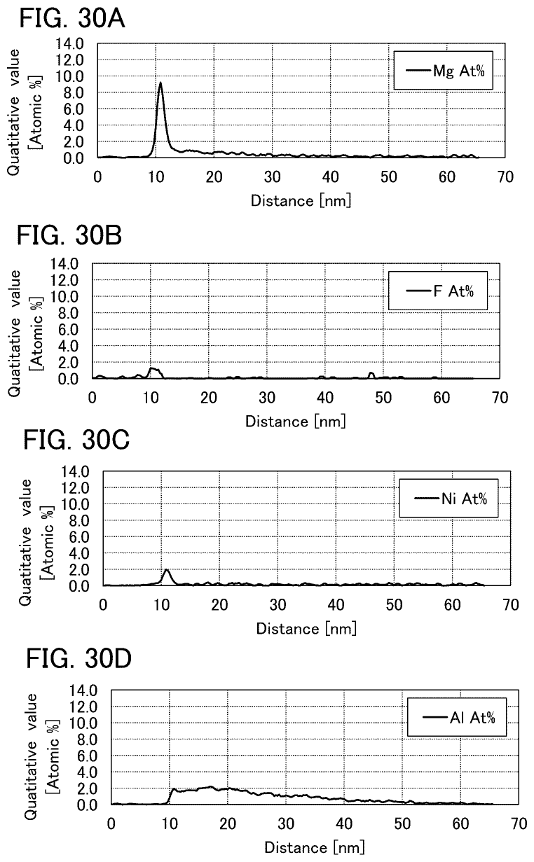

FIG. 30A is a graph of magnesium (Mg At %) extracted from FIG. 28B; FIG. 30B is a graph of fluorine (F At %) extracted from FIG. 28B; FIG. 30C is a graph of nickel (Ni At %) extracted from FIG. 28B, and FIG. 30D is a graph of aluminum (Al At %) extracted from FIG. 28B.

FIG. 31A is a graph showing the results of the cross-sectional STEM-EDX analysis on the edge region of the surface portion of Sample 5 with a vertical axis representing count values of the characteristic X-ray, and FIG. 31B is a graph with a vertical axis representing quantitative values as Atomic % instead of the vertical axis in FIG. 31A. On each of horizontal axes of FIGS. 31A and 31B, a reference point of the particle surface is presumed at a position of 10 nm. Note that the position of the reference point was determined by the method described in Embodiment 2.

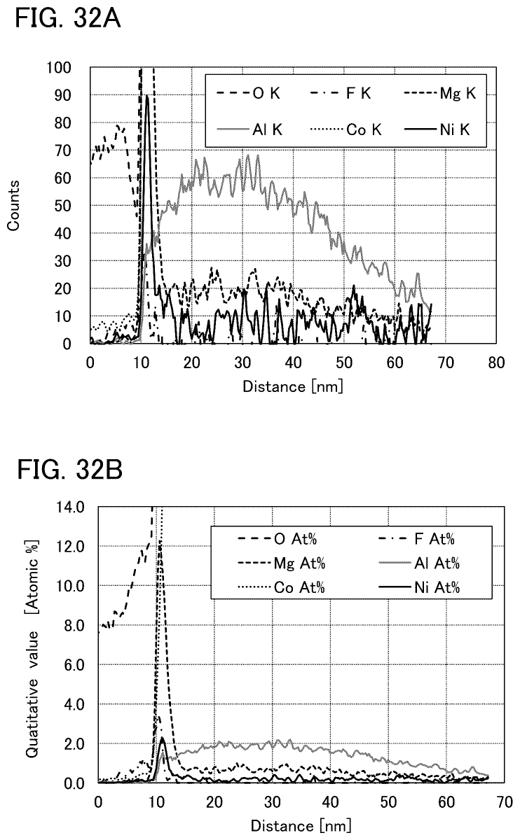

FIG. 32A is a graph with an enlarged vertical axis of FIG. 31A, and FIG. 32B is a graph with an enlarged vertical axis of FIG. 31B.

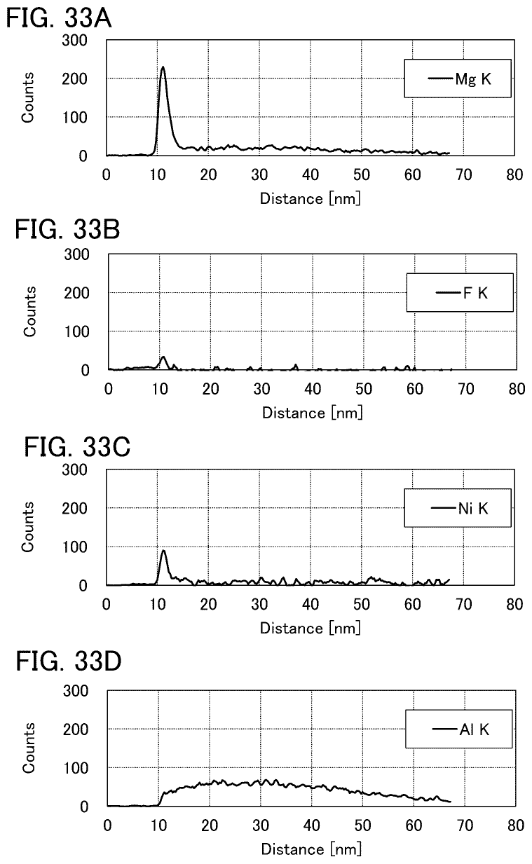

FIG. 33A is a graph of magnesium (Mg K) extracted from FIG. 32A; FIG. 33B is a graph of fluorine (F K) extracted from FIG. 32A; FIG. 33C is a graph of nickel (Ni K) extracted from FIG. 32A; and FIG. 33D is a graph of aluminum (Al K) extracted from FIG. 32A.

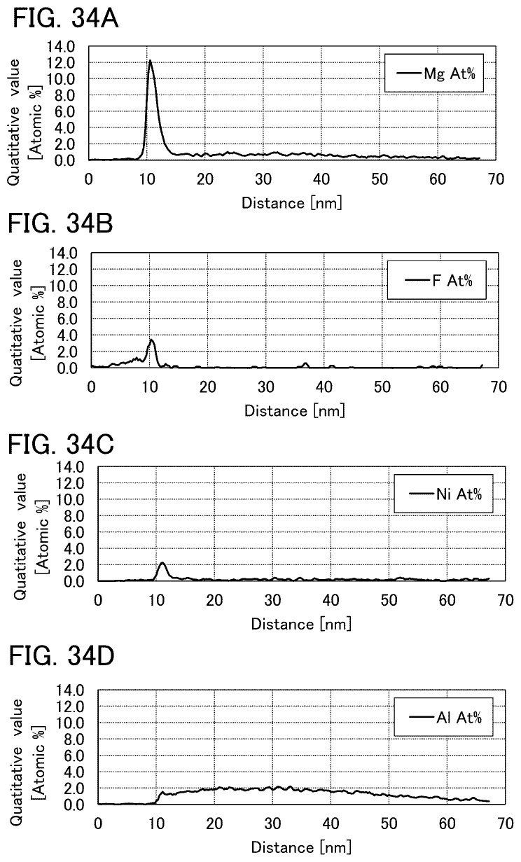

FIG. 34A is a graph of magnesium (Mg At %) extracted from FIG. 32B; FIG. 34B is a graph of fluorine (F At %) extracted from FIG. 32B; FIG. 34C is graph of nickel (Ni At %) extracted from FIG. 32B, and FIG. 34D is a graph of aluminum (Al At %) extracted from FIG. 32B.

Table 4 shows the local maximum values of the concentrations of the additive elements and the positions thereof obtained from the STEM-EDX analysis results shown in FIGS. 27A to 34B.

Note that the calculation of quantitative values as atomic % in the above-described graphs and Table 4 are made assuming that the sum of the detected amounts of carbon, oxygen, fluorine, magnesium, aluminum, silicon, phosphorus, sulfur, calcium, titanium, iron, cobalt, nickel, and gallium is 100%.

TABLE 4

| | Mg | | F | | Ni | | Al | |
|---|---|---|---|---|---|---|---|---|
| | Detected | | Detected | | Detected | | Detected | |
| | amount | Position | amount | Position | amount | Position | amount | Position |
| | (atomic %) | (nm) | (atomic %) | (nm) | (atomic %) | (nm) | (atomic %) | (nm) |
| Sample 4 | 9.2 | 10.81 | 1.6 | 10.25 | 2.0 | 10.81 | 2.2 | 17.19 |
| Sample 5 | 12.3 | 10.57 | 3.4 | 10.29 | 2.3 | 11.12 | 2.2 | 33.05 |

From the comparison between Sample 4 and Sample 5, it is found that Sample 4 exhibits a smaller local maximum value of the detected amount of magnesium and a smaller local maximum value of the detected amount of fluorine than Sample 5. The local maximum value of the detected amount of magnesium in Sample 4 was lower than or equal to 10.0 atomic %, and the local maximum value of the detected amount of fluorine in Sample 4 was lower than or equal to 2.0 atomic %. Although not shown, the characteristic X-ray of titanium was not observed in the energy spectrum of EDX; thus, the amount of titanium was lower than the lower detection limit (lower than 0.3 atomic %) in Sample 4 and Sample 5.

### Example 2

In Example 2, discharge rate tests and charge and discharge cycle tests were performed on Sample 1 to Sample 6 formed in Example 1.

### <Formation of Positive Electrode>

Sample 1 to Sample 6 described above, acetylene black (AB), and poly(vinylidene fluoride) (PVDF) were prepared as a positive electrode active material, a conductive material, and a binding agent, respectively. The PVDF prepared was one dissolved in N-methyl-2-pyrrolidone (NMP) at a weight ratio of 5%. Then, the positive electrode active material, AB, and PVDF were mixed at a weight ratio of 96:2:2 to form a slurry (this mixing was performed for each of the above positive electrode active materials), and the slurry was applied on an aluminum positive electrode current collector. As a solvent of the slurry, NMP was used. After the application of the slurry on the positive electrode current collector, the solvent was volatilized.

After that, pressing was performed with a roller press machine to increase the density of a positive electrode active material layer over the positive electrode current collector. The conditions of the pressing were as follows: the first pressing (linear pressure: 210 kN/m) was followed by the second pressing (linear pressure: 1467 kN/m). Note that the temperature of each of an upper roll and a lower roll of the roller press machine was 120° C.

Through the above steps, the positive electrode was obtained. The loading amount of the positive electrode active material per area of the positive electrode was greater than or equal to 14 mg/cm² and less than or equal to 15 mg/cm². By such a formation method, a positive electrode containing Sample 1, a positive electrode containing Sample 2, a positive electrode containing Sample 3, a positive electrode containing Sample 4, a positive electrode containing Sample 5, and a positive electrode containing Sample 6 were formed.

### <Fabrication of Half Cell>

A coin-type half cell was fabricated using the above positive electrode, lithium metal foil, a separator, an electrolyte, a coin cell positive electrode can, and a coin cell negative electrode can. The shape of the coin-type half cell was CR2032 type (with a diameter of 20 mm and a height of 3.2 mm).

As the electrolyte, a mixture of ethylene carbonate (EC) and diethyl carbonate (DEC) at a volume ratio of 3:7 to which vinylene carbonate (VC) was added as an additive at 2 wt % was used. As an electrolyte contained in the electrolyte solution, 1 mol/L lithium hexafluorophosphate (LiPF₆) was used.

As the separator, a porous polypropylene film was used.

In this manner, a half cell including a positive electrode containing Sample 1, a half cell including a positive electrode containing Sample 2, a half cell including a positive electrode containing Sample 3, a half cell including a positive electrode containing Sample 4, a half cell including a positive electrode containing Sample 5, and a half cell including a positive electrode containing Sample 6 were fabricated.

### <Discharge Rate Test>

A discharge rate test was performed using the half cells containing the respective samples.

The conditions of the discharge rate test are described. In the first charge and discharge cycle, constant current charging at 0.2 C was performed up to approximately 4.6 V, constant voltage charging was performed until the current value reached 0.05 C, and then, constant current discharging at 0.2 C was performed up to 3.0 V. In the second charge and discharge cycle, constant current charging at 0.5 C was performed up to approximately 4.6 V, constant voltage charging was performed until the current value reached 0.05 C, and then, constant current discharging at 0.1 C was performed up to 3.0 V. In the third charge and discharge cycle, constant current charging at 0.5 C was performed up to approximately 4.6 V, constant voltage charging was performed until the current value reached 0.05 C, and then, constant current discharging at 1.0 C was performed up to 3.0 V. In the fourth charge and discharge cycle, constant current charging at 0.5 C was performed up to approximately 4.6 V, constant voltage charging was performed until the current value reached 0.05 C, and then, constant current discharging at 2.0 C was performed up to 3.0 V. Note that here, 1 C was set to 200 mA/g. The temperature in the measurement environment was 25° C. The post-charging rest period from the completion of charging to the start of discharging and the post-discharging rest period from the completion of discharging to the start of charging were each 10 minutes.

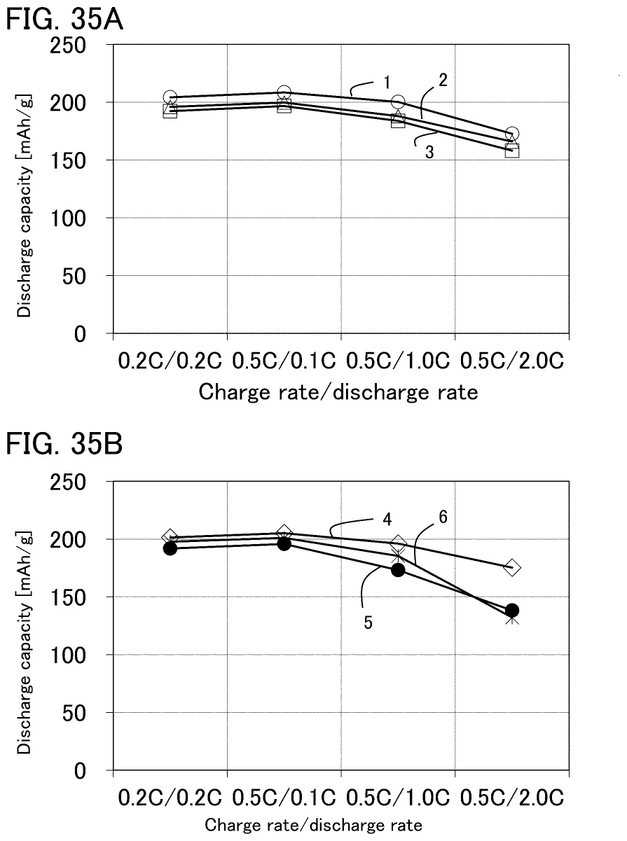

FIGS. 35A and 35B show results of the discharge rate test. FIG. 35A is a graph showing the measurement results of the half cell containing Sample 1, the half cell containing Sample 2, and the half cell containing Sample 3. FIG. 35B is a graph showing the measurement results of the half cell containing Sample 4, the half cell containing Sample 5, and the half cell containing Sample 6. In each graph, the horizontal axis represents the “charge rate/discharge rate” of the measurement conditions, and the vertical axis represents the discharge capacity under each measurement condition. Note that the discharge capacity is a value obtained by dividing the discharge capacity of each half cell by the weight of the positive electrode active material contained in the corresponding half cell.

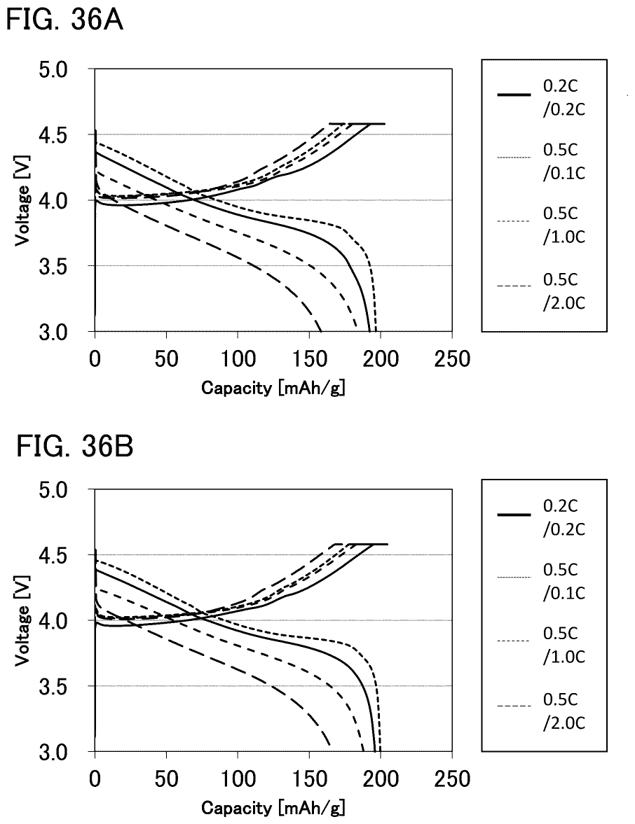

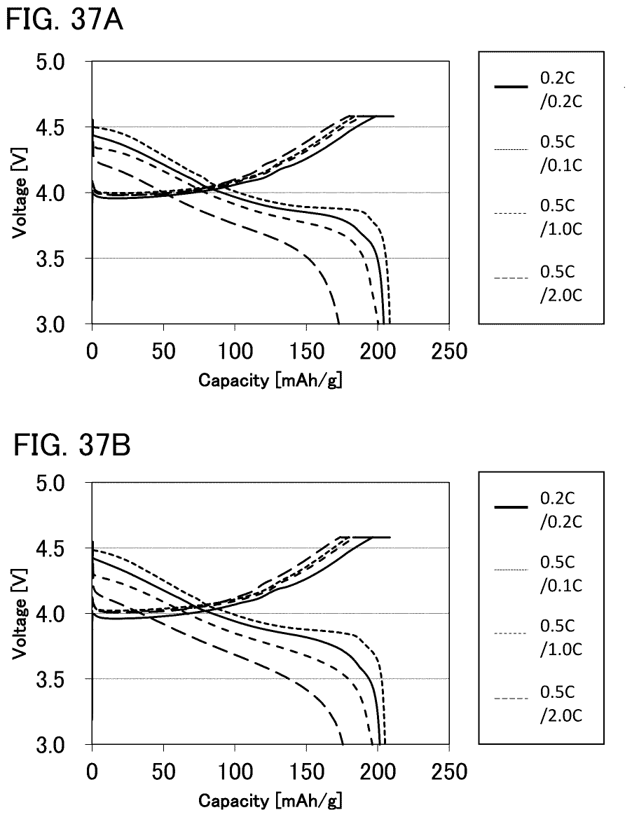

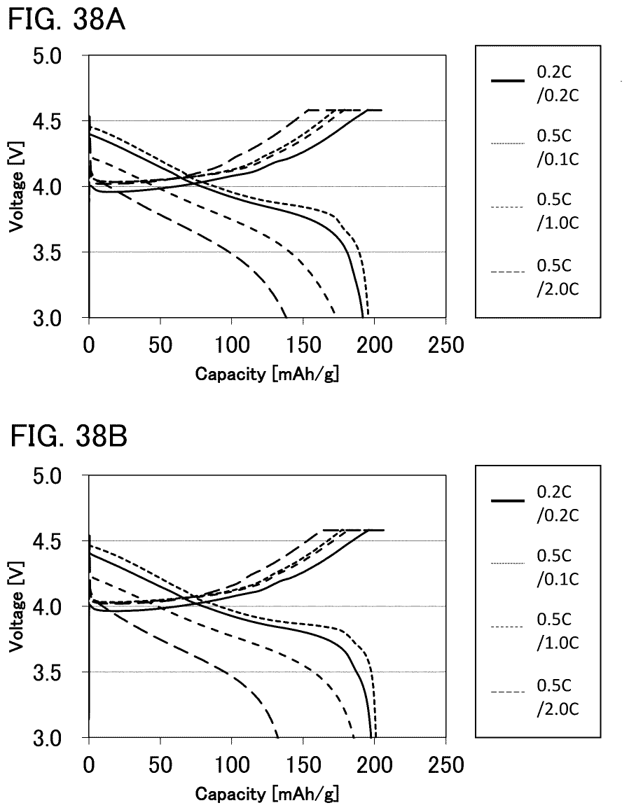

FIGS. 36A to 38B each show charge curves and discharge curves obtained from the discharge rate test. FIG. 36A shows the measurement results of the half cell containing Sample 1, FIG. 36B shows the measurement results of the half cell containing Sample 2, FIG. 37A shows the measurement results of the half cell containing Sample 3, FIG. 37B shows the measurement results of the half cell containing Sample 4, FIG. 38A shows the measurement results of the half cell containing Sample 5, and FIG. 38B shows the measurement results of the half cell containing Sample 6.

Table 5 summarizes the measurement results shown in FIG. 35A to FIG. 38B. Table 5 shows the discharge capacity value under each measurement condition and the proportion of the discharge capacity under each measurement condition assuming the discharge capacity value as being 100 under the condition of a charge rate of 0.5 C and a discharge rate of 0.1 C (0.5 C/0.1 C).

TABLE 5

| | 0.2 C/0.2 C | 0.5 C/0.1 C | 0.5 C/1.0 C | 0.5 C/2.0 C |
|---|---|---|---|---|
| Sample 1 | 192.2 mAh/g | 196.7 mAh/g | 183.8 mAh/g | 158.0 mAh/g |
| | 97.8% | 100.0% | 93.4% | 80.4% |
| Sample 2 | 196.0 mAh/g | 199.7 mAh/g | 187.9 mAh/g | 165.9 mAh/g |
| | 98.1% | 100.0% | 94.1% | 83.1% |
| Sample 3 | 204.2 mAh/g | 208.4 mAh/g | 200.2 mAh/g | 172.7 mAh/g |
| | 98.0% | 100.0% | 96.1% | 82.9% |
| Sample 4 | 201.4 mAh/g | 205.1 mAh/g | 196.1 mAh/g | 175.3 mAh/g |
| | 98.2% | 100.0% | 95.6% | 85.5% |
| Sample 5 | 191.8 mAh/g | 195.7 mAh/g | 173.2 mAh/g | 138.2 mAh/g |
| | 98.0% | 100.0% | 88.5% | 70.6% |
| Sample 6 | 197.6 mAh/g | 201.0 mAh/g | 185.4 mAh/g | 132.1 mAh/g |
| | 98.3% | 100.0% | 92.2% | 65.7% |

According to the discharge rate test results, Sample 1, Sample 2, Sample 3, and Sample 4 each subjected to the initial heating after the step of mixing lithium fluoride exhibit better characteristics than Sample 5 and Sample 6 each subjected to the initial heating without the step of mixing lithium fluoride. In particular, Sample 3 and Sample 4 subjected to the initial heating at 900° C. after the step of mixing lithium fluoride exhibit much preferable discharge capacity under the condition of “0.5 C/2.0 C” and enable discharge capacity exceeding 170 mAh/g.

### <Charge and Discharge Cycle Test>

Charge and discharge cycle tests were performed using the half cells containing Sample 1 to Sample 6 fabricated in the above manner.

The conditions of the charge and discharge cycle tests were as follows. In the charging, constant current charging at 0.5 C was performed up to approximately 4.6 V and then, constant voltage charging was performed until the current value reached 0.05 C. In the discharging, constant current discharging at 1 C was performed up to 3.0 V. Note that here, 1 C was set to 200 mA/g. The temperature in the measurement environment was 45° C. The post-charging rest period from the completion of charging to the start of discharging and the post-discharging rest period from the completion of discharging to the start of charging were each 10 minutes. Note that the termination conditions of each of the charging and discharging include a termination time of 20 hours in addition to the above-described voltage and current values.

Note that in each charge and discharge cycle, the resistance DCIR was measured at the start of discharging. In the measurement, discharging is performed at a current of 6 mA/g per weight of the positive electrode active material for 1 second, and the resistance DCIR can be calculated by dividing a difference between the open circuit voltage before the discharging and the voltage during the discharging by the above current (6 mA/g).

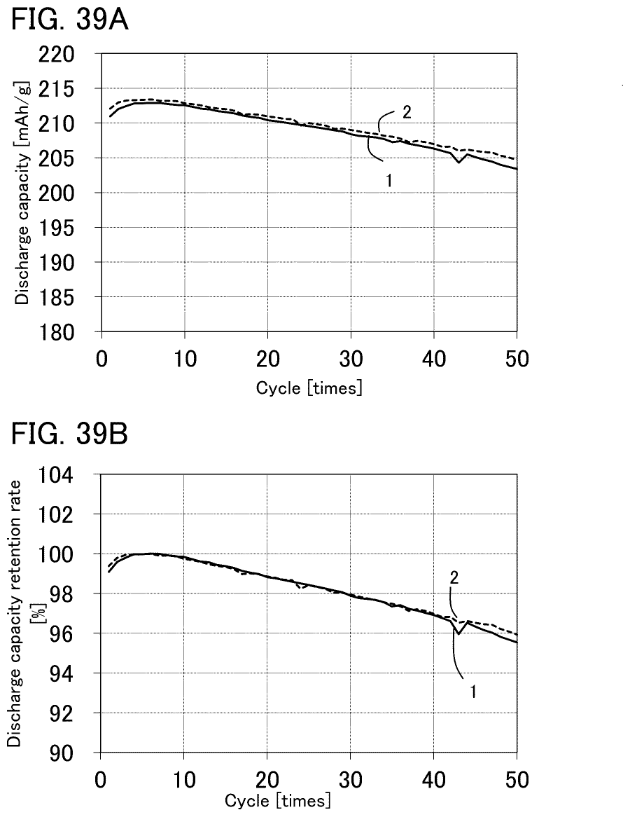

FIGS. 39A to 45B show results of the charge and discharge cycle test.

FIG. 39A is a graph showing the results of the charge and discharge cycle tests conducted on the half cell containing Sample 1 and the half cell containing Sample 2, where the horizontal axis represents the number of repetition of charging and discharging (the number of cycles) and the vertical axis represents the discharge capacity in each cycle. FIG. 39B is a graph whose vertical axis represents values on the vertical axis in FIG. 39A as the rate, assuming the maximum discharge capacity in the charge and discharge cycle for each half cell as being 100%.

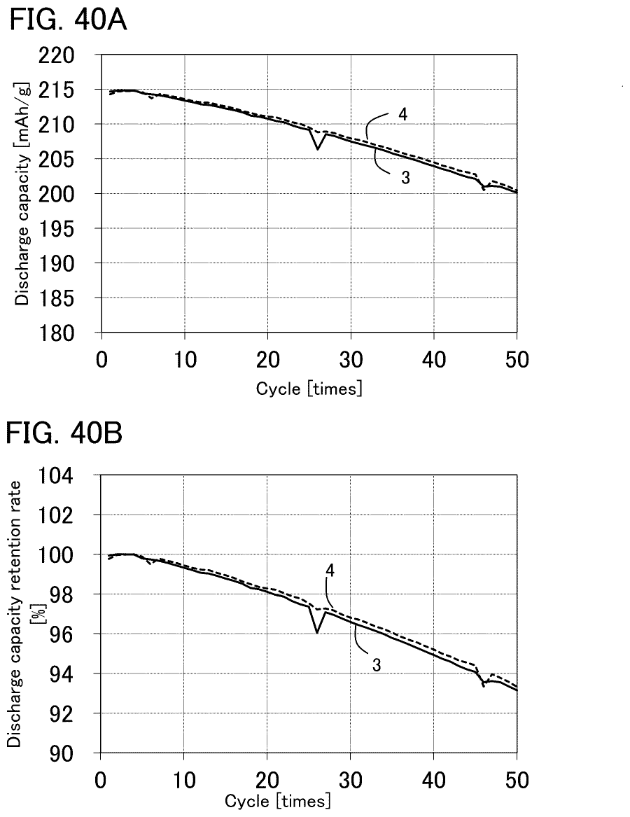

FIG. 40A is a graph showing the results of the charge and discharge cycle tests conducted on the half cell containing Sample 3 and the half cell containing Sample 4, where the horizontal axis represents the number of repetition of charging and discharging (the number of cycles) and the vertical axis represents the discharge capacity in each cycle. FIG. 40B is a graph whose vertical axis represents values on the vertical axis in FIG. 40A as the rate, assuming the maximum discharge capacity in the charge and discharge cycle for each half cell as being 100%.

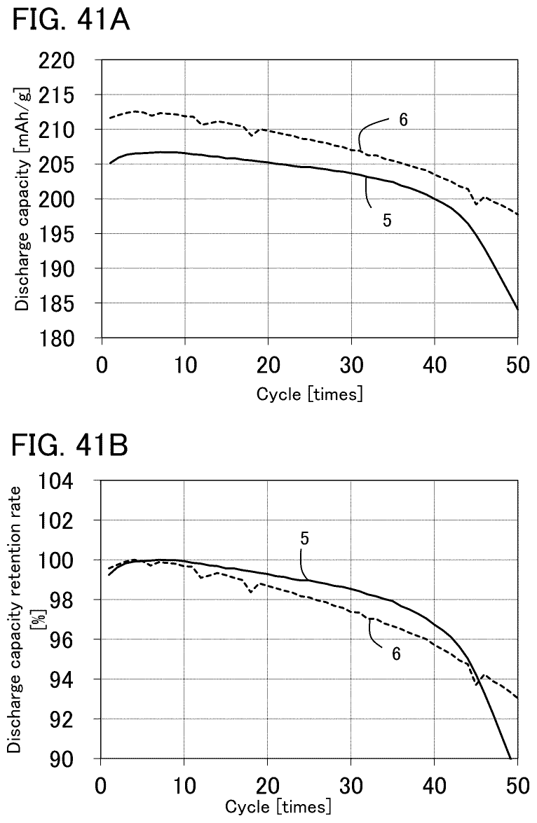

FIG. 41A is a graph showing the results of the charge and discharge cycle tests conducted on the half cell containing Sample 5 and the half cell containing Sample 6, where the horizontal axis represents the number of repetition of charging and discharging (the number of cycles) and the vertical axis represents the discharge capacity in each cycle. FIG. 41B is a graph whose vertical axis represents values on the vertical axis in FIG. 41A as the rate, assuming the maximum discharge capacity in the charge and discharge cycle for each half cell as being 100%.

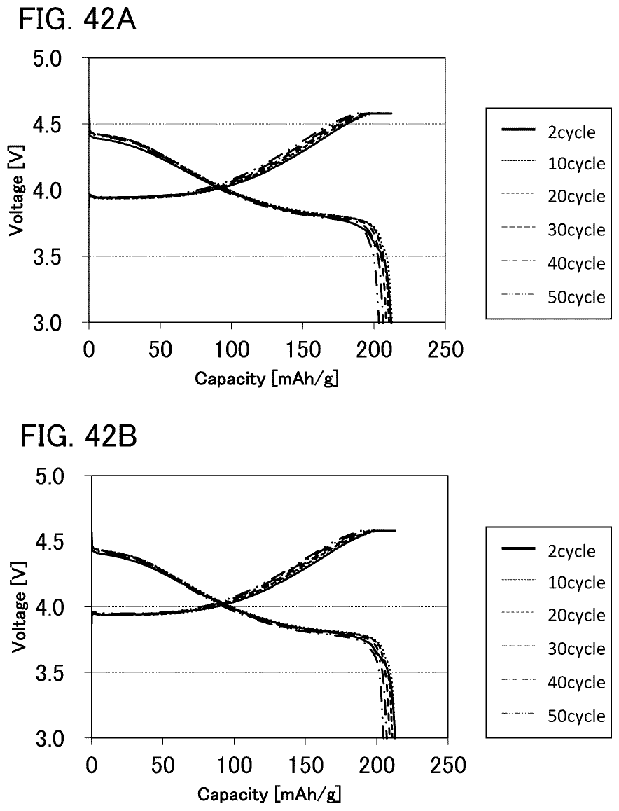

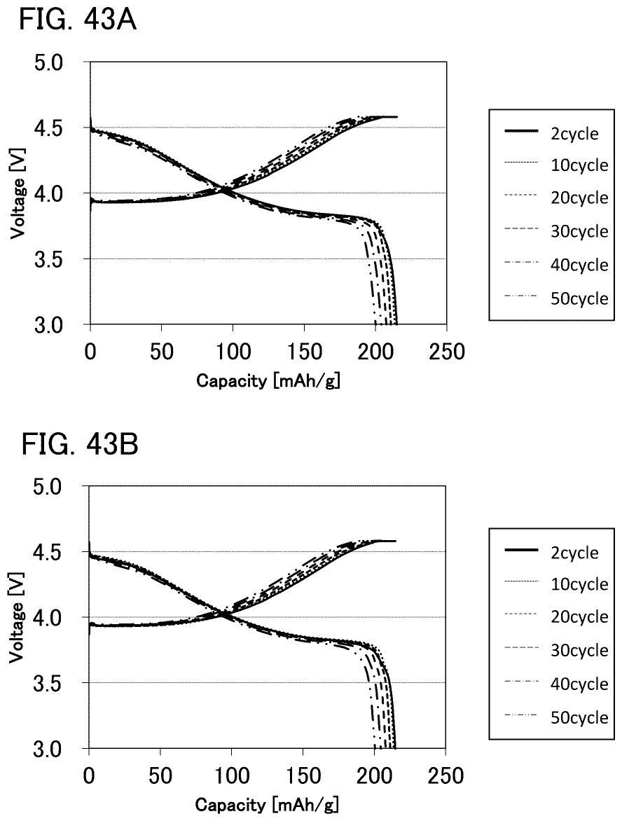

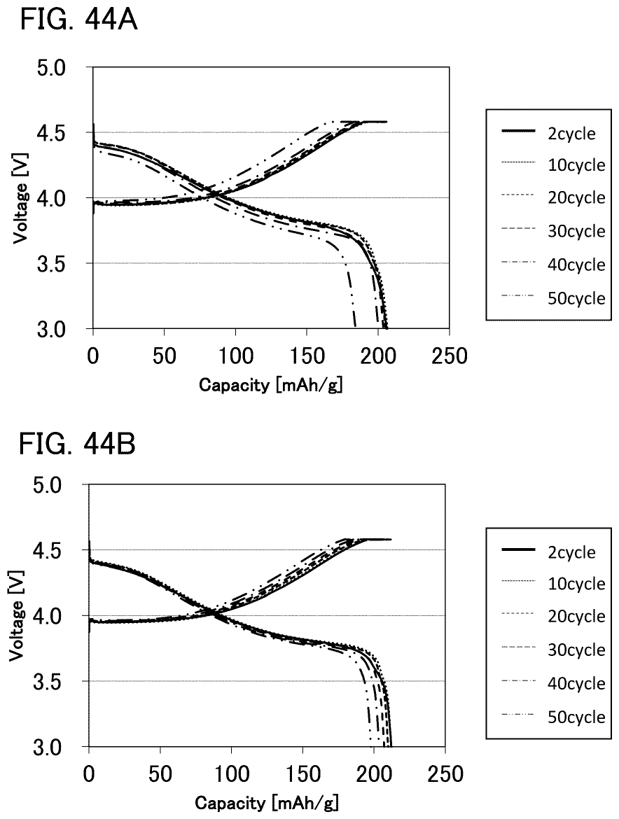

FIGS. 42A to 44B each show charge curves and discharge curves obtained from the charge and discharge cycle tests. FIG. 42A shows the measurement results of the half cell containing Sample 1, FIG. 42B shows the measurement results of the half cell containing Sample 2, FIG. 43A shows the measurement results of the half cell containing Sample 3, FIG. 43B shows the measurement results of the half cell containing Sample 4, FIG. 44A shows the measurement results of the half cell containing Sample 5, and FIG. 44B shows the measurement results of the half cell containing Sample 5.

Table 6 to Table 8 summarize the results of the charge and discharge cycle tests shown in FIGS. 39A to 44B.

TABLE 6

| | Sample 1 | | Sample 2 | |
|---|---|---|---|---|
| | | Discharge | | Discharge |
| | Discharge | capacity | Discharge | capacity |
| | capacity | retention rate | capacity | retention rate |
| Maximum | 212.9 mAh/g | 100.0% | 213.4 mAh/g | 100.0% |
| value | | | | |
| 1st cycle | 210.9 mAh/g | 99.1% | 212.1 mAh/g | 99.4% |
| 2nd cycle | 212.0 mAh/g | 99.6% | 212.9 mAh/g | 99.8% |
| 5th cycle | 212.8 mAh/g | 100.0% | 213.3 mAh/g | 100.0% |
| 10th cycle | 212.6 mAh/g | 99.8% | 212.8 mAh/g | 99.7% |
| 20th cycle | 210.4 mAh/g | 98.8% | 210.9 mAh/g | 98.9% |
| 25th cycle | 209.5 mAh/g | 98.4% | 210.0 mAh/g | 98.4% |
| 30th cycle | 208.4 mAh/g | 97.9% | 209.0 mAh/g | 97.9% |
| 40th cycle | 206.3 mAh/g | 96.9% | 206.9 mAh/g | 97.0% |
| 50th cycle | 203.4 mAh/g | 95.5% | 204.7 mAh/g | 95.9% |

TABLE 7

| | Sample 3 | | Sample 4 | |
|---|---|---|---|---|
| | | Discharge | | Discharge |
| | Discharge | capacity | Discharge | capacity |
| | cpacity | retention rate | capacity | retention rate |
| Maximum | 214.8 mAh/g | 100.0% | 214.8 mAh/g | 100.0% |
| value | | | | |
| 1st cycle | 214.7 mAh/g | 99.9% | 214.3 mAh/g | 99.8% |
| 2nd cycle | 214.8 mAh/g | 100.0% | 214.7 mAh/g | 100.0% |
| 5th cycle | 214.4 mAh/g | 99.8% | 214.5 mAh/g | 99.9% |
| 10th cycle | 213.4 mAh/g | 99.3% | 213.6 mAh/g | 99.4% |
| 20th cycle | 210.8 mAh/g | 98.1% | 211.0 mAh/g | 98.3% |
| 25th cycle | 209.1 mAh/g | 97.4% | 209.5 mAh/g | 97.5% |
| 30th cycle | 207.5 mAh/g | 96.6% | 207.9 mAh/g | 96.8% |
| 40th cycle | 203.9 mAh/g | 94.9% | 204.5 mAh/g | 95.2% |
| 50th cycle | 200.1 mAh/g | 93.1% | 200.4 mAh/g | 93.3% |

TABLE 8

| | Sample 5 | | Sample 6 | |
|---|---|---|---|---|
| | | Discharge | | Discharge |
| | Discharge | capacity | Discharge | capacity |
| | capacity | retention rate | capacity | retention rate |
| Maximum | 206.7 mAh/g | 100.0% | 212.6 mAh/g | 100.0% |
| value | | | | |
| 1st cycle | 205.1 mAh/g | 99.2% | 211.6 mAh/g | 99.6% |
| 2nd cycle | 205.9 mAh/g | 99.6% | 212.0 mAh/g | 99.8% |
| 5th cycle | 206.6 mAh/g | 99.9% | 212.4 mAh/g | 99.9% |
| 10th cycle | 206.6 mAh/g | 99.9% | 211.9 mAh/g | 99.7% |
| 20th cycle | 205.2 mAh/g | 99.3% | 209.8 mAh/g | 98.7% |
| 25th cycle | 204.6 mAh/g | 99.0% | 208.5 mAh/g | 98.1% |
| 30th cycle | 203.7 mAh/g | 98.5% | 207.0 mAh/g | 97.4% |
| 40th cycle | 200.0 mAh/g | 96.7% | 203.5 mAh/g | 95.7% |
| 50th cycle | 184.1 mAh/g | 89.1% | 197.7 mAh/g | 93.0% |

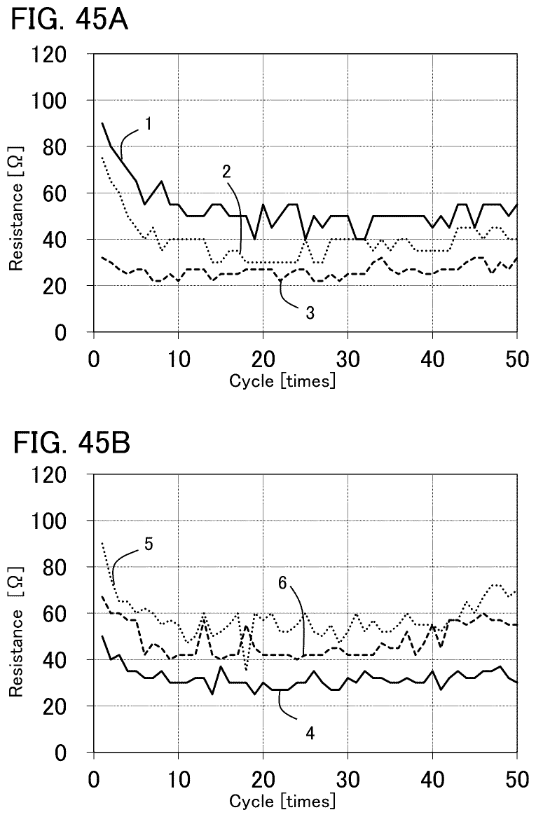

FIG. 45A and FIG. 45B show resistance DCIR measured at the start of discharging in each cycle in the charge and discharge cycle tests.

FIG. 45A is a graph showing the measurement results of the half cell containing Sample 1, the half cell containing Sample 2, and the half cell containing Sample 3. FIG. 45B is a graph showing the measurement results of the half cell containing Sample 4, the half cell containing Sample 5, and the half cell containing Sample 6. In each graph, the horizontal axis represents the number of repetition of charging and discharging (the number of cycles), and the vertical axis represents the resistance DCIR in each cycle. Table 9 to Table 11 summarize the measurement results of the resistance DCIR shown in FIGS. 45A and 45B. Table 9 to Table 11 also show the open circuit voltages of the half cells just before the measurement of the resistance DCIR.

TABLE 9

| | Sample 1 | | | Sample 2 | | |
|---|---|---|---|---|---|---|
| | Open circuit | Rersistance | Proportion to | Open circuit | Rersistance | Proportion to |
| | voltage | (DCIR) | 1st cycle | voltage | (DCIR) | 1st cycle |
| 1st cycle | 4.56 V | 90 Ω | 100.0% | 4.56 V | 75 Ω | 100.0% |
| 2nd cycle | 4.56 V | 80 Ω | 88.9% | 4.56 V | 65 Ω | 86.7% |
| 5th cycle | 4.56 V | 65 Ω | 72.2% | 4.57 V | 45 Ω | 60.0% |
| 10th cycle | 4.57 V | 55 Ω | 61.1% | 4.57 V | 40 Ω | 53.3% |
| 20th cycle | 4.57 V | 55 Ω | 61.1% | 4.57 V | 30 Ω | 40.0% |
| 25th cycle | 4.57 V | 40 Ω | 44.4% | 4.57 V | 40 Ω | 53.3% |
| 30th cycle | 4.57 V | 50 Ω | 55.6% | 4.57 V | 40 Ω | 53.3% |
| 40th cycle | 4.57 V | 45 Ω | 50.0% | 4.57 V | 35 Ω | 46.7% |
| 50th cycle | 4.57 V | 55 Ω | 61.1% | 4.57 V | 40 Ω | 53.3% |

TABLE 10

| | Sample 3 | | | Sample 4 | | |
|---|---|---|---|---|---|---|
| | Open circuit | Rersistance | Proportion to | Open circuit | Rersistance | Proportion to |
| | voltage | (DCIR) | 1st cycle | voltage | (DCIR) | 1st cycle |
| 1st cycle | 4.57 V | 32 Ω | 100.0% | 4.57 V | 50 Ω | 100.0% |
| 2nd cycle | 4.57 V | 30 Ω | 93.8% | 4.57 V | 40 Ω | 80.0% |
| 5th cycle | 4.57 V | 27 Ω | 84.4% | 4.57 V | 35 Ω | 70.0% |
| 10th cycle | 4.57 V | 22 Ω | 68.8% | 4.57 V | 30 Ω | 60.0% |
| 20th cycle | 4.57 V | 27 Ω | 84.4% | 4.57 V | 30 Ω | 60.0% |
| 25th cycle | 4.57 V | 27 Ω | 84.4% | 4.57 V | 30 Ω | 60.0% |
| 30th cycle | 4.57 V | 25 Ω | 78.1% | 4.57 V | 32 Ω | 64.0% |
| 40th cycle | 4.57 V | 25 Ω | 78.1% | 4.57 V | 35 Ω | 70.0% |
| 50th cycle | 4.57 V | 32 Ω | 100.0% | 4.57 V | 30 Ω | 60.0% |

TABLE 11

| | Sample 5 | | | Sample 6 | | |
|---|---|---|---|---|---|---|
| | Open circuit | Rersistance | Proportion to | Open circuit | Rersistance | Proportion to |
| | voltage | (DCIR) | 1st cycle | voltage | (DCIR) | 1st cycle |
| 1st cycle | 4.56 V | 90 Ω | 100.0% | 4.56 V | 67 Ω | 100.0% |
| 2nd cycle | 4.56 V | 75 Ω | 83.3% | 4.56 V | 60 Ω | 89.6% |
| 5th cycle | 4.56 V | 60 Ω | 66.7% | 4.56 V | 57 Ω | 85.1% |
| 10th cycle | 4.56 V | 55 Ω | 61.1% | 4.57 V | 42 Ω | 62.7% |
| 20th cycle | 4.56 V | 57 Ω | 63.3% | 4.57 V | 42 Ω | 62.7% |
| 25th cycle | 4.56 V | 60 Ω | 66.7% | 4.57 V | 42 Ω | 62.7% |
| 30th cycle | 4.56 V | 52 Ω | 57.8% | 4.56 V | 42 Ω | 62.7% |
| 40th cycle | 4.56 V | 55 Ω | 61.1% | 4.56 V | 55 Ω | 82.1% |
| 50th cycle | 4.56 V | 70 Ω | 77.8% | 4.56 V | 55 Ω | 82.1% |

From the comparison of the resistance DCIR measurement results on Sample 1 to Sample 6 subjected to the above charge and discharge cycle test, it is revealed that Sample 3 and Sample 4 exhibit a tendency of smaller resistance DCIR than the other samples.

### Example 3

In Example 3, XPS analysis and charge and discharge cycle tests were performed using Sample 2 and Sample 4 formed in Example 1 and Sample 7 to Sample 9 formed in this example.

### <Sample 7>

Sample 7 was formed in a manner similar to that of Sample 2 formed in Example 1 except that the heating temperature in Step S17 was changed to 875° C.

### <Sample 8>

Sample 8 was formed in a manner similar to that of Sample 2 formed in Example 1 except that the heating temperature in Step S17 was changed to 925° C.

### <Sample 9>

Sample 9 was formed in a manner similar to that of Sample 2 formed in Example 1 except that the heating temperature in Step S17 was changed to 950° C.

The formation conditions of the samples are shown in Table 12. Note that “mol %” in Table 12 represents the proportion of the number of moles of the additive element to that of LiCoO₂. As can be seen from Table 12, the object of this example is to examine the influence of the heating temperature in Step S17 on the positive electrode active material. Another object of this example is to obtain a positive electrode active material having better battery characteristics by being formed through Step S17 under a preferable heating temperature condition that is higher than or equal to 900° C. and lower than or equal to 950° C.

TABLE 12

| | Initial heating | | A1 source | | A2 source | |
|---|---|---|---|---|---|---|
| | Second | | | Additive | | Additive |
| | lithium source | Temperature | Material | amount | Material | amount |
| Sample 2 | LiF | 850° C. | LiF + MgF₂ | 0.33 mol % + | Ni(OH)₂ + | 0.5 mol % + |
| | | | | 1.0 mol % | Al(OH)₃ | 0.5 mol % |
| Sample 4 | LiF | 900° C. | LIF + MgF₂ | 0.33 mol % + | Ni(OH)₂ + | 0.5 mol % + |
| | | | | 1.0 mol % | Al(OH)₃ | 0.5 mol % |
| Sample 7 | LiF | 875° C. | LiF + MgF₂ | 0.33 mol % + | Ni (OH)₂ + | 0.5 mol % + |
| | | | | 1.0 mol % | Al(OH)₃ | 0.5 mol % |
| Sample 8 | LiF | 925° C. | LiF + MgF₂ | 0.33 mol % + | Ni(OH)₂ + | 0.5 mol % + |
| | | | | 1.0 mol % | Al(OH)₃ | 0.5 mol % |
| Sample 9 | LiF | 950° C. | LiF + MgF₂ | 0.33 mol % + | Ni(OH)₂ + | 0.5 mol % + |
| | | | | 1.0 mol % | Al(OH)₃ | 0.5 mol % |

### <XPS Analysis>

XPS analysis was performed on the particle surfaces of Sample 2, Sample 4, Sample 7, Sample 8, and Sample 9 prepared in the above manner. The apparatus and conditions used in the XPS measurement were as follows.
Measurement apparatus: Quantera II by ULVAC-PHI, Inc.
X-ray source: monochromatic Al Kα (1486.6 eV)
   Detection area: 100 μmϕ
   Angle of detector: 45°
   Measurement spectrum: wide scan, narrow scan of each detected element

The XPS analysis results are shown in Table 13 and Table 14.

TABLE 13

| | Li | Co | Ti | O | C | F | S | Ca | Mg |
|---|---|---|---|---|---|---|---|---|---|
| Sample 2 | 9.6 at % | 13.2 at % | — | 46.0 at % | 6.2 at % | 7.8 at % | 0.9 at % | 0.5 at % | 13.0 at % |
| Sample 7 | 10.5 at % | 12.7 at % | — | 45.5 at % | 5.2 at % | 8.3 at % | 1.5 at % | 0.6 at % | 12.8 at % |
| Sample 4 | 10.4 at % | 15.9 at % | — | 50.9 at % | 8.0 at % | 1.5 at % | 0.9 at % | 0.7 at % | 8.8 at % |
| Sample 8 | 11.4 at % | 15.8 at % | — | 50.2 at % | 6.0 at % | 1.7 at % | 1.2 at % | 0.8 at % | 9.6 at % |
| Sample 9 | 11.1 at % | 16.4 at % | — | 50.7 at % | 5.8 at % | 1.2 at % | 1.1 at % | 0.8 at % | 9.4 at % |

| | Na | Zr | Ni | Si | Al | Mg/Co | Ni/Co | Al/Co | F/Mg |
|---|---|---|---|---|---|---|---|---|---|
| Sample 2 | 0.6 at % | — | 1.2 at % | 0.4 at % | 0.7 at % | 0.98 | 0.09 | 0.05 | 0.60 |
| Sample 7 | 0.8 at % | — | 1.0 at % | 0.4 at % | 0.6 at % | 1.01 | 0.08 | 0.05 | 0.65 |
| Sample 4 | 0.9 at % | — | 1.1 at % | 0.4 at % | 0.5 at % | 0.55 | 0.07 | 0.03 | 0.17 |
| Sample 8 | 0.9 at % | — | 1.0 at % | 0.8 at % | 0.6 at % | 0.61 | 0.06 | 0.04 | 0.18 |
| Sample 9 | 1.0 at % | — | 1.1 at % | 0.8 at % | 0.6 at % | 0.57 | 0.07 | 0.04 | 0.13 |

Table 13 shows the concentrations (atomic number concentration: at %) of lithium (Li), cobalt (Co), titanium (Ti), oxygen (O), carbon (C), fluorine (F), sulfur(S), calcium (Ca), magnesium (Mg), sodium (Na), zirconium (Zr), nickel (Ni), silicon (Si), and aluminum (Al) assuming that the total concentrations of the elements is 100 at %.

TABLE 14

| | Li | Co | Ti | O | C | F | S | Ca | Mg |
|---|---|---|---|---|---|---|---|---|---|
| Sample 2 | | 14.6 at % | — | 50.8 at % | 6.9 at % | 8.6 at % | 1.0 at % | 0.6 at % | 14.4 at % |
| Sample 7 | | 14.2 at % | — | 50.9 at % | 5.8 at % | 9.3 at % | 1.7 at % | 0.7 at % | 14.3 at % |
| Sample 4 | | 17.7 at % | — | 56.8 at % | 8.9 at % | 1.7 at % | 1.0 at % | 0.8 at % | 9.8 at % |
| Sample 8 | | 17.8 at % | — | 56.7 at % | 6.8 at % | 1.9 at % | 1.4 at % | 0.9 at % | 10.8 at % |
| Sample 9 | | 18.4 at % | — | 57.0 at % | 6.5 at % | 1.3 at % | 1.2 at % | 0.9 at % | 10.6 at % |

| | Na | Zr | Ni | Si | Al | Mg/Co | Ni/Co | Al/Co | F/Mg |
|---|---|---|---|---|---|---|---|---|---|
| Sample 2 | 0.7 at % | — | 1.3 at % | 0.4 at % | 0.8 at % | 0.98 | 0.09 | 0.05 | 0.60 |
| Sample 7 | 0.9 at % | — | 1.1 at % | 0.4 at % | 0.7 at % | 1.01 | 0.08 | 0.05 | 0.65 |
| Sample 4 | 1.0 at % | — | 1.2 at % | 0.4 at % | 0.6 at % | 0.55 | 0.07 | 0.03 | 0.17 |
| Sample 8 | 1.0 at % | — | 1.1 at % | 0.9 at % | 0.7 at % | 0.61 | 0.06 | 0.04 | 0.18 |
| Sample 9 | 1.1 at % | — | 1.2 at % | 0.9 at % | 0.7 at % | 0.57 | 0.07 | 0.04 | 0.13 |

Table 14 shows the concentration (at %) of cobalt (Co), titanium (Ti), oxygen (O), carbon (C), fluorine (F), sulfur(S), calcium (Ca), magnesium (Mg), sodium (Na), zirconium (Zr), nickel (Ni), silicon (Si), and aluminum (Al) assuming that the total concentration of the elements is 100 at %.

Table 13 and Table 14 each also show the concentration ratio of magnesium to cobalt (Mg/Co), the concentration ratio of nickel concentration to cobalt (Ni/Co), and the concentration ratio of aluminum to cobalt (Al/Co) when the cobalt concentration is assumed as 1. In addition, the concentration ratio of fluorine to magnesium (F/Mg) is shown, assuming the magnesium concentration is 1.

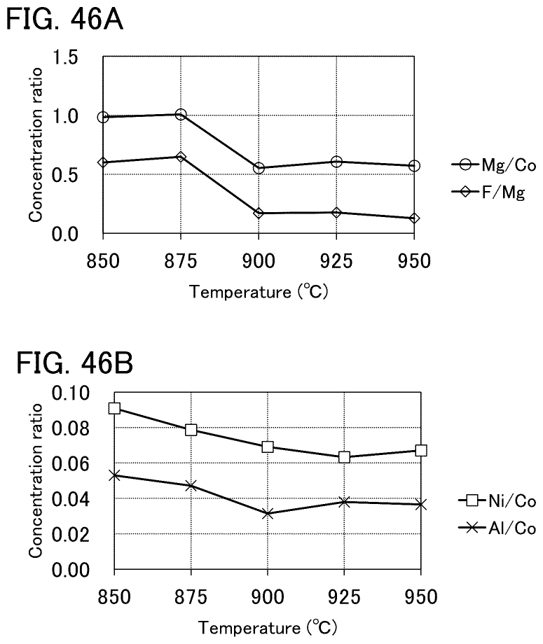

FIG. 46A is a graph showing values of the Mg/Co and F/Mg in Sample 2, Sample 4, Sample 7, Sample 8, and Sample 9. FIG. 46B is a graph showing values of the Ni/Co and Al/Co in Sample 2, Sample 4, Sample 7, Sample 8, and Sample 9. In each of FIGS. 46A and 46B, the horizontal axis represents heating temperature conditions in Step S17 for each sample.

As shown in FIG. 46A, the samples (Sample 4, Sample 8, and Sample 9) subjected to the heating in Step S17 at a temperature higher than or equal to 900° C. have a tendency of smaller values of the Mg/Co and F/Mg than those of the samples (Sample 2 and Sample 7) subjected to the heating in Step S17 at a temperature lower than 900° C. In addition, the samples subjected to the heating in Step S17 at a temperature higher than or equal to 900° C. exhibit the Mg/Co value greater than or equal to 0.50 and less than or equal to 0.70 and the F/Mg value greater than or equal to 0.10 and less than or equal to 0.20.

As shown in FIG. 46B, such a tendency that the value is decreased as the heating temperature in Step S17 is increased is observed for the Ni/Co value and the Al/Co value. Unlike the Mg/Co value and the F/Mg value, neither the Ni/Co value nor the Al/Co value exhibit a tendency of large change between the conditions of 875° C. and 900° C.

Next, in the XPS analysis, the Mg₁s peak on the XPS spectrum was focused. Assuming that the peak component derived from the O—Mg—O bond is a fit peak 1, that from the O—Mg—F bond is a fit peak 2, and that from the F—Mg—F bond is a fit peak 3 in the analysis of the Mg₁s peak, a ratio of these three fit peaks synthesized was calculated so that a difference from the Mg₁s peak on the XPS spectrum obtained by the XPS analysis is the smallest. Table 15 shows the analysis results on the assumption that the area ratio of the fit peak 1, the fit peak 2, and the fit peak 3 in this calculation is the existence ratio of the O—Mg—O bond, the O—Mg—F bond, and the F—Mg—F bond.

Note that in the analysis method of the XPS spectrum, for an energy value (Ep1) at the maximum value (also referred to as a peak top) of the fit peak 1, the energy value at the maximum value of the Mg₁s peak separately measured using a standard sample of LiCoO₂ coated with MgO was referred to. For an energy value (Ep3) at the maximum value of the fit peak 3, the energy value at the maximum value of the Mg₁s peak separately measured using a standard sample of magnesium fluoride (MgF₂) (MGH18XB with purity of 99.9% (3N) up by Kojundo Chemical Laboratory Co., Ltd.) was referred to. An energy value (Ep2) at the maximum value of the fit peak 2 was an intermediate value between Ep1 and Ep3. Note that the energy value at the maximum peak value is also referred to as a peak position.

On the XPS spectrum in the XPS analysis, the energy axis was corrected so that the maximum value of C1s peak was to be 284.8 eV.

TABLE 15

| | Initial heating | Mg1s analysis result | | | Peak | Peak |
|---|---|---|---|---|---|---|
| | temperature | O—Mg—O | O—Mg—F | F—Mg—F | position | half width |
| Sample 2 | 850° C. | 72.4% | 27.6% | 0.0% | 1304.5 eV | 3.0 eV |
| Sample 7 | 875° C. | 72.4% | 27.6% | 0.0% | 1304.5 eV | 2.9 eV |
| Sample 4 | 900° C. | 100.0% | 0.0% | 0.0% | 1304.0 eV | 2.6 eV |
| Sample 8 | 925° C. | 100.0% | 0.0% | 0.0% | 1304.0 eV | 2.6 eV |
| Sample 9 | 950° C. | 100.0% | 0.0% | 0.0% | 1304.0 eV | 2.5 eV |

Table 15 shows the heating temperature conditions in Step S17, the Mg1s analysis results in the XPS analysis, the peak positions of the Mg1s peaks, and the half width of the peaks, for Sample 2, Sample 4, Sample 7, Sample 8, and Sample 9.

According to Table 15 showing the XPS spectrum analysis on Sample 2, Sample 4, Sample 7, Sample 8, and Sample 9, it is found that the samples (Sample 2 and Sample 7) subjected to the heating in Step S17 at a temperature lower than 900° C. contain a peak component derived from the O—Mg—O bond and a peak component derived from the O—Mg—F bond and that the samples (Sample 4, Sample 8, and Sample 9) subjected to the heating in Step S17 at a temperature higher than or equal to 900° C. contain a peak component derived from the O—Mg—O bond. Note that even an analysis result of 0.0% in the table does not indicates that corresponding bonds are not present at all. That is, the bond whose analysis result is represented as 0.0% may exist although it is lower than the lower detection limit.

According to Table 15 showing the XPS spectrum analysis on Sample 2, Sample 4, Sample 7, Sample 8, and Sample 9, the half width of the Mg1s peak in each of the samples (Sample 2 and Sample 7) subjected to the heating in Step S17 at a temperature lower than 900° C. is greater than or equal to 2.9 eV and less than or equal to 3.0 eV whereas that in each of the samples (Sample 4, Sample 8, and Sample 9) subjected to the heating in Step S17 at a temperature higher than or equal to 900° C. is greater than or equal to 2.5 eV and less than or equal to 2.6 eV.

Thus, according to the XPS analysis results, the samples (Sample 4, Sample 8, and Sample 9) subjected to the heating in Step S17 at a temperature higher than or equal to 900° C. contained the peak component derived from the O—Mg—O bond at 100% assuming that the sum of the peak component derived from the O—Mg—O bond, the peak component derived from the O—Mg—F bond, and the peak component derived from the F—Mg—F bond is 100%. In addition, the samples (Sample 4, Sample 8, and Sample 9) subjected to the heating in Step S17 at a temperature higher than or equal to 900° C. each exhibited a narrower half width of the Mg1s peak, which is greater than or equal to 2.5 eV and less than or equal to 2.6 eV, than the samples (Sample 2 and Sample 7) subjected to the heating in Step S17 at a temperature lower than 900° C.

As described above, it is found that the samples (Sample 4, Sample 8, and Sample 9) subjected to the heating in Step S17 at a temperature higher than or equal to 900° C. satisfy the particularly preferable conditions described in Embodiment 1 (containing the peak component derived from the “O—Mg—O” bond at 100% and having a half width of the Mg₁s peak which is greater than or equal to 1.0 eV and less than or equal to 2.6 eV).

### <Formation of Positive Electrode>

Positive electrodes were formed using Sample 2, Sample 4, Sample 7, Sample 8, and Sample 9. Each positive electrode was formed by the same formation method as that in Example 2.

### <Fabrication of Half Cell>

Half cells including the positive electrode containing Sample 2, the positive electrode containing Sample 4, the positive electrode containing Sample 7, the positive electrode containing Sample 8, and the positive electrode containing Sample 9 were fabricated. The half cells were fabricated by the same fabrication method as that in Example 2. Note that the positive electrode active material loading amount of the positive electrode containing Sample 2 was 14.79 mg/cm², that of the positive electrode containing Sample 4 was 14.46 mg/cm², that of the positive electrode containing Sample 7 was 14.23 mg/cm², that of the positive electrode containing Sample 8 was 14.89 mg/cm², and that of the positive electrode containing Sample 9 was 14.25 mg/cm².

### <Discharge Rate Test>

A discharge rate test was performed using the half cells that were fabricated as described above.

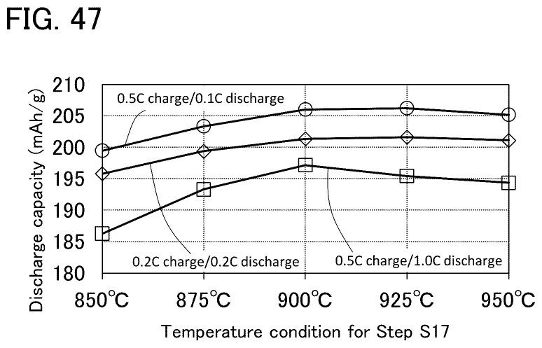

The discharge rate test was performed under the same conditions as those in Example 2. FIG. 47 shows results of the discharge rate test.

As shown in FIG. 47, the discharge capacity of the coin cell containing Sample 4 was higher than that of the coin cell containing Sample 7. That is, it was found that the discharge rate characteristics of the coin cell containing Sample 4 subjected to the heating in Step S17 at a temperature of 900° C. were higher than those of the coin cell containing Sample 7 subjected to the heating in Step S17 at a temperature of 875° C.

Also as shown in FIG. 47, the discharge capacity of the coin cells containing Sample 4, Sample 8, and Sample 9 was higher than that of the coin cells containing Sample 2 and Sample 7. That is, it was found that the discharge rate characteristics of the coin cells containing Sample 4, Sample 8, and Sample 9, subjected to the heating in Step S17 at a temperature higher than or equal to 900° C. and lower than or equal to 950° C., were higher than those of the coin cells containing Sample 2 and Sample 7, subjected to the heating in Step S17 at a temperature lower than 900° C. Since the coin cell containing Sample 4 subjected to the heating in Step S17 at a temperature of 900° C. exhibits the highest discharge rate characteristics, it can be said that the most preferable heating temperature in Step S17 is 900° C.

Thus, it can be considered that the tendency in the XPS analysis conducted in this example is compatible with the discharge rate characteristics. In other words, when the Mg/Co value is greater than or equal to 0.50 and less than or equal to 0.70 and the F/Mg value is greater than or equal to 0.10 and less than or equal to 0.20 in XPS analysis of a positive electrode active material, the use of such a positive electrode active material for a battery enables the discharge rate characteristics of the battery to be increased. Moreover, when a positive electrode active material satisfies the particularly preferable conditions described in Embodiment 1 (containing the peak component derived from the “O—Mg—O” bond at 100% and having a half width of the Mg₁s peak which is greater than or equal to 1.0 eV and less than or equal to 2.6 eV) in XPS analysis, the use of such a positive electrode active material for a battery enables the discharge rate characteristics of the battery to be increased.

After the discharge rate test, charging and discharging were performed under the conditions of the charge and discharge cycle test described in Example 2. Table 16 shows the resistance DCIR before the discharging in this case. Note that Table 16 also shows the open circuit voltages of the half cells just before the measurement of the resistance DCIR.

TABLE 16

| | |
|---|---|
| Sample 4 | Sample 7 |

| Open circuit | Resistance | Open circuit | Resistance |
|---|---|---|---|
| voltage | (DCIR) | voltage | (DCIR) |
| 4.57 V | 45 Ω | 4.56 V | 67 Ω |

As shown in Table 16, Sample 4 exhibits a smaller resistance DCIR than Sample 7 in the measurement results of the resistance DCIR, and the DCIR of Sample 4 is lower than or equal to 50Ω, specifically, 45Ω.

### Example 4

### <XRD Analysis in High-Voltage Charged State>

An experiment for examining a crystal structure of Sample 4 in a high-voltage charged state was conducted.

### <Formation of Positive Electrode>

Sample 4 described above, acetylene black (AB), and poly(vinylidene fluoride) (PVDF) were prepared as a positive electrode active material, a conductive material, and a binding agent, respectively. The PVDF prepared was one dissolved in N-methyl-2-pyrrolidone (NMP) at a weight ratio of 5%. Then, the positive electrode active material, AB, and PVDF were mixed at a weight ratio of 95:3:2 to form a slurry, and the slurry was applied on an aluminum positive electrode current collector. As a solvent of the slurry, NMP was used. After the application of the slurry on the positive electrode current collector, the solvent was volatilized. Note that in the formation of the positive electrode, pressing treatment after the slurry drying was not performed.

### <Fabrication of Half Cell>

Next, a half cell including a positive electrode containing Sample 4 was fabricated. The half cell was fabricated by the same fabrication method as that in Example 2. Note that the loading amount of the positive electrode active material of the positive electrode containing Sample 4 was 7 mg/cm².

Next, charging, discharging, disassembly of the half cell, and XRD measurement were performed using the fabricated half cell.

### <Charging and Discharging Before Measurement>

In the charging, constant current charging was performed at 0.2 C was performed until the voltage reached 4.50 V and then, constant voltage charging was performed until the current value reached 0.05 C. In the discharging, constant current discharging at 0.2 C was performed up to 3.0 V. Note that as in the other tests, 1 C was set to 200 mA/g per weight of the positive electrode active material.

Next, charging before the XRD analysis in a high-voltage charged state was performed. In the charging, constant current charging was performed at 0.2 C was performed until the voltage reached 4.60 V and then, constant voltage charging was performed until the current value reached 0.02 C.

### <Disassembly of Half Cell and XRD Measurement>

After that, the half cell was disassembled within an hour after the above charge was terminated. Specifically, the half cell in the charged state was disassembled carefully; the positive electrode was extracted as it is in the high-voltage charged state, by using an insulating tool to avoid a short circuit. For the disassembly, an argon-filled glove box in which the dew point and the oxygen concentration were controlled was used. Note that the dew point of the glove box is preferably lower than or equal to −70° C., and the oxygen concentration is preferably lower than or equal to 5 ppm. Since the crystal structure of the positive electrode active material might be changed by self-discharging after a long time elapses from the above charging, disassembly and analysis are preferably performed as early as possible.

The above-described positive electrode obtained by disassembling the half cell was set on an XRD measurement stage capable of being hermetically sealed in the glove box, thereby obtaining a positive electrode that was hermetically sealed in the XRD measurement stage together with argon.

After that, the XRD measurement was started within 15 minutes. The XRD apparatus and conditions are as follows.
XRD apparatus: D8 ADVANCE by Bruker AXS
X-ray: Cu Kα radiation
Output: 40 kV, 40 mA
Angle of divergence: Div. Slit, 0.5°
Detector: LynxEye
Scanning method: 2θ/θ continuous scan
Measurement range (2θ): from 15° to 75°
Step width (2θ): 0.01°
Counting time: one sec/step
Rotation of sample stage: 15 rpm

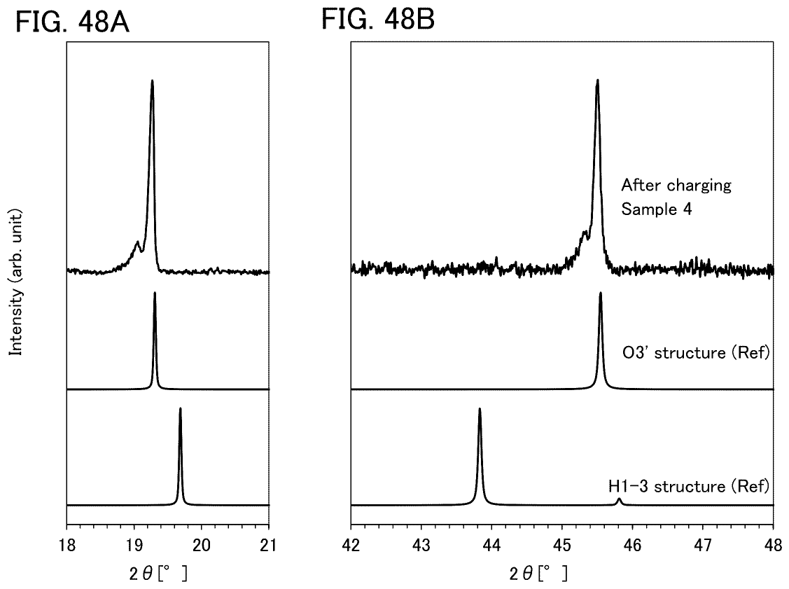

The XRD measurement data of the positive electrode (Sample 4) in the high-voltage charged state measured above are shown in FIGS. 48A and 48B. In FIGS. 48A and 48B, a reference pattern of the O3′ structure (O3′) and a reference pattern of the H1-3 structure (H1-3) are also shown.

FIG. 48A shows the range where 2θ is greater than or equal to 18° and less than or equal to 21° in the XRD measurement. FIG. 48B shows the range where 2θ is greater than or equal to 42° and less than or equal to 48°. Typical peak positions are extracted from the XRD measurement data of Sample 4 and the reference pattern of the O3′ structure, and shown in Table 17.

TABLE 17

| Peak No. | Sample 4 |
|---|---|
| 1 | 19.271° |
| 2 | 37.366° |
| 3 | 39.092° |
| 4 | 45.509° |
| 5 | 49.861° |
| 6 | 60.406° |
| 7 | 66.301° |
| 8 | 69.775° |

As shown in FIGS. 48A and 48B and Table 17, in the XRD measurement, the typical peak positions of Sample 4 in the high-voltage charged state are substantially aligned with peak positions of the reference pattern (Ref) of the O3′ structure. In other words, Sample 4 in the high-voltage charged state can be regarded as the O3′ structure. In addition, Sample 4 in the high-voltage charged state exhibited no peak position aligned with that of the reference pattern (Ref) of the H1-3 structure. In other words, the structure of Sample 4 in the high-voltage charged state can be expressed as follows: a region that is the O3′ structure is larger than a region that is the H1-3 structure in Sample 4; a region that is the O3′ structure is much larger than a region that is the H1-3 structure in Sample 4; a region that is the H1-3 structure is hardly contained in Sample 4; the O3′ structure occupies 50% or more of regions in Sample 4; the O3′ structure occupies 60% or more of regions in Sample 4; the O3′ structure occupies 70% or more of regions in Sample 4; the O3′ structure occupies 80% or more of regions in Sample 4; and the O3′ structure occupies 90% or more of regions in Sample 4.

This application is based on Japanese Patent Application Serial No. 2023-215216 filed 10 with Japan Patent Office on Dec. 20, 2023 and Japanese Patent Application Serial No. 2024-023104 filed with Japan Patent Office on Feb. 19, 2024, the entire contents of which are hereby incorporated by reference.

What is claimed is:

1. A battery comprising a positive electrode,
wherein the positive electrode comprises lithium cobalt oxide comprising magnesium, aluminum, and nickel,
wherein when a concentration of cobalt in the lithium cobalt oxide measured from XPS analysis is represented as 1, a concentration of the magnesium (Mg/Co) is greater than or equal to 0.50 and less than or equal to 0.90, and
wherein a half width of a Mg1s peak in the XPS analysis is higher than or equal to 1.0 eV and lower than or equal to 2.6 eV.

2. The battery according to claim 1, wherein when a concentration of the magnesium in the XPS analysis is represented as 1, a concentration of fluorine (F/Mg) is greater than or equal to 0.10 and less than or equal to 0.20.

3. The battery according to claim 2, wherein when the concentration of the cobalt in the XPS analysis is represented as 1, a concentration of the aluminum (Al/Co) is greater than or equal to 0.01 and less than or equal to 0.04 and a concentration of the nickel (Ni/Co) is greater than or equal to 0.01 and less than or equal to 0.07.

4. The battery according to claim 1,
wherein the lithium cobalt oxide has a layered rock-salt crystal structure of a space group R-3m,
wherein the battery further comprises a negative electrode and an electrolyte solution,
wherein the negative electrode comprises a lithium metal, and the electrolyte solution comprises a mixture in which 2 wt % of vinylene carbonate is added to lithium hexafluorophosphate, ethylene carbonate, and diethyl carbonate,
wherein when the positive electrode is analyzed by powder X-ray diffraction with CuKα₁ radiation in an argon atmosphere after constant current charging with a current value of 0.5 C (1 C=200 mA/g) is performed up to a voltage of 4.60 V in an environment at 45° C. and then constant voltage charge is performed until the current value becomes 0.05 C, an XRD pattern at least have a diffraction peak at 2θ of 19.25±0.20° and 2θ of 45.47±0.10°.

5. A method for forming a positive electrode active material, comprising:
mixing lithium cobalt oxide and lithium fluoride to form a first mixture;
heating the first mixture at a temperature higher than or equal to 900° C. and lower than or equal to 950° C. for longer than or equal to 2 hours and shorter than or equal to 10 hours to form a first composite oxide;
mixing a magnesium source with the first composite oxide to form a second mixture;
heating the second mixture at a temperature higher than or equal to 850° C. and lower than or equal to 950° C. for longer than or equal to 2 hours and shorter than or equal to 60 hours to form a second composite oxide;
mixing a nickel source and an aluminum source with the second composite oxide to form a third mixture; and
heating the third mixture at a temperature higher than or equal to 800° C. and lower than or equal to 900° C. for longer than or equal to 2 hours and shorter than or equal to 20 hours.

6. The method for forming a positive electrode active material according to claim 5, wherein when EELS analysis is performed on a portion within a range less than or equal to 2 nm from a surface of the first composite oxide, a valence of cobalt is greater than or equal to 2.35 and less than or equal to 2.90.

7. The method for forming a positive electrode active material according to claim 5, wherein the first composite oxide is mixed with lithium fluoride in addition to the magnesium source before heating at the temperature higher than or equal to 850° C. and lower than or equal to 950° C.

8. The method for forming a positive electrode active material according to claim 5,
wherein magnesium fluoride is used as the magnesium source, and
wherein when the number of moles of the lithium cobalt oxide is 100, the number of moles of the magnesium fluoride is greater than or equal to 0.5 and less than or equal to 3.0.

9. The method for forming a positive electrode active material according to claim 8, wherein nickel hydroxide is used as the nickel source and aluminum hydroxide is used as the aluminum source.

10. The method for forming a positive electrode active material according to claim 9, wherein when the number of moles of the lithium cobalt oxide is 100, the number of the nickel hydroxide is greater than or equal to 0.05 and less than or equal to 4.0 and the number of moles of the aluminum hydroxide is greater than or equal to 0.05 and less than or equal to 4.0.
